(19) United States
(12) Patent Application Publication
(10) Pub. No.: US 2026/0160669 A1
(43) Pub. Date: Jun. 11, 2026

(54) OPTICAL INSPECTION SYSTEMS AND METHODS FOR MOVING OBJECTS

(71) Applicant: Borde, Inc., San Ramon, CA (US)

(72) Inventors: Saumitra Buragohain, San Ramon, CA (US); Sarvanan Packianathan Nadar, Mumbai (IN)

(21) Appl. No.: 19/371,390

(22) Filed: Oct. 28, 2025

Related U.S. Application Data
(63) Continuation-in-part of application No. 19/190,838, filed on Apr. 28, 2025.
Application No. 19/190,838 is a continuation-in-part of application No. 17/934,957, filed on Sep. 23, 2022, now Pat. No. 12,541,836.
Application No. 17/934,957 is a continuation-in-part of application No. 17/682,756, filed on Feb. 28, 2022, now Pat. No. 11,480,529.
(60) Provisional application No. 63/243,371, filed on Sep. 13, 2021.

(30) Foreign Application Priority Data
Aug. 28, 2025 (IN) 202511081636

(51) Int. Cl. G01N 21/01; G01N 21/89; G06T 1/00; G06T 7/00; G06T 7/11; G06V 20/60

(52) U.S. Cl. CPC G01N 21/01; G01N 21/8901; G06T 1/0007; G06T 7/001; G06T 7/11; G06V 20/60; G01N 2021/0137; G06T 2207/10016; G06T 2207/20081; G06T 2207/20084; G06T 2207/20212

(57) ABSTRACT

The present disclosure provides techniques for optical inspection systems and methods for moving objects. An optical inspection system can include an image capturing device that can acquire images of an object that is moving, a first-stage frame grabber coupled to the image capturing device and configured to send the images directly to a memory of a first second-stage processor. The first second-stage processor is configured to analyze the images from the first-stage frame grabber. A second second-stage processor is coupled to the first second-stage processor and is configured to process information from the first second-stage processor. A third-stage storage system is coupled to the second second-stage processor and is configured to store images and information from the second second-stage processor, wherein the second second-stage processor is configured to produce a report using the images and information stored in the third-stage storage system.

### BACKGROUND

Optical inspection systems can use one or more cameras to acquire, process and analyze images of objects to extract data from the objects in order to produce numerical or symbolic information. Optical inspection systems can be used in various applications including quality control (QC) or quality assurance (QA) to support a production (or manufacturing) process, and inspection and sorting of objects for recycling. In some cases, optical inspection systems can use artificial intelligence, computer vision, and/or machine learning to analyze the acquired images.

### SUMMARY

The present disclosure provides techniques for optical inspection systems and methods for moving objects. In some embodiments, an optical inspection system, includes: a first image capturing device configured to acquire images of an object that is moving; a first first-stage storage system coupled to the first image capturing device and configured to store images from the first image capturing device; a first second-stage processor coupled to the first first-stage storage system and configured to analyze the images from the first image capturing device; a second image capturing device configured to acquire images from the object that is moving; a second first-stage storage system coupled to the second image capturing device and configured to store images from the second image capturing device; a second second-stage processor coupled to the second first-stage storage system and configured to analyze the images from the second image capturing device; a second-stage storage system coupled to the first and second second-stage processor and configured to store images and information from the first and second second-stage processors; a third-stage processor coupled to the second-stage storage system and configured to process information from the second-stage processor and second-stage storage system and produce a report; and a third-stage storage system coupled to the third-stage processor and configured to store images and information from the third-stage processor.

In some embodiments, an optical inspection system, includes: a first image capturing device configured to acquire images of an object that is moving; a first volatile memory system coupled to the first image capturing device and configured to store images from the first image capturing device; a first second-stage processor coupled to the first volatile memory system and configured to analyze the images from the first image capturing device; a second image capturing device configured to acquire images from the object that is moving; a second volatile memory system coupled to the second image capturing device and configured to store images from the second image capturing device; a second second-stage processor coupled to the second volatile memory system and configured to analyze the images from the second image capturing device; a third second-stage processor coupled to the first and second second-stage processors and configured to process information from the first and second second-stage processors; and a third-stage storage system coupled to the third second-stage processor and configured to store images and information from the third second-stage processor, wherein the third second-stage processor is configured to produce a report using the images and information stored in the third-stage storage system.

In some embodiments, an optical inspection system includes: an image capturing device configured to acquire images of an object that is moving; a first-stage storage system coupled to the image capturing device and configured to store images from the image capturing device; a second-stage processor coupled to the first-stage storage system and configured to analyze the images from the image capturing device; a second-stage storage system coupled to the second-stage processor and configured to store images and information from the second-stage processor; a third-stage processor coupled to the second-stage storage system and configured to process information from the second-stage processor and second-stage storage system and produce a report; and a third-stage storage system coupled to the third-stage processor and configured to store images and information from the third-stage processor.

In some embodiments, an optical inspection system includes: an image capturing device configured to acquire images of an object that is moving; a volatile memory system coupled to the image capturing device and configured to store images from the image capturing device; a first second-stage processor coupled to the volatile memory system and configured to analyze the images from the image capturing device; a second second-stage processor coupled to the first second-stage processor and configured to process information from the first second-stage processor; and a third-stage storage system coupled to the second second-stage processor and configured to store images and information from the second second-stage processor. The second second-stage processor can be configured to produce a report using the images and information stored in the third-stage storage system.

In some aspects, the techniques described herein relate to an inspection system, including: a lighting and imaging assembly positioned to acquire images from a plurality of moving objects, the lighting and imaging assembly including: a first light and a second light; an image capturing device; and a first mounting fixture and a second mounting fixture, each including: a first base structure and a second base structure coupled to a rigid support; a first intermediate structure coupled to the first base structure and a second intermediate structure coupled to the second base structure; a first light support structure coupled to the first intermediate structure and the first light, and a second light support structure coupled to the first intermediate structure and the second light; a third light support structure coupled to the second intermediate structure and the first light, and a fourth light support structure coupled to the second intermediate structure and the second light; and an image capturing device support structure coupled to the image capturing device and one or both of: the first intermediate structure and the second intermediate structure; a set of ejectors configured to eject an object of the plurality of moving objects after the object has been imaged by the lighting and imaging assembly; and an image storage and processing system coupled to the lighting and imaging assembly and to the set of ejectors, wherein the image storage and processing system is configured to analyze the images acquired using the lighting and imaging assembly and to send a signal to the set of ejectors to cause ejection of the object of the plurality of moving objects in response to one or more of the analyzed images.

In some aspects, the techniques described herein relate to an optical inspection system, including: an image capturing device configured to acquire images of an object that is moving; a first-stage frame grabber coupled to the image capturing device and configured to receive the images from the image capturing device; a second-stage processor coupled to the first-stage frame grabber and configured to analyze the images from the first-stage frame grabber, wherein the first-stage frame grabber is configured to send the images directly to a memory of the second-stage processor; a second-stage storage system coupled to the second-stage processor and configured to store images and information from the second-stage processor; a third-stage processor coupled to the second-stage storage system and configured to process information from the second-stage processor and second-stage storage system and produce a report; and a third-stage storage system coupled to the third-stage processor and configured to store images and information from the third-stage processor.

In some aspects, the techniques described herein relate to an optical inspection system, including: an image capturing device configured to acquire images of an object that is moving; a first-stage frame grabber coupled to the image capturing device and configured to receive the images from the image capturing device, wherein the first-stage frame grabber is configured to send the images directly to a memory of the first second-stage processor; a first second-stage processor coupled to the first-stage frame grabber and configured to analyze the images from the first-stage frame grabber; a second second-stage processor coupled to the first second-stage processor and configured to process information from the first second-stage processor; and a third-stage storage system coupled to the second second-stage processor and configured to store images and information from the second second-stage processor, wherein the second second-stage processor is configured to produce a report using the images and information stored in the third-stage storage system.

In some aspects, the techniques described herein relate to a method of sorting moving objects, including: capturing images of one or more moving objects using an image capturing device; receiving the images using a frame grabber; sending the images directly from the frame grabber to a memory of a processor, wherein the processor is selected from a GPU, an FPGA, and an ASIC; stitching together subsequent images of the images to form stitched images using the processor, or alternatively, stitching together subsequent images of the images using the frame grabber before sending the images directly from the frame grabber to a memory of a processor; analyzing the stitched images using the processor to classify the one or more moving objects; and optionally, sending a signal to an ejector to eject a moving object of the one or more moving objects.

### BRIEF DESCRIPTION OF THE DRAWINGS

The foregoing is a summary, and thus, necessarily limited in detail. The above-mentioned aspects, as well as other aspects, features, and advantages of the present technology are described below in connection with various embodiments, with reference made to the accompanying drawings.

FIGS. 1-3 show examples of optical inspection systems.

FIGS. 4A-4D show examples of optical inspection systems.

FIG. 5A shows an example of an optical inspection system including processing blocks to capture images, analyze the images, and trigger an ejection system based on the analyzed images.

FIG. 5B shows an example of process times for processing blocks in an optical inspection system.

FIG. 5C shows an example of pipelining, which can be used in combination with the systems and methods described herein.

FIG. 5D shows a schematic of an example method for capturing a sequence of images, where there is overlap in both space and time between images.

FIGS. 5E-5I show examples of a method for capturing a sequence of images, where images are stitched together such that a subsequent image is placed above a previous image.

FIGS. 6A-6D show examples of optical inspection systems including a chute out of which a set of objects are falling, area scan or line-scan image capturing devices, and an ejector.

FIG. 7A shows an example of a three-dimensional (3D) model of an object (an almond in this example) that was created using photogrammetry from images taken from a plurality of different angles.

FIG. 7B shows synthetic images of different objects (almonds in this example) from a plurality of angles.

FIG. 7C shows an example of training an artificial intelligence (AI) model for inspecting, analyzing, and/or grading objects (almonds in this example) with a chart that plots the mean average precision (mAP, on the y-axis) of the AI model over training iterations (or steps, on the x-axis).

FIG. 7D shows an example of real images of objects (almonds in this example) taken by an optical inspection system.

FIGS. 8A-8B show an example of processing images from a pair of cameras, where one camera is positioned to take images of a first side of an object and the other camera in the pair is positioned to take images of the other side of the object.

FIGS. 9A-9C show some examples of image inspection systems described herein.

FIG. 10 is a schematic of an example of an optical inspection system 200 described herein.

FIGS. 11A-11D show examples of lighting and imaging assemblies for optical inspection systems.

FIGS. 11E-11M show examples of portions of optical inspection systems including the lighting and imaging assemblies described herein.

FIG. 12 shows a flowchart of an example of a method 800 for inspecting or sorting objects.

FIGS. 13A-13B are flowcharts of example methods for sorting moving objects.

The illustrated embodiments are merely examples and are not intended to limit the disclosure. The schematics are drawn to illustrate features and concepts and are not necessarily drawn to scale.

### DETAILED DESCRIPTION

The foregoing is a summary, and thus, necessarily limited in detail. The above-mentioned aspects, as well as other aspects, features, and advantages of the present technology will now be described in connection with various embodiments. The inclusion of the following embodiments is not intended to limit the disclosure to these embodiments, but rather to enable any person skilled in the art to make and use the claimed subject matter. Other embodiments may be utilized, and modifications may be made without departing from the spirit or scope of the subject matter presented herein. Aspects of the disclosure, as described and illustrated herein, can be arranged, combined, modified, and designed in a variety of different formulations, all of which are explicitly contemplated and form part of this disclosure.

Optical inspection systems and methods for inspection of moving objects, free falling objects, and/or fast-moving objects (“fast-moving object”) are described herein.

“Fast-moving objects” can move faster than about 1 m/s, or from about 1 m/s to about 10 m/s, or from about 2 m/s to about 6 m/s or from about 0.1 m/s to about 10 m/s. The optical inspection systems described herein enable inspection of a high number of objects (e.g., fast-moving objects) per time interval. For example, the optical inspection systems described herein enable inspection of an object in less than about 18 ms to about 20 ms, or about 10 objects in less than about 18 ms to about 20 ms, or up to about 100 objects in less than a time period from about 18 ms to about 20 ms, or up to about 40,000 lbs of objects per about one hour, or about 20 metric tons of objects per about one hour, or about 5000 objects per about one second. The optical inspection systems described herein can be applied in a variety of applications including, but not limited to, identifying and/or sorting of food (e.g., nuts), waste and/or recyclable objects, mining and minerals, and pharmaceutical and nutraceutical products. In some cases, the optical inspection systems can also perform sorting of objects, for example, by using a mechanism (e.g., an ejector or a robotic arm) to route objects to different locations based on the results (e.g., classification, or grades) output from a component of the optical inspection system.

The optical inspection systems and methods described herein can acquire images of (fast-moving) objects, optionally pre-process the images, analyze the images to determine a classification, category and/or grade of the objects, save the images and/or information generated from the analysis, and optionally generate reports based on the information generated from the analysis. Some examples of classifications (or classes, or categories, or grades) that the optical inspection systems and methods described herein can use are those related to quality (e.g., defective, non-defective), category (e.g., type-A, type-B), size (e.g., small, large), shape (e.g., round, square), color (e.g., white, black, uniform, non-uniform), or any other visual characteristic of the objects.

In some cases, the optical inspection systems and methods described herein acquire images using digital cameras. In some cases, acquired images are stored using a hybrid in-memory and solid-state drive (SSD) storage system that enables the present systems to perform high-speed image acquisition and analysis. In some cases, the analysis is performed using artificial intelligence (AI) (e.g., AI-based object detection). Recording and/or generating reports for grading may also be done by the optical inspection systems and methods described herein, based on the analysis and/or grading performed. The analysis and/or grading may include adding bounding boxes around one or more objects in an image, and determining a classification and/or grade for the one or more objects in an image or set of images.

In some cases, the optical inspection systems and methods described herein include offloading images (and optionally image data) to be written to memory (a storage system), and to a graphics processing unit (GPU), a central processing unit (CPU) and/or a field-programmable gate array (FPGA) for processing (e.g., the analysis and/or grading). Such systems can be fast enough to keep up with real-time object analysis (e.g., classifying and/or grading an object in under about 18 ms, or under about 20 ms).

In some cases, the optical inspection systems and methods described herein include 3D grading of both sides of fast-moving object(s).

In some cases, the optical inspection systems and methods described herein include automated start and stop of AI generation (or image capture, or analysis, or image processing). For example, a trigger can be provided to start and/or stop AI generation (or image capture, or analysis, or image processing).

In some cases, the AI object detection is always on, and does not use an external trigger or sensor. A “polling period” is a time period between instances of capturing images and/or analyzing the captured images. For example, the system (using AI processing) can inspect (fast-moving) objects in images captured from one or more cameras frequently, e.g., with a fast “polling period” (e.g., about 20 ms). If an object is not detected in a captured image for a time period (e.g., a “slowdown window,” e.g., about 1 min), then the “polling period” can be increased (e.g., doubled or quadrupled, or from about 20 ms to about 40 ms). This process can continue until a pre-set maximum “polling period” (e.g., about 1000 ms) is reached, and then the system can continue polling every about 1000 ms (or 1 second). If a single (fast-moving) object is detected in the “polling period,” the system, can then automatically accelerate to the standard “polling period” (e.g., of about 20 ms) so that the system can resume capturing and/or analyzing images of the (fast-moving) objects. In some cases, AI report generation can be paused after the “polling period” reaches a pre-set maximum threshold (e.g., about 100 ms, or about 500 ms, or about 1000 ms), and then once a (fast-moving) object is detected, the AI can resume capturing and/or analyzing images, and the AI report generation can also resume.

In some cases, the AI object detection of the optical inspection systems and methods described herein also uses information (a signal, or trigger) from an external sensor to determine when to capture images, analyze images, and/or generate AI reports. For example, motion sensors and/or photo-electric sensors can be used together with the above method in a complementary manner where input from a sensor as well as object detection from the AI engine are used to refine the “polling period,” when to capture and/or analyze images, and/or generate AI reports.

The optical inspection systems and methods described herein can be used in logical inspection lines including 2 or more (e.g., from 2 to 10, or 6) image capture devices, processors and/or storage devices (e.g., with components connected in parallel within a single device). In such systems with multiple inspection lines, each line can have its own reporting and grading with its own camera(s), light(s), and/or mounting kit, that are all connected to a single device where the information (e.g., captured images, processed images, and/or information about the images) can be logically grouped and/or analyzed. For example, each logical inspection line can handle its own image capture (acquisition) and processing with 2 or more logical inspection lines sharing a processor (e.g., a FPGA, a CPU, and/or a GPU), and a storage system (e.g., DRAM and/or SSD). Such systems can be advantageous because they can reduce the total cost of the system, and can enable the inspection of more objects per a given interval of time. For example, in a process where multiple lines of objects converge into one line with a larger number of objects per unit time, multiple inspection lines (e.g., each having its own reporting and grading with its own camera(s), light(s), and/or mounting kit) placed on the multiple lines of objects (before converging) can enable all of the objects to be inspected, which may not be possible if one optical inspection system were installed on the converged line with a larger number of objects passing the system per unit time.

The optical inspection systems and methods described herein can be configured to inspect (fast-moving) objects in free fall (e.g., falling off a discharge chute) or to inspect objects on a horizontal conveyor belt. For example, the cameras can be positioned (e.g., facing approximately horizontally) to capture images of objects during free fall, or can be positioned (e.g., facing approximately downwards) to capture images of objects moving on a conveyor belt. In the case where there are multiple free fall lines (or streams) of objects, there can be a logical inspection line for each of the multiple free fall lines of objects, each sharing a processor and/or storage system as described above. Similarly, in the case where there are multiple lines (or streams) of objects moving on multiple conveyor belts, there can be a logical inspection line for each of the multiple lines of objects, each sharing a processor and/or storage system as described above.

In some cases, the AI model comprises deep learning models. In some cases, the AI models include one or more of a family of object detection and tracking architectures and models that are pretrained on the common objects in context (COCO) dataset. In some cases, the AI model comprises deep learning object detection models such as Fast Region-based Convolutional Neural Network (Fast R-CNN) or Faster R-CNN, or regression-based object detectors such as a Single Shot Detector or You only Look Once (YOLO).

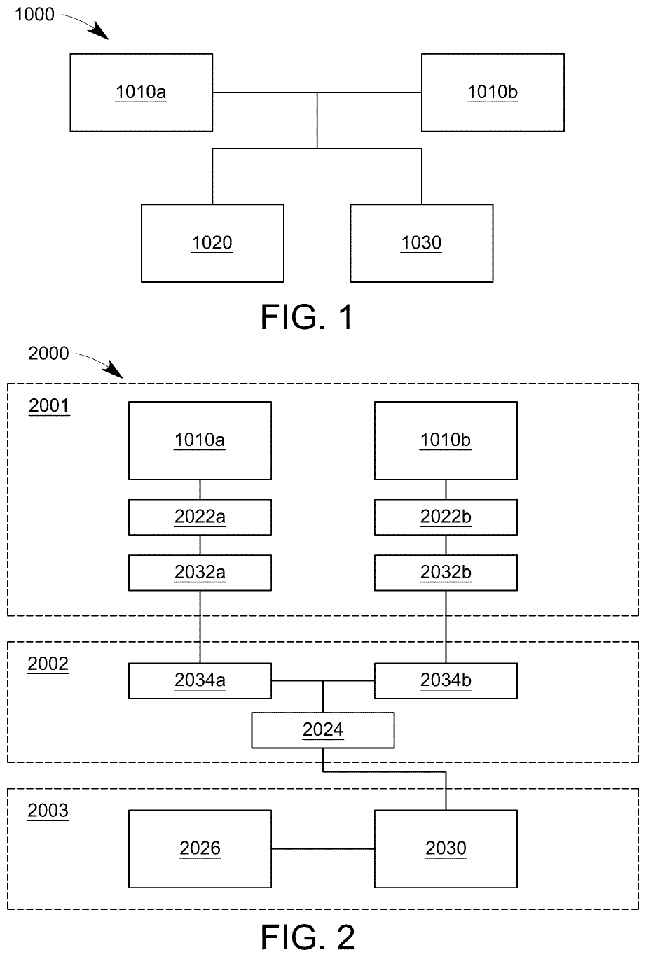

The image capturing devices of the systems and methods described herein can be any devices capable of capturing a digital image, including digital cameras, charge-coupled device (CCD) cameras, and digital video recording devices (i.e., digital video cameras). In some cases, the image capturing device(s) are video recording devices that capture video, and still images are extracted from the captured video. For example, a video captured using a digital video camera can be stored as a video file in a storage system (e.g., DRAM, persistent memory, and/or SSD) or in volatile memory (e.g., DRAM, and/or SRAM). Still images can then be extracted from the stored video file using a processor (e.g., a GPU, a CPU, or an FPGA). In some cases, the image capturing device(s) are digital video camera(s) that are used in a mode where the video cameras capture still images and then output the still images to another component of the system such as a storage device (e.g., DRAM, persistent memory, and/or SSD) or volatile memory (e.g., DRAM, and/or SRAM). The embodiments described above, wherein the image capturing devices are video cameras, may apply to any of the embodiments described elsewhere herein, for example at least those embodiments described in FIGS. 1-5.

Components of the systems described herein can be located either at the physical location of the objects being inspected, or they can be located in the cloud. Components that are located in the cloud are located at a physical location that is remote (or different than) the physical location of the objects being inspected. For example, a storage system or processor of the systems described herein that is located in the cloud can be located at a datacenter or other physical location away from the location of the objects being inspected. In the systems and methods described herein, components located in the cloud can be used to store or process information in the cloud. In some cases, data can be stored in the cloud using a cloud storage system (e.g., a cloud storage system from Microsoft, or Amazon Web Services).

In general, components that directly interact with the objects being inspected (e.g., the image capturing device(s), optionally trigger sensors, and optionally ejectors) are located at a facility where objects are inspected, and all of the other components of the system (e.g., the storage systems, volatile memory, and/or the processors) can be located either at the location of the objects being inspected (e.g., at a plant or facility) or in the cloud. In some cases, some of the storage systems, volatile memory, and/or the processors of the system can be located at the facility and some can be located in the cloud. In other cases, all of the storage systems, volatile memory (if the system uses volatile memory), and the processors of the system can all be located in the cloud.

For example, an image capturing device can transmit captured images (e.g., using a high-speed data transfer method, such as 5G) to storage systems and/or processors located in the cloud for storage, processing and/or report generation. In some cases, captured images, pre-processed images, and/or other data (e.g., bounding box location, and/or grades) can be stored in storage systems located in the cloud. In some cases, the analysis, categorization, and/or classification of the captured images (or an object in the captured images) can be performed by processors that are located in the cloud. In some cases, the images are captured at the location where the objects are inspected, then data (e.g., captured images, pre-processed images, and/or other data such as bounding box location and/or grades) can be stored in storage systems located in the cloud and/or processed by processors in the cloud, and then data can be sent from components in the cloud back to components at the location where the objects are inspected for further storage, processing and/or report generation.

FIG. 1 shows an example of an optical inspection system 1000 for quality inspection of objects (e.g., fast-moving objects) including a first image capturing device (or first set of image capturing devices) 1010a and a second image capturing device (or second set of image capturing devices) 1010b, a storage system 1020, and a processor 1030. Images of objects (e.g., fast-moving objects) are taken by the (sets of) image capturing devices 1010a and 1010b (e.g., a digital camera or CCD camera). Image capturing devices 1010a and 1010b can be any devices capable of capturing a digital image, including digital cameras, charge-coupled device (CCD) cameras, and digital video recording devices (i.e., digital video cameras). The images are then either sent to storage system 1020 (e.g., containing a DRAM, persistent memory, and/or an SSD) to be saved, or to processor 1030 (e.g., a GPU, a CPU, and/or an FPGA) to be processed. The storage system 1020 and processor 1030 can be used to analyze the images, save the images, grade the images, save the gradings and graded images, and/or produce reports of the analysis. Storage system 1020 and/or processor 1030 can be located in either the physical location of the objects being inspected, or they can be located in the cloud (e.g., at a datacenter, or other physical location).

For example, in some cases, images from (sets of) image capturing devices 1010a and 1010b are sent to processor 1030 (or another processor, not shown) to perform pre-processing of the images. The pre-processing can include cropping the images and/or size-reducing the images. In some cases, after pre-processing, the pre-processed images are stored in storage system 1020. In some cases, after storage, processor 1030 further analyzes the stored pre-processed images (and optionally determines a grade of an object based on the stored pre-processed images), and the further analyzed images (and optionally object grade or quality information) are stored in storage system 1020. The processor 1030 can use AI to analyze the images, where the analysis can include adding bounding boxes surrounding the objects in the images, classifying the objects in the images, and/or grading the objects in the images.

In some cases, uncompressed, high-resolution data is captured from the image capturing device(s). Then, to save storage space and processing time, the size of the captured image can be reduced (e.g., using approaches such as letterbox, or reducing a 2448×784 pixel image to a 640×224 pixel image without compressing (e.g., to a jpeg format)) and the size-reduced image is then stored to a persistent storage system. This approach can help avoid time consuming image compression (e.g., to jpeg) as well as reducing the amount of expensive memory required. In some cases, the AI engine can analyze fully uncompressed (e.g., 2448×784 pixel) images. However, in some cases, doing so can increase the AI processing time, and slow down the processing speed of the system. Therefore, in some cases, to improve the performance of the system, size-reduced (e.g., 640×224 pixel) images are retrieved from the storage system and analyzed using the AI processing engine. In some cases, after the size-reduced images are analyzed using the AI engine and a list of objects detected with corresponding bounding boxes is produced, the image(s) are then compressed and stored in a post-processing stage. In the post-processing stage, the images and/or data can be converted into a tabular report format (e.g., including metadata), which allows the image with the analysis (e.g., a grading report) to be viewed (e.g., by an operator).

In another example, in some cases, images from (sets of) image capturing devices 1010a and 1010b are sent to processor 1030 to perform pre-processing of the images, then the processor 1030 analyzes the pre-processed images (and optionally determines a grade of an object based on the stored pre-processed images), and the analyzed images (and optionally object grade or quality information) are stored in storage system 1020.

In some cases, one or more reports can be generated from the stored information in storage system 1020.

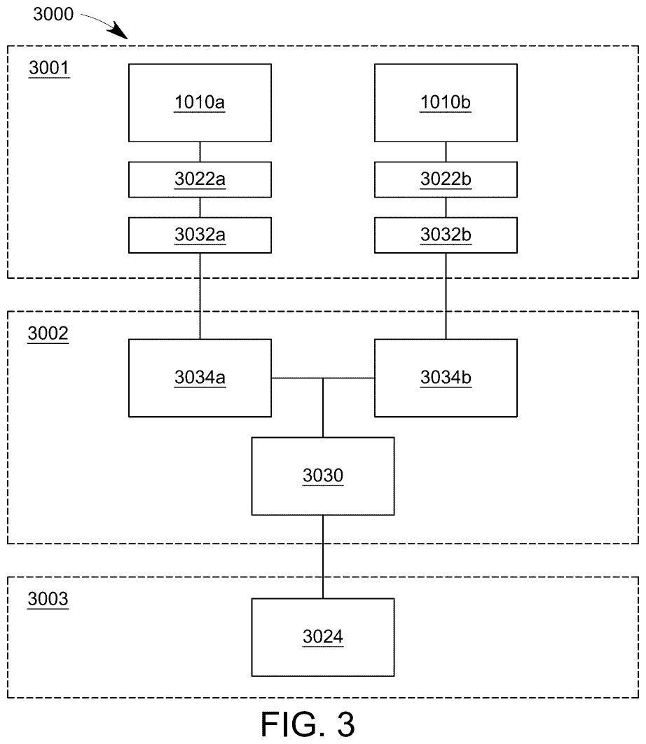

FIGS. 2 and 3 show examples of optical inspection systems 2000 and 3000 for quality inspection of objects (e.g., fast-moving objects). Some of the components in system 1000 in FIG. 1 are the same as or similar to those in the systems 2000 and 3000 in FIGS. 2 and 3.

FIG. 2 shows an example of an optical inspection system 2000 for quality inspection of objects (e.g., fast-moving objects) with a first stage 2001, a second stage 2002 and a third stage 2003. The optical inspection system 2000 includes a first image capturing device (or first set of image capturing devices) 1010a and a second image capturing device (or second set of image capturing devices) 1010b (as shown in FIG. 1), two first-stage storage systems (or devices) 2022a and 2022b (e.g., DRAM, persistent memory, and/or SSD), two first-stage processors 2032a and 2032b (e.g., CPUs, cores of a CPU, or FPGAs), two second-stage processors 2034a and 2034b (e.g., GPUs and/or FPGAs), a second-stage storage system 2024 (e.g., DRAM, persistent memory, SSD, and/or a write-optimized pseudo-database), a third-stage processor 2030 (e.g., a CPU or FPGA), and a third-stage storage system 2026 (e.g., DRAM, persistent memory, SSD, and/or a relational database).

In the first stage of optical inspection system 2000, and of a corresponding method of using system 2000, images are captured by the image capturing devices 1010a and 1010b, and stored in the first-stage storage system 2022a and 2022b. In the first stage 2001, the images are pre-processed (e.g., cropped, size-reduced) using the first-stage processors 2032a and 2032b. In the second stage, the second-stage processors 2034a and 2034b analyze the pre-processed images to produce information about the images (e.g., bounding box sizes and locations, object classifications, and/or object grades). The images and/or information from the second-stage processors 2034a and 2034b are then saved using the second-stage storage system 2024. In a third stage 2003, the saved images and information (generated from the analysis) are then further processed using the third-stage processor 2030, for example, to convert the data to a tabular format, to produce a report (e.g., with information about the images, bounding boxes, and object categories or grades), and/or to save the tabular data to a database. The information from the third-stage processor 2030 can then be saved to the third-stage storage system 2024. In some cases, the images may be graded (e.g., given a U.S. Department of Agriculture (USDA) grading) and/or a report may be generated using a processor (e.g., third-stage processor 2030, or a fourth-stage processor in an optional fourth stage (not shown)).

The processors 2032a-b, 2034a-b, and/or 2030 in FIG. 2 can be separate CPUs, separate FPGAs, or separate cores of one or more shared CPUs. In some cases, the first-stage processors 2032a and 2032b are each cores of a CPU, and one or more other cores of the CPU are also used by one or more other processors in the system. For example, processor 2032a, 2032b, and 2030 can all include cores of the same shared CPU. In some cases, processor 2030 is a CPU with some cores that perform actions in the third-stage and other cores that perform actions in the fourth-stage. Using a single CPU with multiple cores (or more than one CPU with multiple cores), where different cores (or groups of cores) are dedicated to different stages, can improve the speed of the system (e.g., the speed by which an image is acquired, pre-processed, analyzed, stored, graded and/or reported) by allowing actions from different stages to occur in parallel. For example, if a first data set (or report) is being processed in the fourth-stage, a second data set (or report) can be processed in the third-stage in parallel, rather than the processing of the first data set in the fourth-stage blocking the second data set from being processed in the third-stage. In some cases, the processors 2032a-b, 2034a-b, and/or 2030 can be FPGAs. In some cases, a fourth-stage processor (not shown) is an FPGA that is a separate FPGA from the third-stage processor (which can also be an FPGA).

All of the components of system 2000, except for the image capturing devices 1010a and 1010b, can be located at the physical location of the objects being inspected, or they can be located in the cloud (e.g., at a datacenter, or other physical location). For example, image capturing devices 1010a and 1010b can transmit captured images (e.g., using a high-speed data transfer method, such as 5G) to first-stage storage system 2022 a and 2022 b located in the cloud (e.g., at a datacenter, or other physical location). In another example, first-stage processors 2032a and 2032b can be located at the physical location of the objects being inspected, and they can transmit the pre-processed images (e.g., using a high-speed data transfer method, such as 5G) to second-stage processors 2034a and 2034b that are located in the cloud. In some cases, captured images, pre-processed images, and/or other data (e.g., bounding box location, and/or grades) can be stored in storage systems (e.g., first-stage storage systems 2022a and 2022b, second-stage storage system 2024, and/or third-stage storage system 2026) located in the cloud. In some cases, the analysis, categorization, and/or classification of the captured images (or an object in the captured images) can be performed by second-stage and/or third-stage processors (2034a, 2034b and/or 2040) located in the cloud. In another example, the second-stage processors 2034a and 2034b and second-stage storage system 2024 are located in the cloud, and the third-stage processor 2030 and third-stage storage system 2026 are located at the location of the objects being inspected. In such cases, captured images, pre-processed images, and/or other data (e.g., bounding box location, and/or grades) can be sent to the cloud for processing and storage, and then data can be sent back to the location of the objects being inspected for further processing and storage.

FIG. 3 shows an example of an optical inspection system 3000 for quality inspection of objects (e.g., fast-moving objects) including a first image capturing device (or first set of image capturing devices) 1010a and a second image capturing device (or second set of image capturing devices) 1010b (as shown in FIG. 1), two first-stage volatile memory systems (or devices) 3022a and 3022b (e.g., DRAM, and/or SRAM), two first-stage processors 3032a and 3032b (e.g., CPUs, cores of a CPU, or FPGAs), two second-stage processors (e.g., GPUs and/or FPGAs) 3034a and 3034b, an additional second-stage processor 3030 (e.g., a CPU or FPGA), and a storage system 3024 (e.g., DRAM, persistent memory, SSD, and/or a regional database).

In a first stage 3001 of system 3000, and of a corresponding method of using system 3000, images are captured by the image capturing devices 1010a and 1010b, and the acquired images are stored in the two first-stage volatile memory systems (or devices) 3022a and 3022b. In the first stage 3001, the images are pre-processed (e.g., cropped, size-reduced) using first-stage processors 3032a and 3032b. In the second stage 3002, the images are analyzed (e.g., bounding boxes added, and objects classified and/or graded) using second-stage processors 3034a and 3034b. The processed images and information (generated from the analysis) from the second-stage processors 3034a and 3034b are then further processed using an additional second-stage processor 3030. In a third stage 3003, the further processed images (and information about the images, e.g., a grade) are saved using a third-stage storage system 2024. In some cases, the images may be graded (e.g., given a U.S. Department of Agriculture (USDA) grading) and/or a report may be generated using a processor (e.g., second-stage processor 3030, or a fourth-stage processor (not shown)) in an optional fourth stage.

The processors 3032a-b, 3034a-b, and/or 3030 in FIG. 3 can be separate CPUs, separate FPGAs, or separate cores of one or more shared CPUs. In some cases, the first-stage processors 3032a and 3032b are each cores of a CPU, and one or more other cores of the CPU are also used by one or more other processors in the system. For example, processor 3032a, 3032b, and 3030 can all include cores of the same shared CPU. In some cases, processor 3030 is a CPU with some cores that perform actions in the third-stage and other cores that perform actions in the fourth-stage. Using a single CPU with multiple cores (or more than one CPU with multiple cores), where different cores (or groups of cores) are dedicated to different stages can improve the speed of the system (e.g., the speed by which an image is acquired, pre-processed, analyzed, stored, graded and/or reported) by allowing actions from different stages to occur in parallel. For example, if a first data set (or report) is being processed in the fourth-stage, a second data set (or report) can be processed in the third-stage in parallel, rather than the processing of the first data set in the fourth-stage blocking the second data set from being processed in the third-stage. In some cases, the processors 3032a-b, 3034a-b, and/or 3030 can be FPGAs. In some cases, a fourth-stage processor (not shown) is an FPGA that is a separate FPGA from the third-stage processor (which can also be an FPGA).

All of the components of system 3000, except for the image capturing devices 1010a and 1010b, can be located in the physical location of the objects being inspected, or they can be located in the cloud (e.g., at a datacenter, or other physical location). For example, first-stage processors 3032a and 3032b can be located at the physical location of the objects being inspected, and they can transmit the pre-processed images (e.g., using a high-speed data transfer method, such as 5G) to second-stage processors 3034a, 3034b and 3030 that are located in the cloud. In some cases, captured images, pre-processed images, and/or other data (e.g., bounding box location, and/or grades) can be stored in third-stage storage system 3024 located in the cloud. In some cases, the analysis, categorization and/or classification of the captured images (or an object in the captured images) can be performed by second-stage processors 3034a, 3034b and 3030 located in the cloud. In another example, second-stage processors 3034a, 3034b and 3030 and are located in the cloud, and third-stage storage system 3024 is located at the location of the objects being inspected. In such cases, captured images, pre-processed images, and/or other data (e.g., bounding box location, and/or grades) can be sent to the cloud for processing, and then data can be sent back to the location of the objects being inspected for storage.

In FIGS. 1-3, the first image capturing device 1010a may be a single image capturing device, or a set of image capturing devices, and the second image capturing device 1010b may be a single image capturing device, or a set of image capturing devices. In some cases, the (sets of) image capturing devices 1010a and 1010b are positioned to face each other (e.g., to capture images of both sides of an object). In some cases, the optical inspection systems described herein can have one or more pairs of image capturing devices 1010a and 1010b, with the devices in each pair positioned to face each other. One or more motion sensors may be in communication with the first and second image capturing devices 1010a and 1010b, for example, to trigger the devices to capture (acquire) images of an object when it is detected by the motion sensor. Real-time images may be captured by the first and second image capturing devices as fast-moving objects move in front of each of the first and second image capturing devices. Other image capturing devices and/or motion sensors may also be included in the optical inspection systems described herein. Different configurations of image capturing devices are possible, such as from 2 to 10 pairs, or 3 pairs, or 6 pairs of cameras (e.g., with each pair configured to take images of both the front and the back of an object), or cameras positioned on only one side.

In FIGS. 1-3, storage systems 1020, 2022a-b, 2024, 2026, and/or 3024 may include a dynamic random access memory (DRAM) system for block cache, a persistent memory system (such as 3D XPoint), and/or a quad-layer cell or triple-layer cell solid state drive (SSD) system for storing data (e.g., raw format data, images, and/or pre-processed images from the cameras). The storage systems 1020, 2022a-b, 2024, 2026, 3022a-b, and/or 3024 may be configured for high write throughput and longevity (with frequent writes). The storage systems 1020, 2022a-b, 2024, 2026, 3022a-b, and/or 3024 can store all data from the cameras, or can store data selectively (e.g., only data that has been pre-processed, only data corresponding to defective objects, etc.). The storage systems 1020, 2022a-b, 2024, 2026, 3022a-b, and/or 3024 can store raw data, size-reduced data, and/or compressed data. The stored data can be hot data (i.e., data that is acquired and analyzed in real-time or near real-time), cold data (i.e., data that is stored and accessed at a later time that is not in real-time or near real-time, and/or data that is selected from the raw format data that can be used for future audits). In some cases, the systems and methods described herein can utilize tiered storage (e.g., with hot and cold data). For example, the acquired and pre-processed (e.g., resized) data can be stored in a persistent memory (e.g., with adequate longevity and write throughput) for use in the second-stage. Then, the output of the second-stage can be compressed and stored in a cold storage system (e.g., a quad layer SSD), which provides the required performance at a reasonable cost. In some cases, a DRAM storage tier can be utilized prior to storing the data in persistent memory or SSD for systems using in-memory processing.

In FIGS. 1-3, processor 1030, 2030, 2032a-b, 2034a-b, 3030, 3032a-b, and/or 3034a-b may be configured to enable two operating modes: Data Collection Mode, where all images are captured to the persistent memory system and the SSD system; and Production Mode where only some images (e.g., selected images with critical defective objects) are captured. Other operating modes are also possible, such as a mode where a sub-set of images are captured to the persistent memory system and the SSD system. Processor 1030, 2030, 2032a-b, 2034a-b, 3030, 3032a-b, and/or 3034a-b also may also be configured to receive the captured images from one or more image capturing devices (e.g., from one or multiple sets of the first and the second image capturing devices), and/or pre-process the images, and/or analyze the images, and/or generate reports based on the images.

In FIGS. 1-3, processor 1030, 2030, 2032a-b, 2034a-b, 3030, 3032a-b, and/or 3034a-b may be configured to process (or pre-process) the received captured images. For example, for each captured image, processor 1030, 2032a-b, 2034a-b, 3032a-b, and/or 3034a-b may perform image pre-processing such as resizing (or size-reducing) of images, and/or image processing such as feature extraction, to identify at least one fast-moving object in the captured image. The processor may also pre-process a captured image to select (or crop) at least a portion of the captured image (called a “sub-image”) that contains an image of one or more objects (e.g., fast-moving objects).

In FIGS. 1-3, the processor 1030, 2030, 2032a-b, 2034a-b, 3030, 3032a-b, and/or 3034a-b may be configured to perform a grouping of the sub-images identified by the processor in such a way that each group of images includes the same fast-moving object. For example, a first group of sub-images can include a first image from the first image capturing device of a first fast-moving object from a first perspective view, and a second image from the second image capturing device of the same first fast-moving object from a second perspective view (where the first perspective view is at least partially or wholly different from the second perspective view). In some cases, the grouping of the identified sub-images can be performed based on, among other things: a timestamp comparison of each identified sub-image; an exterior shape and/or size of each identified fast-moving object in the identified sub-image; orientation of the identified fast-moving object in the identified sub-image; location of the identified fast-moving object in the identified sub-image; location of other objects and/or features (other than the identified fast-moving object) in the identified sub-image; and/or a surface texture/roughness, color, size, shape, and/or other features on or pertaining to the identified fast-moving object in the identified sub-image.

In some cases, for each identified sub-image in each group of sub-images: the processor can be configured to further identify any defects on the identified fast-moving object in the identified sub-image; and/or generate a defect score for each identified fast-moving object in the identified sub-image. In some cases, for each group of sub-images, which represents the same fast-moving object, the processor can be configured to generate a final defect score. In some cases, for each identified fast-moving object, the processor can be configured to perform a defect final classification and/or categorization of the fast-moving object based on one or more threshold scores. For example, in some cases, each object in an image is detected (or classified) as belonging to a particular type (or class) with a confidence score that is a measure of the confidence of the classification of the object. In some cases, only the classified type with the highest confidence score is selected. In cases where two or more cameras are used to image an object from two or more angles, the types (or classes) of the object from the images from the different camera angles are compared, and the worst grade (or class) wins. In another example, an identified fast-moving object can be classified as a major defective fast-moving object when a final defect score exceeds a first threshold score. Similarly, the identified fast-moving object can be classified as a minor defective fast-moving object when the final defect score does not exceed a first threshold score but exceeds a second threshold score. Additional, or other, classifications of the fast-moving object may be performed by including, for example, additional detection (or classification) processes.

In some cases, one or more of the above processes may be performed, in part or in whole, via artificial intelligence (AI) engines, models, and/or systems, including active learning frameworks (e.g., where the system can interactively query an operator (or some other information source) to label new data points with desired outputs). In some cases, training of the AI engines/systems may include generating and/or applying real and synthetic (or simulated) training data. The generating of such synthetic (or simulated) training data may be based on or derived from a smaller set of real training data.

In some cases, the processor(s) of the optical inspection systems and methods described herein may be configured to perform one or more of the following processes before, during, and/or after the image processing, grouping, scoring, and/or classifying/categorizing. The processor may be configured to perform an analysis of the captured images, identified sub-images, and/or one or more sub-parts of the identified sub-images (e.g., the identified fast-moving objects, other objects in the identified sub-images, surroundings, shaded portion(s) on identified fast-moving objects, and/or illuminated portion(s) on identified fast-moving objects) to assess whether or not illumination conditions used during the capturing of the images need to be adjusted. The processor(s) may be configured to adjust illumination conditions based on the analysis, where the adjusting of the illumination conditions can include increasing intensity of one or more light sources, and/or changing a color, frequency, and/or wavelength of one or more light sources. The processor(s) may be configured to edit the captured images, identified sub-images, and/or one or more sub-parts of the identified sub-images. The editing can include adjusting brightness, contrast, hue, color, and/or sharpness of the images, for example, to assist in improving the image processing, grouping, and/or scoring, and/or classifying, and/or categorizing of the objects.

The above analysis of one or more sub-parts of the identified sub-images, adjusting of illumination conditions, and/or editing of captured images, identified sub-images, and/or sub-parts of identified sub-images may be performed, in part or in whole, via AI engines/systems, including active learning frameworks.

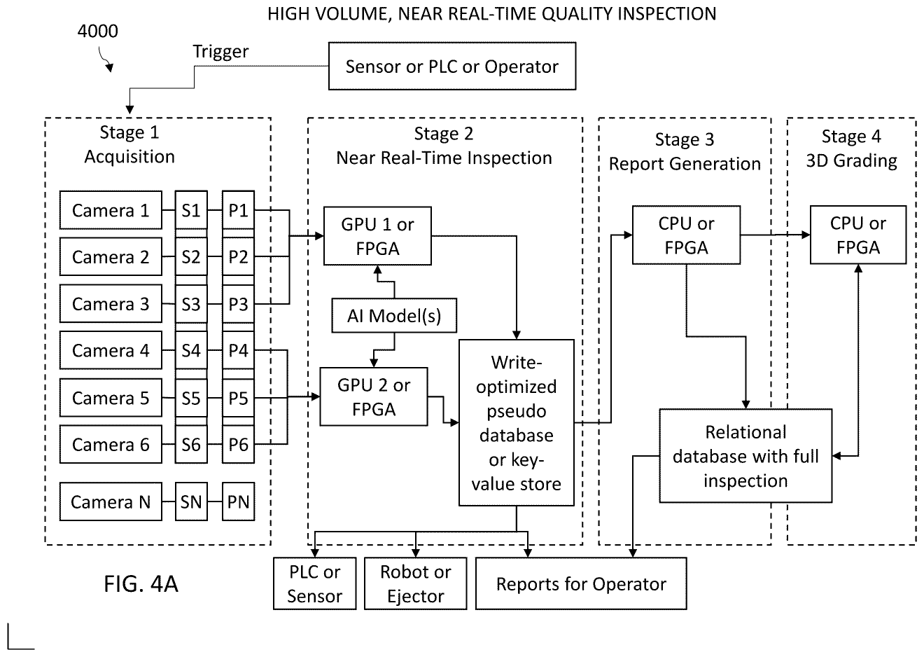

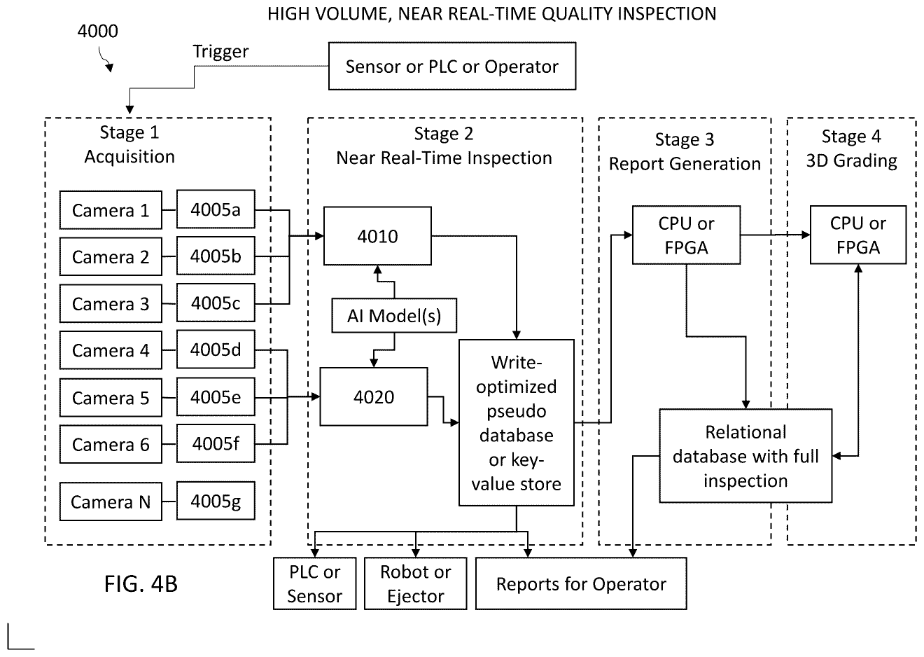

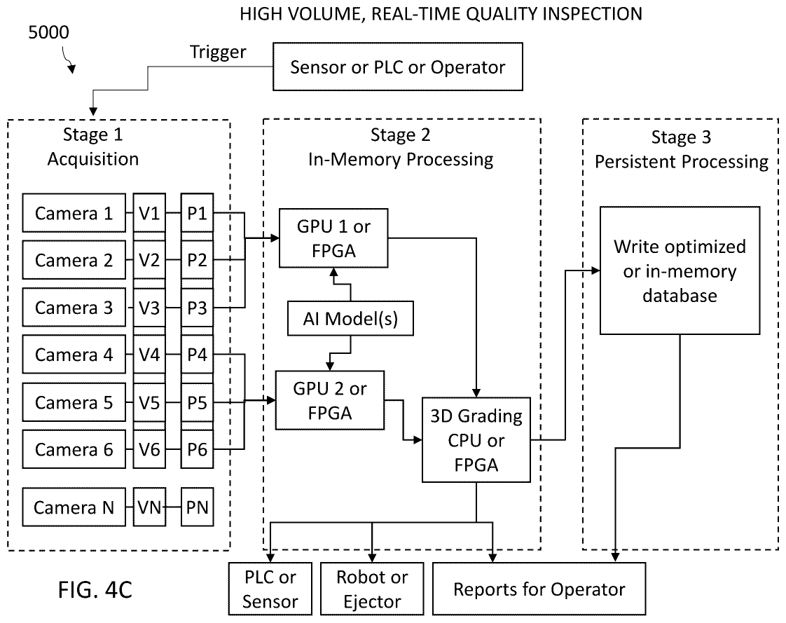

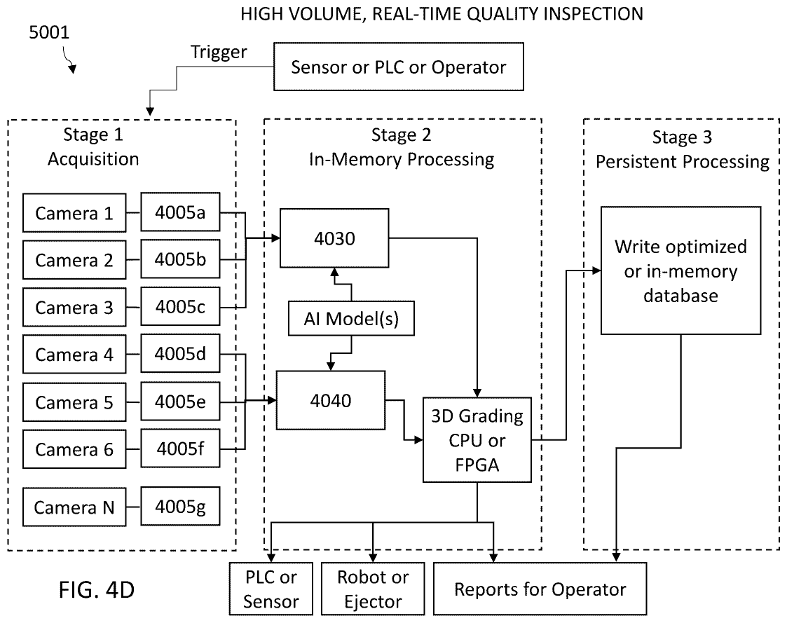

FIG. 4A shows an example of an optical inspection system 4000 that is similar to system 2000 in FIG. 2. The system in FIG. 4A includes 6 (or more) image capturing devices (“Camera 1”-“Camera N”) that capture images in a first stage and send the captured images to two second-stage processors (“GPU #1 or FPGA” and “GPU #2 or FPGA”). Image capturing devices (“Camera 1”-“Camera N”) can be any devices capable of capturing a digital image, including digital cameras, charge-coupled device (CCD) cameras, and digital video recording devices (i.e., digital video cameras). The cameras (i.e., image capturing devices (“Camera 1”-“Camera N”)) are configured to capture images at fixed time intervals or based on a synchronization trigger (e.g., using external sensor(s), such as a motion sensor, a programmable logic controller (PLC), or a trigger from an operator). The images can be pre-processed (e.g., cropped and/or size-reduced) by first-stage processors (“P1”-“PN”). The first-stage processors can be stand-alone processors, cores of a third-stage processor that is a CPU, or FPGAs, as described with respect to the system in FIG. 2. In the example shown in FIG. 4A, there is a processor coupled to each camera (1-N). In other embodiments, there can be fewer first-stage processors than cameras, and images from more than one camera can be pre-processed by a first-stage processor. For example, images from 1, or 2, or 3, or 4, or 5, or 6 cameras can be pre-processed by a first stage processor. For example, there can be 1, or 2, or 3, or 4, or 5, or 6, or 10, or 20, or from 1 to 20, or from 1 to 10 image capturing devices (e.g., “Camera 1”-“Camera N” in FIG. 4A), and there can be 1, or 2, or 3, or 4, or 5, or 6, or 10, or 20, or from 1 to 20, or from 1 to 10 first-stage processors (e.g., “P1”-“PN” in FIG. 4A). In some cases, the images are not compressed (or are maintained in an uncompressed state) by the first-stage processors to decrease the processing time required, which can help the system keep up with the speed of image acquisition (e.g., to achieve real-time, or near real-time operation).

In some cases of a first stage (“Stage 1 Acquisition”) of optical inspection system 4000, the images are stored in a first-stage storage system or device (“S1”-“SN”) (e.g., a high Endurance SSD or other type of persistent memory with low latency) after the images are acquired and before the images are sent to the two second-stage processors (“GPU #1 or FPGA” and “GPU #2 or FPGA”). In some cases, first-stage storage system or device (“S1”-“SN”) is a single device coupled to all of the image capturing devices in the first stage, and to the second-stage processors. In other cases, “S1”-“SN” can be multiple first-stage storage systems or devices, wherein first-stage storage system or device (“S1”-“SN”) is coupled to one or more image capture devices. For example, each of image capture devices (“Camera 1”-“Camera N”) can be coupled to a separate first-stage storage system or device. In another example, three image capture devices (“Camera 1”-“Cameran 3”) can be coupled to a first first-stage storage system or device and to a first second-stage processor (“GPU #1 or FPGA”), and three image capture devices (“Camera 4”-“Camera 6”) can be coupled to a second first-stage storage system or device and to a second second-stage processor (“GPU #2 or FPGA”).

Images from a sub-set of the cameras (e.g., cameras #1-#3) can be sent to a first first-stage storage system or device (e.g., where “P1”-“P3” is one memory device), and another sub-set of the cameras (e.g., cameras #4-#6) can be sent to a second first-stage storage system or device (e.g., where “P4”-“P6” is one memory device). Six cameras are shown in this example, but in other examples, more or fewer cameras can be used. For example, “Camera N” could be coupled to either of the two second-stage processors (GPU #1 and #2, or FPGAs), or to another second-stage processor (not shown). In some cases, the two second-stage processors (“GPU #1 or FPGA” and “GPU #2 or FPGA”) can be coupled to the first and the second first-stage storage systems or devices that are used to save the images from the cameras.

In a second stage (“Stage 2 Near Real-Time Inspection”) of optical inspection system 4000, the two second-stage processors (“GPU #1 or FPGA” and “GPU #2 or FPGA”) analyze the captured images using an AI model. Images from three cameras are being processed by each of the second-stage processors in optical inspection system 4000. In other cases, images from more or fewer than three (e.g., from 1 to 10) cameras can be processed by each second-stage processor. For example, the AI model can be used to detect objects in each image from each camera, and add (or apply, or draw, or determine the size and location of) bounding boxes to each object in each image. The AI model can then output an indication or a determination of the quality (or classification, or category) for each object in each image. For example, the AI model can be used to determine if an object is defective (i.e., is classified in a “bad” or “error” category) or non-defective (i.e., is classified in a “good” or “error-free” category). In some cases, only images with defective objects (or items) are compressed and saved to a second-stage storage system or device (“Write-optimized pseudo database or key-value store”) (e.g., DRAM, SSD, or other persistent memory). The second-stage storage system (“Write-optimized pseudo database or key-value store”) can be a write-optimized pseudo database (e.g., an embeddable key-value store). In some cases, the second-stage storage system or device (“Write-optimized pseudo database or key-value store”) is configured to enable images to be saved very quickly, so that the saving images in the second stage can be done in real-time (or near real-time) (e.g., such that it is keeping up with the speed of image acquisition). Images with no defective objects (or, images with only objects classified in good categories) may not be saved to the second-stage storage system or device (“Write-optimized pseudo database or key-value store”) to save time and space, in some cases. Images with error categories can be used by a customer (or operator) as a quality metric (or QA, or QC) or for further AI training (e.g., where the system employs active learning). The second-stage processors can also determine counts of acquired images (e.g., from all cameras, or from primary cameras only (e.g., only from cameras positioned on one side of the objects), and display the counts in a report in real-time or near real-time. Such counts can be used, for instance, for QA, QC, and other types of tracking and alerting (e.g., via email).

In the second stage of optical inspection system 4000, there may also be an optional ejector or a robot (e.g., a robotic arm) that ejects or removes defective objects (or objects classified as bad), or sorts objects into categories. For example, an ejector can include an air jet (or air stream) that is configured to eject defective objects (or items) out of a production (or sorting) line. The analysis and grading done in the second stage can be used to identify an object that is defective (as described above) and then a signal (“action trigger”) can be sent to the ejector to eject the defective object from the production (or sorting) line in real-time. The robot can be a robotic arm (e.g., a mechanical arm) that is configured to remove defective objects (or items) out of a processing line. The systems and methods described herein, therefore enable the inspection of objects (e.g., fast-moving objects, objects in free-fall, or objects on a conveyor belt) and the ejection or removal of defective objects from the production (or sorting) line in real-time.

In a third stage (“Stage 3 Report Generation”) of optical inspection system 4000, a third-stage processor (“CPU or FPGA” in the third stage in FIG. 4A) (e.g., a CPU or FPGA) can further analyze the images and information (generated from the analysis in the second-stage) saved in the second-stage storage system (“Write-optimized pseudo database or key-value store”). For example, the third-stage processor (“CPU or FPGA”) can read the bounding boxes of each object for all or a subset of the saved images, and save the information to a third stage storage system or device including a relational database. Reports with images and corresponding information (e.g., bounding boxes and/or categories) can then be generated (e.g., using an SQL interface) using the third-stage processor (“CPU or FPGA”).

In a fourth stage (“Stage 4 3D Grading”) of optical inspection system 4000, 3D grading and/or USDA grading can be done using a fourth-stage processor (“CPU or FPGA” in the fourth stage in FIG. 4A) (e.g., a CPU or FPGA). The fourth-stage processor (“CPU or FPGA”) (e.g., a CPU, one or more cores of a CPU, or an FPGA) can collect the data from all cameras (e.g., showing more than one side of an object) from the relational database (which can be used in both the third stage and the fourth stage) and then write back to the relational database. In some cases, the third-and fourth-stage processors are the same processor. In some cases, the cameras are paired and positioned to capture images of opposing sides of an object (or item), for example, objects that are in free-fall. Each pair of cameras can be mirror opposites, and one camera can be designated as a primary camera and the other camera in the pair can be designated as a secondary camera. Each of the images from the secondary cameras can be mirror reversed (i.e., where bounding boxes on the left would then appear on the right). After the mirror reversing, if a rightmost bounding box of an image from the secondary camera overlaps with a rightmost bounding box of an image from the primary camera, then that indicates that the objects in the bounding boxes are the opposite sides of the same object. In such cases, during the grading in the fourth stage, only one grade is assigned to that object (e.g., the most severe (or negative, or defective) grade or categorization is used). In the fourth stage, the size of the bounding boxes and/or objects within the bounding boxes can also be determined (e.g., based on a mapping from pixel size to actual size (e.g., millimeters)), and the size of each object can be determined. USDA grading can be done based on object weight. In some cases, an assumption is used where all objects within a batch have the same density, and therefore the size determined in the fourth stage can be used as a proxy to determine a USDA weight grading. In some cases, a USDA report can then be generated.

The reports generated in the second, third and fourth stages of optical inspection system 4000 can be read by an operator. In some cases, the operator can then improve the AI model by adding more training data based on the generated reports (e.g., in a system that uses active learning). For example, the operator can manually classify the object in the image and provide that information to the AI model to further train the AI model. In some cases, the generated reports are archived to the cloud (e.g., using Amazon Web Services, Microsoft Azure, or a private Data Center) and an automatic AI training will commence (e.g., using an autonomous machine learning framework), based on the revised classification by the operator. The newly trained AI model can then be deployed automatically. Such systems can advantageously allow an operator without data science expertise to train the AI.

Many of the components of system 4000 can be located either at the physical location of the objects being inspected or in the cloud (e.g., at a datacenter, or other physical location). Some components (e.g., image capturing devices (“Camera 1”-“Camera N”), trigger sensor, and ejector) are located at the physical location of the objects being inspected. For example, image capturing devices (“Camera 1”-“Camera N”) can transmit captured images (e.g., using a high-speed data transfer method, such as 5G) to first-stage storage system or device (“S1”-“SN”) located in the cloud (e.g., at a datacenter, or other physical location). In another example, first-stage processors (“P1”*“PN”) can be located at the physical location of the objects being inspected, and they can transmit the pre-processed images (e.g., using a high-speed data transfer method, such as 5G) to second-stage processors (“GPU #1 or FPGA” and “GPU #2 or FPGA”) located in the cloud. In some cases, captured images, pre-processed images, and/or other data (e.g., bounding box location, and/or grades) can be stored in storage systems (e.g., first-stage storage system or device (“S1”-“SN”), second-stage storage system or device (“Write-optimized pseudo database or key-value store”) and/ a third stage storage system or device (including a relational database) located in the cloud. In some cases, the analysis, categorization and/or classification of the captured images (or an object in the captured images) can be performed by one or more processors (e.g., second-stage processors (GPU #1 and #2, or FPGAs), third-stage processor (“CPU or FPGA”), and/or fourth-stage processor (“CPU or FPGA”)) located in the cloud. In another example, the second-stage processors and second-stage storage system are located in the cloud, and the third-stage processor and third-stage storage system are located at the location of the objects being inspected. In such cases, captured images, pre-processed images, and/or other data (e.g., bounding box location, and/or grades) can be sent to the cloud for processing and storage, and then data can be sent back to the location of the objects being inspected for further processing and storage.

FIG. 4B shows an example of an optical inspection system 4001 that is similar to system 4000 in FIG. 4A. The system 4001 includes six (or more) image capturing devices (“Camera 1”-“Camera N”) and frame grabbers 4005a-g (e.g., frame grabber cards), that receive images from the image capturing devices in a first stage and send the images directly to second-stage processors 4010, 4020. In other examples, there can be from one to ten, or more than ten second-stage processors. The two second-stage processors 4010, 4020 can be GPUs, FPGAs, or application-specific integrated circuits (ASICs). In this example, the first-stage storage system or device (“S1”-“SN”) and the first-stage processors (“P1”-“PN”) in system 4000 are omitted since they are replaced by the frame grabbers 4005a-g.

A frame grabber is a specialized piece of hardware, which can take the form of a card, embedded module, or external device, and serves as the interface between an image capturing device and a processor (e.g., a computer, or a GPU). Its primary role is to reliably capture image data streams from the image capturing devices and transfer those pixels into system memory or directly into a GPU for processing.

Image capturing devices (“Camera 1”-“Camera N”) can be any devices capable of capturing a digital image that are compatible with direct memory access (DMA). In the system shown in FIG. 4B, the image capturing device can be a PCI device, which is a piece of hardware connected to a motherboard via a Peripheral Component Interconnect (PCI) slot. The motherboard can also include a chip-set that supports peer-to-peer protocols. PCI device, such as PCIe (Peripheral Component Interconnect Express) devices, can perform DMA to bypass the CPU and transfer data directly between the device and system memory, which can beneficially improve the speed and the performance by reducing the latency. For example, the image capturing device can be a PCIe device including digital cameras, charge-coupled device (CCD) cameras, and digital video recording devices (i.e., digital video cameras).

In some cases, the image capturing devices can support an image protocol such as crosspoint, CoaXPress (CXP), Camera Link, or 10GigE, that enables the transmission of high-bandwidth image data from the image capturing devices to the frame grabbers, for example, using coaxial or fiber links and, in some cases, dedicated hardware signaling for synchronization and error correction. Using such image protocols can be advantageous to transmit high data rates (e.g., up to 12.5+ Gbps per cable), accommodate the use of long cable lengths, and/or enable lower latency.

The image capturing devices (“Camera 1”-“Camera N”) send area scans or line scans to the frame grabbers 4005a-g, which then send the frames to the second-stage processors 4010, 4020. In the case of line-scan image capturing devices, the frame grabbers 4005a-g can stitch captured lines into frames and then send the frames to the second-stage processors 4010, 4020. Alternatively, in the case of line-scan image capturing devices, the frame grabbers 4005a-g can send the individually captured lines directly to the second-stage processors 4010, 4020, which can be used to stitch captured lines into frames. This approach can be beneficial since the stitching process can be customized, for example, to combine images together to be processed by the AI models, as described further herein.

The frame grabbers 4005a-g and the second-stage processors 4010, 4020 perform the functions of the first-stage storage system or device (“S1”-“SN”), the first-stage processors (“P1”-“PN”), and the second-stage processors in system 4000, including analyzing the captured images using an AI model. System 4001 can have lower latency between capturing an image and analyzing the image than system 4000, since storing the images in the first-stage storage system or device (“S1”-“SN”) and pre-processing them in the first-stage processors (“P1”-“PN”) in system 4000 takes additional time that is saved in system 4001 by sending the images from the image capturing devices to the memory of the second-stage processors using DMA.

FIG. 4C shows an example of an optical inspection system 5000 that is similar to system 3000 in FIG. 3. The system in FIG. 4C includes 6 (or more) cameras that capture images in a first stage and send the captured images to two second-stage processors (“GPU #1 or FPGA” and “GPU #2 or FPGA”). Image capturing devices (“Camera 1”-“Camera N”) can be any devices capable of capturing a digital image, including digital cameras, charge-coupled device (CCD) cameras, and digital video recording devices (i.e., digital video cameras). The cameras are configured to capture images at fixed time intervals or based on a synchronization trigger (e.g., using external sensor(s)). The images can be size-reduced by first-stage processors (“P1”-“PN”). The first-stage processors can be stand-alone processors, cores of a third-stage processor that is a CPU, or FPGAs, as described with respect to the system in FIG. 3. In the example shown in FIG. 4C, there is a processor coupled to each camera (1-N). In other embodiments, there can be fewer first-stage processors than cameras, and images from more than one camera can be pre-processed by a first-stage processor. For example, images from 1, or 2, or 3, or 4, or 5, or 6 cameras can be pre-processed by a first stage processor. For example, there can be 1, or 2, or 3,or 4, or 5, or 6, or 10, or 20, or from 1 to 20, or from 1 to 10 image capturing devices (e.g., “Camera 1”-“Camera N” in FIGS. 4A-4D), there can be 1, or 2, or 3, or 4, or 5, or 6, or 10, or 20, or from 1 to 20, or from 1 to 10 first-stage processors (e.g., “P1”-“PN” in FIG. 4C). Additionally, there can be 1, or 2, or 3, or 4, or 5, or 6, or 10, or 20, or from 1 to 20, or from 1 to 10 first-stage frame grabbers (e.g., frame grabbers 4005 a-g in FIGS. 4B and 4D). In some cases, the images are not compressed or are maintained in an uncompressed state to decrease the processing time required, which can help the system keep up with the speed of image acquisition.

In some cases of a first-stage (“Stage 1 Acquisition”) of optical inspection system 5000, the images are stored in a volatile memory (“V1”-“VN”) (e.g., DRAM or SRAM) after the images are acquired and before the images are sent to the two second-stage processors (“GPU #1 or FPGA” and “GPU #2 or FPGA”). In some cases, volatile memory (“V1”-“VN”) is a single volatile memory system or device coupled to all of the image capturing devices in the first stage, and all of the second-stage processors. In other cases, “V1”-“VN” can be multiple volatile memory systems or devices, wherein each volatile memory system or device is coupled to one or more image capture devices. For example, each of image capture devices (“Camera 1-Camera N”) can be coupled to a separate volatile memory system or device. In another example, three image capture devices (“Camera 1-Camera 3”) can be coupled to a first volatile memory system or device and to a first second-stage processor (“GPU #1 or FPGA”), and three image capture devices (“Camera 4-Camera 6”) can be coupled to a second volatile memory system or device and to a second second-stage processor (“GPU #2 or FPGA”).

Images from a sub-set of the cameras (e.g., cameras #1-#3) can be sent to a first volatile memory system or device (e.g., where “V1-V3” is one volatile memory device), and another sub-set of the cameras (e.g., cameras #4-#6) can be sent to a second volatile memory system or device (e.g., where “V4”-“V6” is one volatile memory device). The two second-stage processors (“GPU #1 or FPGA” and “GPU #2 or FPGA”) can then be coupled to the first and a second volatile memory systems or devices that are used to save images from the cameras. Images from three cameras are being processed by each of the second-stage processors (“GPU #1 or FPGA” and “GPU #2 or FPGA”) in optical inspection system 5000. In other cases, images from more or fewer than three (e.g., from 1 to 10) cameras can be processed by each second-stage processor. For example, “Camera N” could be coupled to either of the two second-stage processors (“GPU #1 or FPGA” and “GPU #2 or FPGA”), or to another second-stage processor (not shown).

In a second stage (“Stage 2 In-Memory Processing”) of optical inspection system 5000, the two second-stage processors (“GPU #1 or FPGA” and “GPU #2 or FPGA”) analyze the captured images using an AI model. For example, the AI model can be used to detect objects in each image from each camera, and add (or apply, or draw, or determine the size and location of) bounding boxes to each object in each image. The AI model can then output an indication or a determination of the quality (or classification, or category) for each object in each image. For example, the AI model can be used to determine whether an object is defective (i.e., is classified in a “bad” or “error” category) or non-defective (i.e., is classified in a “good” or “error-free” category). Images with error categories can be used by a customer (or operator) as a quality metric (or QA, or QC) or for further AI training (e.g., where the system employs active learning). The second-stage processors can also determine counts of acquired images (e.g., from all cameras, or from primary cameras only (e.g., positioned on one side of the objects)), and display the counts, e.g., in a report or on a display of a computing device, in real-time or near real-time. Such counts can be used, for instance, for QA, QC, and other types of tracking and email alerts.

In the second stage of optical inspection system 5000, 3D grading and/or USDA grading can also be done using an additional second-stage processor (“3D Grading CPU or FPGA”) (e.g., a CPU or FPGA), that further analyzes the images and information (generated from the analysis) from the two second-stage processors (“GPU #1 or FPGA” and “GPU #2 or FPGA”). In some cases, the cameras are paired and positioned to capture images of opposing sides of an object (or item), for example, objects that are in free-fall. Each pair of cameras can be mirror opposites, and one camera can be designated as a primary camera and the other camera in the pair can be designated as a secondary camera. Each of the images from the secondary cameras can be mirror reversed (i.e., where bounding boxes on the left would then appear on the right). After the mirror reversing, if a rightmost bounding box of an image from the secondary camera overlaps with a rightmost bounding box of an image from the primary camera, that indicates that the objects in the bounding boxes are the opposite sides of the same object. In such cases, during the grading in the second stage, only one grade is assigned to that object (e.g., the most severe categorization is used). In the second stage, the size of the bounding boxes can also be determined (e.g., based on a mapping from pixel size to actual size (e.g., millimeters)), and the size of each object can be determined. USDA grading can be done based on object weight. In some cases, an assumption is used where all objects within a batch have the same density, and therefore the size determined in the second stage can be used as a proxy to determine USDA weight grading. In some cases, a USDA report can then be generated.

In the second-stage of optical inspection system 5000, there may also be an optional ejector or a robot (e.g., a robotic arm) that ejects or removes defective objects (or objects classified as bad) or sorts objects into categories. For example, an ejector can include an air jet (or air stream) that is configured to eject defective objects (or items) out of a production (or sorting) line. The analysis and grading done in the second stage can be used to identify an object that is defective (as described above) and then the additional second stage processor (“3D Grading CPU or FPGA”) can send a signal (“action trigger”) to the ejector to eject the defective object from the production (or sorting) line in real-time. The systems and methods described herein, therefore enable the inspection of objects (e.g., fast-moving objects, objects in free-fall, or objects on a conveyor belt) and the ejection or removal of defective objects from the production (or sorting) line in real-time. The robot can be or may comprise a robotic arm (e.g., a mechanical arm) that is configured to remove defective objects (or items) out of a processing line.

In some cases, one, some, or all of the operations performed in the second stage are low latency operations.

In a third stage (“Stage 3 Persistent Processing”) of optical inspection system 5000, the images and/or information from the additional second-stage processor (“3D Grading CPU or FPGA”) can be saved in a third-stage storage system or device (“Write optimized or in-memory database”) (e.g., DRAM, SSD, or other persistent memory). For example, the images and/or information from the additional second-stage processor (“3D Grading CPU or FPGA”) can be saved in a write optimized or in-memory database.

In some cases, after the images are processed using the AI model in the second stage, they are also saved in the second-stage. In some cases, the images are saved in the second stage without a tabular structure (e.g., without a structure that can be processed by SQL queries). In some cases, the data that is saved in the second stage does not have a tabular structure and cannot interface with a database (e.g., using Microsoft Excel, or a third party customer database) and/or cannot be converted into a report. In some cases, the processor in the third-stage takes the unstructured images and/or data (including, for example, the bounding boxes) from the second stage write optimized pseudo database and then stores the images, the metadata of the images, and/or related data in a tabular format, which can allow for data visualization, or for report generation, or for saving the images and/or data and/or metadata for end user operator consumption.

In some cases of optical inspection system 5000, only images with defective objects (or items) are saved to the third-stage storage system or device (“Write optimized or in-memory database”), which can be an in-memory storage system (e.g., SSD, or other type of persistent memory). In some cases, the second-stage and/or third-stage storage system or device (“Write optimized or in-memory database”) is configured to enable images and/or metadata to be saved very quickly, so that the saving images in the second-stage and/or metadata in the third-stage can be done in real-time (or near real-time) (i.e., keeping up with the speed of image acquisition). Images with no defective objects (only objects classified in good categories) may not be saved to the second-stage and/or third-stage storage system or device (“Write optimized or in-memory database”) to save time and space, in some cases. In some cases, the images are not compressed (or are maintained in an uncompressed state) to reduce the time required to acquire, process, analyze and save the images.

An output, such as a report, may also be generated in the second and/or third stage of optical inspection system 5000. The report can include a QC report, for example, that is displayed in a user interface or written to a plant database (e.g., SAP, Microsoft Access, or Printer). The report generated in the third stage can be read by an operator. In some cases, the operator can then improve the AI model by adding more training data based on the generated reports using active learning, as described herein.

Many of the components of system 5000 can be located at the physical location of the objects being inspected, or they can be located in the cloud (e.g., at a datacenter, or other physical location). Some components (e.g., image capturing devices (“Camera 1”-“Camera N”), trigger sensor, and ejector) are located at the physical location of the objects being inspected. For example, first-stage processors (“P1”-“PN”) can be located at the physical location of the objects being inspected, and they can transmit the pre-processed images (e.g., using a high-speed data transfer method, such as 5G) to second-stage processors (“GPU #1 or FPGA” and “GPU #2 or FPGA”) located in the cloud. In some cases, captured images, pre-processed images, and/or other data (e.g., bounding box location, and/or grades) can be stored in third-stage storage system or device (“Write optimized or in-memory database”) located in the cloud. In some cases, the analysis, categorization and/or classification of the captured images (or an object in the captured images) can be performed by one or more processors (e.g., second-stage processors (GPU #1 and #2, or FPGAs) and/or additional second-stage processor (“3D Grading CPU or FPGA”) located in the cloud. In another example, the second-stage processors are located in the cloud, and the third-stage storage system is located at the location of the objects being inspected. In such cases, captured images, pre-processed images, and/or other data (e.g., bounding box location, and/or grades) can be sent to the cloud for processing, and then data can be sent back to the location of the objects being inspected for storage.

FIG. 4D shows an example of an optical inspection system 5001 that is similar to system 5000 in FIG. 4C. The system in FIG. 4D includes six (or more) image capturing devices (“Camera 1”-“Camera N”) and frame grabbers 4005 a-g (e.g., frame grabber cards), that receive images from the image capturing devices in a first stage and send the images directly to two second-stage processors 4030, 4040. The image capturing devices (“Camera 1”-“Camera N”) send area scans or line scans to the frame grabbers 4005a-g, which then send the line scans or frames to the second-stage processors 4030, 4040, as described with respect to FIG. 4B above. The second-stage processors 4030, 4040 can be GPUs, FPGAs, or ASICs. In this example, the first-stage storage system or device (“V1”-“VN”) and the first-stage processors (“P1”-“PN”) in system 5000 are omitted. Image capturing devices (“Camera 1”-“Camera N”) can be any devices capable of capturing a digital image that are compatible with DMA, such as PCIe devices including digital cameras, charge-coupled device (CCD) cameras, and digital video recording devices (i.e., digital video cameras). The frame grabbers 4005a-g and the two second-stage processors 4030, 4040 perform the functions of the first-stage storage system or device (“V1”-“VN”), the first-stage processors (“P1”-“PN”), and the second-stage processors in system 5000, including analyzing the captured images using an AI model. System 5001 can have lower latency between capturing an image and analyzing the image than system 5000, since storing the images in the first-stage storage system or device (“V1”-“VN”) and pre-processing them in the first-stage processors (“P1”-“PN”) in system 5000 takes time that is saved in system 5001.

In some cases, the first and second stages, or the first, second and third stages, or the first, second, third and fourth stages, of systems 4000, 4001, 5000, and/or 5001 can perform their respective functions on an image in real-time or near real-time, within a time period of less than about 0.1 ms, less than about 1 ms, less than about 3 ms, less than about 6 ms, less than about 10 ms, less than about 18 ms, or less than about 19 ms, or less than about 20 ms, or less than about 30 ms. An object in free fall, for example, may pass by the systems described herein in about 3 ms to about 6 ms, or about 18 ms to about 19 ms. Therefore, a real-time inspection, grading and/or ejection system and/or robotic system that operates in real-time, will be able to acquire image(s), analyze the image(s), output a determination of the quality of the object, save the images and/or information about the images, and/or report out the classifications and/or gradings, in less than about 3 ms to about 6 ms, or less than about 18 ms to about 19 ms. Ejection systems also have some amount of latency between receiving an ejection signal and performing an ejection operation (e.g., ejecting an object using a mechanical device, or air), which makes the timing requirements for the image capturing and grading or classification even shorter. For example, ejection systems can include latencies from about 1 ms to about 10 ms.

In practice, moving the captured images to the first-stage storage system or device (“S1”-“SN” or “V1”-“VN”) and the first-stage processors (“P1”-“PN”) (e.g., on to a CPU) first and then to the second-stage processors (e.g., onto a GPU) adds latency compared to systems 4001 and 5001 using DMA. This latency can be large, especially when processing one or more high-definition camera images, with strict timing requirements (e.g., about 5 ms, or less than about 10 ms, for some sorting methods).

For example, the systems 4001 and 5001 shown in FIGS. 4B and 4D can use frame grabbers to collect each line of an image from a line-scan image capturing device (e.g., 1×1000 pixels) and then use the frame grabbers or second-stage processors to combine or stitch together the lines into frames (e.g., 100×1000 pixels). However, instead of the images landing in the first-stage storage system or device (“S1”-“SN” or “V1”-“VN”) as in systems 4000 and 5000, the images are provided directly to the memory of the second-stage processors 4010, 4020, 4030, 4040 for direct processing. The memory of the second-stage processors 4010, 4020, 4030, 4040 (e.g., GPU memory) is included within the second-stage processors shown in FIGS. 4B and 4D. In systems 4001 and 5001, the first stage includes the capturing of the image using the image sensors and grabbing the lines or frames using the frame grabbers, and the storage and processing steps in the first stage are omitted.

In systems 4001 and 5001, the image capture devices and frame grabbers can be video switchers, HD-SDI (High-Definition Serial Digital Interface) capture devices, or CameraLink devices, that are compatible with DMA and directly transfer frames in and out of the memory of the second-stage processors 4010, 4020, 4030, 4040. A benefit of the system architectures shown in FIGS. 4B and 4D is that the second-stage processors (e.g., GPUs) and the frame grabber share the same system memory, which can eliminate or mitigate a bottleneck of systems that use a separate processor (e.g., a CPU) to copy from the frame-grabber to a GPU system buffer. In these systems, a CPU can be used for some operations such as control operations, while all or most of the data operations are done using the second-stage processors 4010, 4020, 4030, 4040.

The resolution of the captured images in the systems and methods described herein, for example, the systems shown in FIGS. 1-3 and 4A-4D can be high (e.g., greater than 100,000 pixels, or greater than 1 megapixel for area-scan devices) or low (e.g., less than 100,000 pixels, or less than 10,000 pixels for area-scan devices). For example, images captured using area-scan image capturing devices can have a number of pixels in a vertical direction from about 100 to about 10,000, or about 1000, or about 2000, or about 4000, or about 10,000 pixels, and a number of pixels in a horizontal direction from about 100 to about 10,000, or about 1000, or about 2000, or about 4000, or about 10,000 pixels. Images captured using line-scan image capturing devices can have a number of pixels from about 100 to about 10,000, or about 1000, or about 2000, or about 4000 pixels in one direction.

In some cases, systems 4000, 4001, 5000, and 5001 shown in FIGS. 4A-4D can use pipelining in the second-stage processors (e.g., 4010, 4020, 4030, 4040 in FIGS. 4B and 4D). For example, when processing one or more high-definition camera images within a period of time (e.g., about 5 ms), pipelining enables the efficient grabbing of lines or frames, combining the lines or frames into larger images (e.g., with hundreds of thousands of pixels), and performing AI model inference in parallel. For example, intermediate results can be staged in memory buffers in the second stage (e.g., the memory of the second-stage processors 4030, 4040) and reused to reduce data transfer to and from the second-stage processors. Pipelining can be advantageous to minimize latency and maximize processing throughput. In some cases, the second-stage processors 4010, 4020, 4030, 4040 in FIGS. 4B and 4D can use pipelining in combination with DMA to further improve the performance and latency compared to the systems 4000 and 5000 in FIGS. 4A and 4C.

In some cases, the systems shown in FIGS. 4A-4D can include one second-stage processor (e.g., 4010 or 4020 in FIG. 4B, and 4030 or 4040 in FIG. 4D). In some cases, the systems shown in FIGS. 4A-4D can include more than two, or from one to ten, or more than ten, second-stage processors. The additional second-stage processors can be used in parallel (as shown in FIGS. 4A-4D) to increase the processing capacity of the systems. For example, the additional second-stage processors can be used to increase the processing capacity of the system for stitching, preprocessing, and/or AI model inference processing blocks, as described herein. This can be beneficial, for example, to analyze higher resolution images, analyze images from more image capturing devices in parallel, improve the speed, and/or reduce the latency of the system.

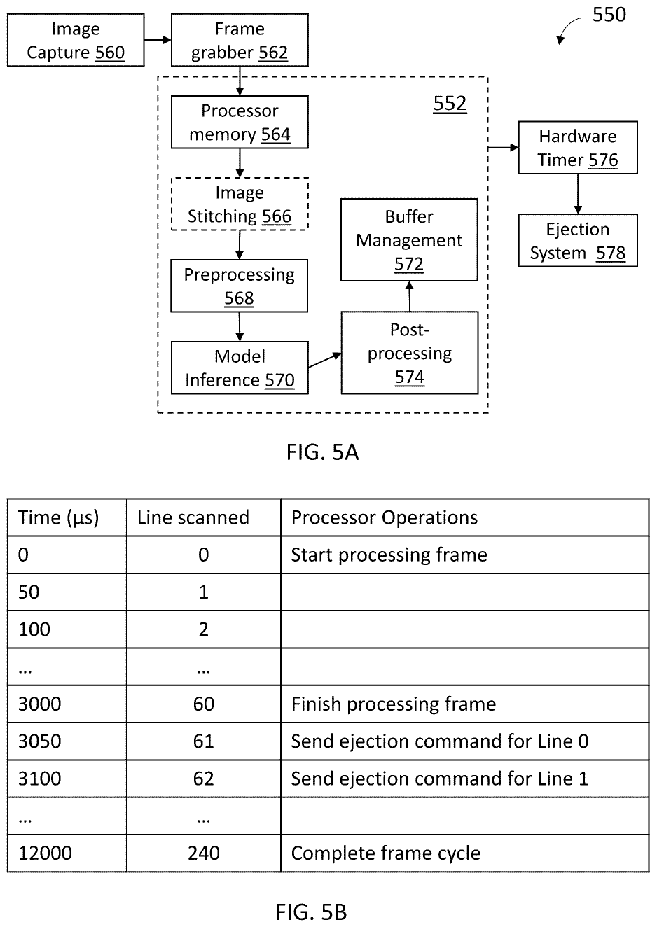

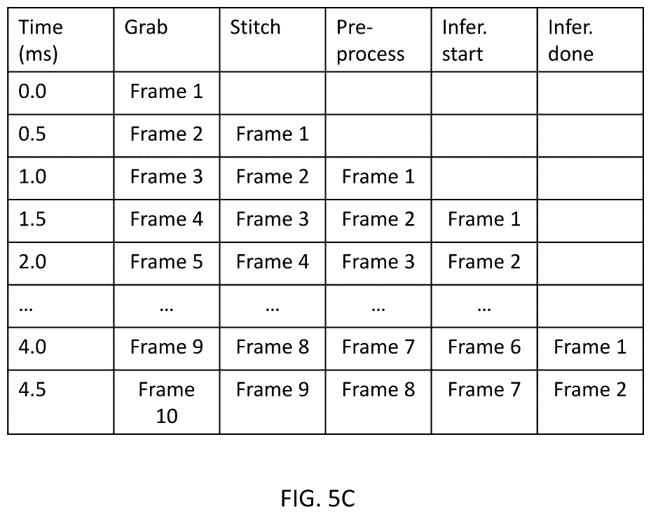

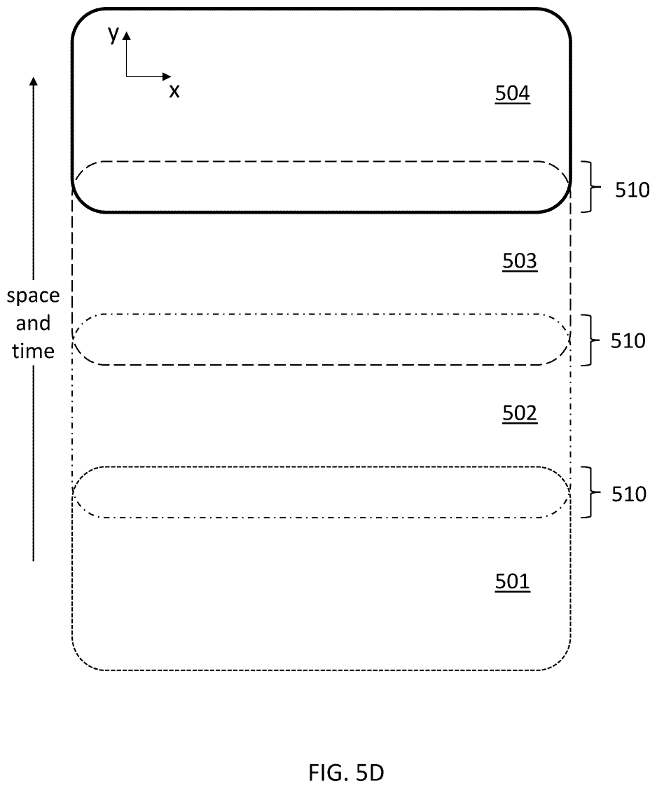

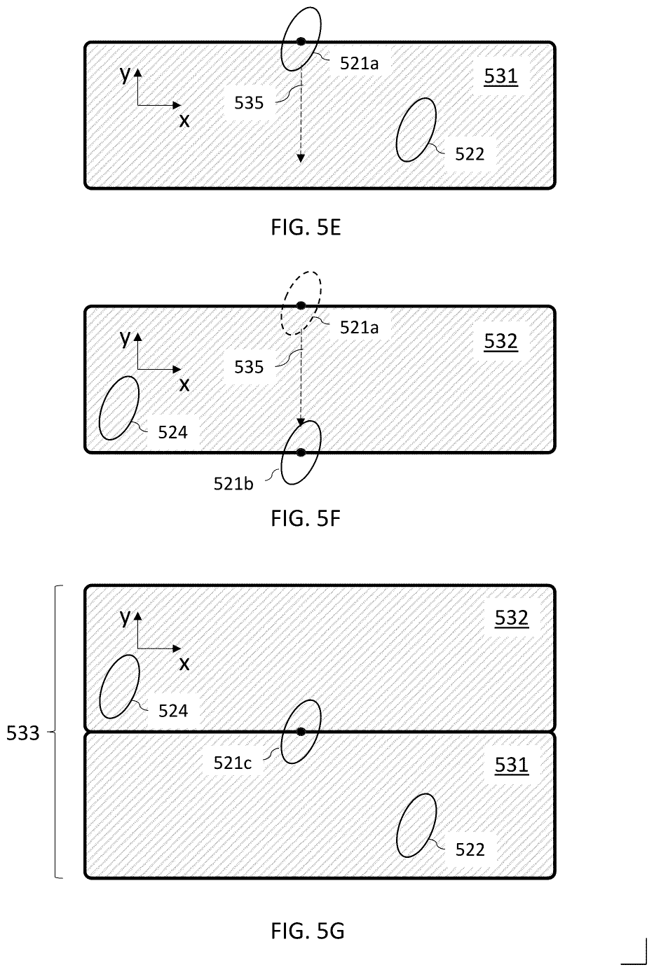

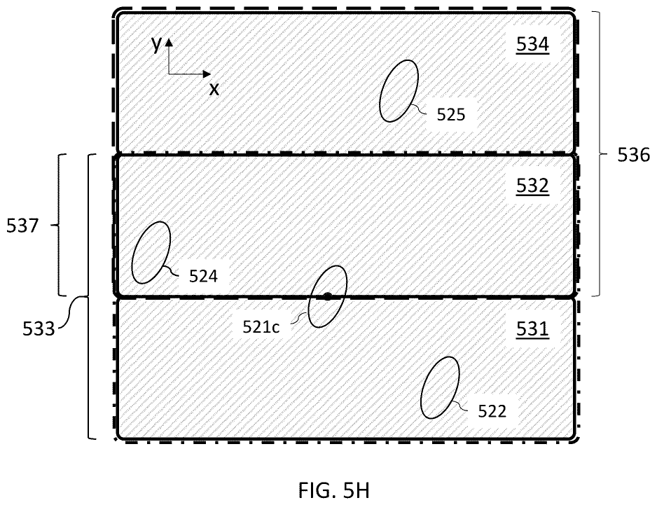

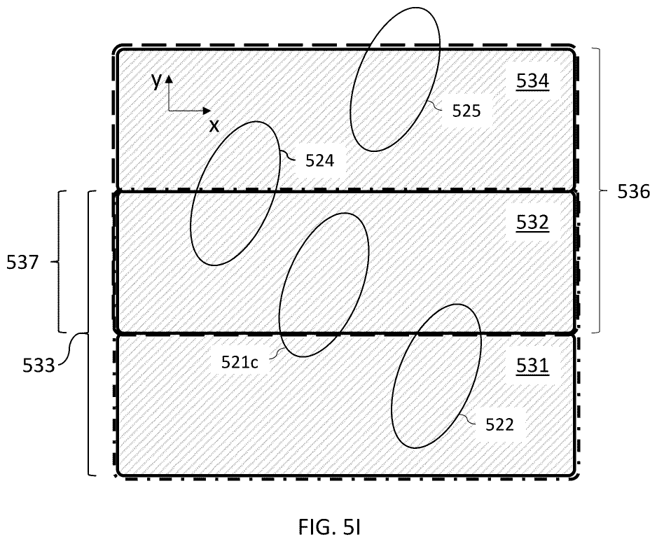

FIG. 5A shows an example system 550 including operations (i.e., processing blocks) to capture images, analyze the images, and trigger an ejection system based on the analyzed images. In system 550, an image is captured in block 560 using an image capturing device. In block 562, a frame grabber is used to receive the images from the image capturing device and send the images to a processor (e.g., a GPU, FPGA, or ASIC). The operation blocks in set of blocks 552 can be performed by the processor. In block 564, the images are sent from the frame grabber to the processor memory. In block 566, images from the frame grabber are stitched together (i.e., combined), as described herein. In other cases, the images can be stitched together in the frame grabber 562, and block 566 can be omitted.

In preprocessing block 568, the stitched images are pre-processed before the model inference block 570. Pre-processing can include one or more of, padding, region of interest (ROI) extraction, image formatting, and Bayer decoding.

For example, the images can be padded with extra pixels (e.g., around the edges of the image) to make the image the right shape, size, or alignment for further processing. For example, stitched images from line-scans can include irregular edges (e.g., jagged or trapezoidal edges). In such cases, padding can be done during pre-processing in block 568 to fill in missing areas to keep the image rectangular. This can be beneficial since some image processing algorithms require images with a certain size (e.g., multiples of 8, 16, or 32 for convolution layers) or shape (e.g., rectangular). Additionally, when applying convolution filters, CNNs, or FFTs, padding can help avoid losing edge information. For example, if a stitched image is convolved without padding, the edges can shrink, while the full field can be preserved if padding is done before the convolution.

In another example, ROI extraction can also or alternatively be done in preprocessing block 568. ROI extraction includes cropping the image to keep only a specific area (region of interest). This can be beneficial to save bandwidth and memory, as well as speed up processing, since a smaller amount of data needs to be processed. Alternatively, ROI extraction can be done in frame grabber 562, which allows for a portion of the image including the ROI to be sent to the processor using DMA rather than the entire image.

In another example, image formatting can also, or alternatively, be done in preprocessing block 568. In some cases, the layout, pixel format, or data organization of the image can be formatted to match what the next stage in the processing or pipeline expects. For example, the images can be reformatted to do one or more of: convert from packed formats (e.g., 12-bit pixels packed into 3 bytes) to aligned formats (e.g., 16-bit per pixel); reorder color channels (e.g., BGR to RGB); tiling or rearranging line-scan data into a contiguous 2D array (which is similar to or the same as stitching in block 566); and adding and/or removing headers or metadata. This can be beneficial because processors (e.g., GPUs, FPGA, or ASIC) and AI models (or ML models) often require a specific memory layout (e.g., stride, alignment, interleaving), and such formatting during the preprocessing in block 566 can ensure the data is processable in model inference block 570. Alternatively, image formatting can be done in frame grabber 562, and the formatted image can be sent to the processor using DMA.

In another example, Bayer decoding (i.e., demosaicing) can also or alternatively be done in preprocessing block 568. Alternatively, Bayer decoding can be done in the camera in image capture block 562, or in the frame grabber block 562, and the Bayer decoded image can be sent to the processor using DMA.

In model inference block 570, the preprocessed images are analyzed using one or more AI models, as described herein (e.g., with respect to the operations performed using the second stage processors (“GPU or FPGA”), 4010, 4020, 4030, and 4040 in FIGS. 4A-4D).

In post-processing block 574, the image is post-processed after the AI model (e.g., object detector) generates raw predictions in model inference block 570. In some cases, result formatting and filtering steps (e.g., non-maximum suppression (NMS)) are performed in post-processing block 574. In some cases, when analyzing an image, object detection models (e.g., YOLO or Faster R-CNN) propose many overlapping bounding boxes for the same detected object. A post-processing operation such as NMS filtering can be performed to sort all predicted boxes by confidence score (highest first) and keep the highest-scoring box. The NMS filter can also suppress or discard all other boxes that overlap it above a certain threshold (e.g., measured by IoU). The advantage of performing such filtering is that each real object is represented by just one bounding box, which is the one that has the highest confidence, and redundant or false positives are greatly reduced.

In buffer management block 572, chunks of memory (i.e., buffers) can be organized, allocated, reused, and/or moved to move results and/or images around efficiently. This can be beneficial to reduce latency in systems where a continuous stream of images is analyzed. For example, in the case of DMA transfers, buffer management can be used to determine which buffer in the processor memory the DMA engine writes into.

In hardware timer block 576, a signal is received from the processor indicating that an ejector should be used to eject an object. The signal is based on the operations performed in set of blocks 552 to classify an object. In ejection system 578, a signal is received from hardware timer 576 to trigger or actuate an ejector to eject an object. For example, an object can be classified as defective in set of blocks 552, and hardware timer in block 576 can send a signal to the ejection system to eject the object (e.g., into a reject bin instead of a product collection bin) in block 578. The ejection system in block 578 can use compressed air, a physical ejector, or a robotic arm, as described further herein.

The total time to perform the frame grabber block 562 and set of blocks 552 can be from about 0.1 ms to about 10 ms, from about 0.3 ms to about 3 ms, less than about 0.1 ms, less than about 1 ms, less than about 3 ms, less than about 6 ms, or less than about 10 ms, about 1 ms, about 3 ms, about 5 ms, or about 10 ms. For example, the frame grabbing block 562, image stitching block 566, preprocessing block 567, post-processing block 574, and buffer management block 572 can each take from about 0.1 to about 1 ms, or less than 0.1 ms. The model inference block 570 can take from about 0.5 ms to 5 ms, or less than 0.5 ms. These fast total processing times are beneficial for real-time inspection and sorting of moving objects, especially objects in free-fall which can pass from a position of image capture to a position of ejection in times that are less than 10 ms, or less than 20 ms.

In some cases, the system 550 in FIG. 5A can be used to analyze images using an image processing pipeline, which can include one or more of:
zero-copy operations, that keep data in GPU memory throughout;
overlapping operations with pipeline parallelism;
memory pre-allocation (e.g., to void dynamic allocation in the loop);
batch processing (e.g., to process multiple images simultaneously);
optimized inference model(s) (e.g., using quantization and pruning techniques); and
real-time GPU pipelining for the inference model(s).

FIG. 5B shows an example of a process time sequence that can be performed using system 550 of FIG. 5A, including sending signals from the set of blocks 552 to the hardware timer block 576 and the ejection system block 578. In this example, a line is scanned every 50 microseconds (e.g., using the image capture block 560 and the frame grabber block 562), starting at “Line 0.” The processor (e.g., a GPU, FPGA, or ASIC) starts processing a frame at 0 microseconds, and completes processing the frame at 3 ms. Ejection commands are then sent 50 microseconds after the frame processing is completed, starting with Line 0 at 3050 microseconds. Ejection commands are then sent for each subsequently scanned line every 50 microseconds, as shown.

In some cases, the systems and methods described herein use parallel processing of subsequent images, which is referred to as pipelining. Pipelining can advantageously minimize latency and maximize processing throughput by processing some blocks in parallel. For example, one or more of the processing blocks including, the frame grabber processing block 562, the data transfer from the frame grabber to the processor memory processing block 564, stitching processing block 566, the preprocessing processing block 568, and the model inference processing block 570, the post-processing processing block 574, and the buffer management processing block 572, can occur in parallel.

FIG. 5C shows an example of pipelining, which can be used in combination with the systems and methods described herein (e.g., system 550 in FIG. 5A). In this example, a first frame (“Frame 1”) is received at the frame grabber at time 0.0 ms. Note that in examples with line-scan image capturing devices, the frame grabber can send individual lines to be stitched together rather than whole frames. At time 0.5 ms, the first frame is being stitched together, and a second frame (“Frame 2”) is being grabbed by the frame grabber. At time 1.0 ms, the first frame is being pre-processed, the second frame is being stitched together, and a third frame (“Frame 3”) is being grabbed. At time 1.5 ms, the model inference is started on the first frame, the second frame is being pre-processed, the third frame is being stitched together, and a fourth frame (“Frame 4”) is being grabbed. At time 2.0 ms, the model inference is continued on the first frame, the model inference is started on the second frame, the third frame is being pre-processed, the fourth frame is being stitched together, and a fifth frame (“Frame 5”) is being grabbed. This sequence continues until, at time 4.0 ms, the model inference is completed on the first frame, the model inference is started on a sixth frame (“Frame 6”), a seventh frame (“Frame 7”) is being pre-processed, an eighth frame (“Frame 8”) is being stitched together, and a ninth frame (“Frame 9”) is being grabbed. In this example, Frame 1 through Frame 5 are in the model inference stage simultaneously, and the system uses the processing power in the processors (GPUs, FPGAs, or ASICs) to process them in parallel without adding additional latency. The sequence then continues, for example, at time 4.5 ms, the model inference is completed on the second frame, the model inference is started on the seventh frame, the eighth is being pre-processed, the ninth frame is being stitched together, and a tenth frame (“Frame 10”) is being grabbed. Therefore, in this example, after a 4.0 ms start-up time, the system can analyze an image every 0.5 ms. For example, the processor can send an instruction to the hardware timer in block 576 in system 550 every 0.5 ms.

FIG. 5D shows a schematic of an example method for processing a sequence of images, where there is overlap 510 in both space and time between subsequently processed images. This can be accomplished by taking sequential lines or frames, which are stitched together before being processed by the AI models. The schematic in FIG. 5D shows a first image 501, which has dimensions in the x-and y-directions as shown. For example, the image can be from about 100 to about 10,000 pixels in the x-direction and from about 100 to about 10,000 pixels in the y-direction. FIG. 5D also shows a second, third, and fourth image 502, 503, and 504, respectively, each with the same x-and y-dimensions. Images 501-504 are images that are analyzed by the AI model (e.g., in the second-stage processors 4030, 4040 in FIG. 4D). In this example, image 501 can include several lines or frames stitched together, and a subsequent image 502 can include the last set of lines or frame of the previous image as well as new lines or frames. In the example shown in FIG. 5D, the subsequent image is stitched on top of a previous image (i.e., with the last captured line of the subsequent image stitched above the first captured line of the previous image), in such a way that it overlaps 510 in space and time with the previous image by an overlap distance.

The overlap distance 510 in FIG. 5A can vary, for example, based on the size of the objects being imaged. For example, the overlap distance 510 can be from about 0 pixels or lines to about 150 pixels or lines, from about 0 pixels or lines to about 100 pixels or lines, from about 0 pixels or lines to about 128 pixels or lines, from about 0 pixels or lines to about 64 pixels or lines, from about 0 pixels or lines to about 50 pixels or lines, from about 0 pixels or lines to about 32 pixels or lines, about 16 pixels or lines, about 32 pixels or lines, about 50 pixels or lines, about 64 pixels or lines, about 100 pixels or lines, or about 128 pixels or lines.

FIGS. 5E-5G show an example to further explain the above method for capturing a sequence of images. In FIG. 5E, a first image 531 is taken at a first instant in time of an image capture area. In this example, an object 521a is partially in the frame, and object 522 is in the frame. Both objects 521, 522 are falling through the image capture area in a direction 535.

In FIG. 5F, a second image 532 is captured at a second instant in time of the same image capture area as image 531. Since the image capture area (or line in the case of a line-scan device) does not change position, the two images 531, 532 have 100% overlap in space. The object 521a from FIG. 5E has fallen and is now in the position shown for object 521b. In other words, objects 521a and 521b are the same object, but are in different positions in the image because they have moved between the first and the second instants in time.

FIG. 5G shows an example where the images 531 and 532 are stitched together, such that image 532 is placed above image 531. The object 521c is the same object as 521a and 521b, and is a whole object in the stitched image 533 which contains images 531 and 532 stitched together. At neither instant is the object completely within the image capture area, however, by stitching together two sequential images, the object is completely within the stitched image 533. The stitched image 533 can then be sent to the AI model (e.g., in the second-stage processors 4030, 4040 in FIG. 4D) for analysis. Having a complete image of an object in an image being analyzed by the AI model can improve the accuracy of the AI classification and/or grading significantly.

FIG. 5G shows examples of images that are taken sequentially in time that have been stitched together. In some cases, the image capture frequency, or the time interval between capturing images, is synchronized with the rate of movement of the objects. For example, if an object takes 1 ms to traverse the image capture area (e.g., from top to bottom when falling), then the interval between capturing images can also be 1 ms.

In FIG. 5H, a third image 534 has been captured, which includes object 525. The third image 534 can be stitched together with the subsequent image 532 to form a new image 536 that can be analyzed by the AI model, as described above. The method can continue in this way, with each subsequent image containing a portion of the previously analyzed image, the overlap region 537 in this example. As shown in FIG. 5H, stitched image 533 and subsequent stitched image 536 overlap in both space and time in overlap region 537.

FIG. 5I shows an example of images that are taken sequentially in time that have been stitched together. In this example, the objects 521c, 522, 524, and 525 are larger compared to the size of the image than the example shown in FIG. 5H. It can be advantageous for an object to be imaged in a single image by stitching subsequent images together, as described herein. Correspondingly, the height of the stitched images 533, 536 that are analyzed by the AI models can be chosen such that the maximum height of an object is smaller than the height of the stitched image. However, images of portions of objects can also be analyzed using the systems and methods described herein.

Systems and methods that enable the overlap of consecutive images, as shown in FIGS. 5D and 5C and described above, are beneficial to improve the fraction of objects that can be captured in a single image, rather than be split between two images. When images are collected consecutively, it is common that small objects (e.g., almonds) moving through the field of view of the cameras will be partially covered between two consecutive images (e.g., as shown in FIG. 5B). The probability of such an event occurring also increases as the size of the objects increases relative to the height of the analyzed image. The cases shown in FIGS. 5D-5I have overlap between two consecutive images that the AI models can process.

In some cases, an object can be detected that is to be ejected (e.g., sorted), and a trigger is sent from the processor to the hardware timer or ejector. In some cases where subsequent images include some overlap region, the trigger will only be sent for objects detected in the new, or non-overlapped area. For example, in FIG. 5H, an object detected in frame 534 can cause a trigger to be sent to the ejector, but objects detected in frame 532 would not cause a trigger to be sent. This can be advantageous so that two trigger signals are not sent for the same object.

Systems and methods in FIGS. 5A-5I are compatible with the systems shown in FIGS. 1-3, and 4A-4D to capture images and provide them to the storage systems and processors in the systems. For example, the systems and methods in FIGS. 5A-5I can enable the capture and processing of images using the systems shown in FIGS. 1-3, and 4A-4D.

In some cases, images can be captured using area scan image capturing devices, or line-scan image capturing devices at the line rate, as described herein. For example, images can be stitched together such that a subsequent image overlaps the previous image with an overlapping spatial region between the images. Therefore, there is an overlap region (e.g., about 8 lines, about 16 lines, about 32 lines, about 50 lines, about 64 lines, or about 100 lines) in space between consecutive captures. The previous image (e.g., 501 in FIG. 5D), the overlapping image (e.g., 510 in FIG. 5D), and the next image (502 in FIG. 5D) can all be stitched together (e.g., in the second stage GPU, FPGA, or ASIC processor).

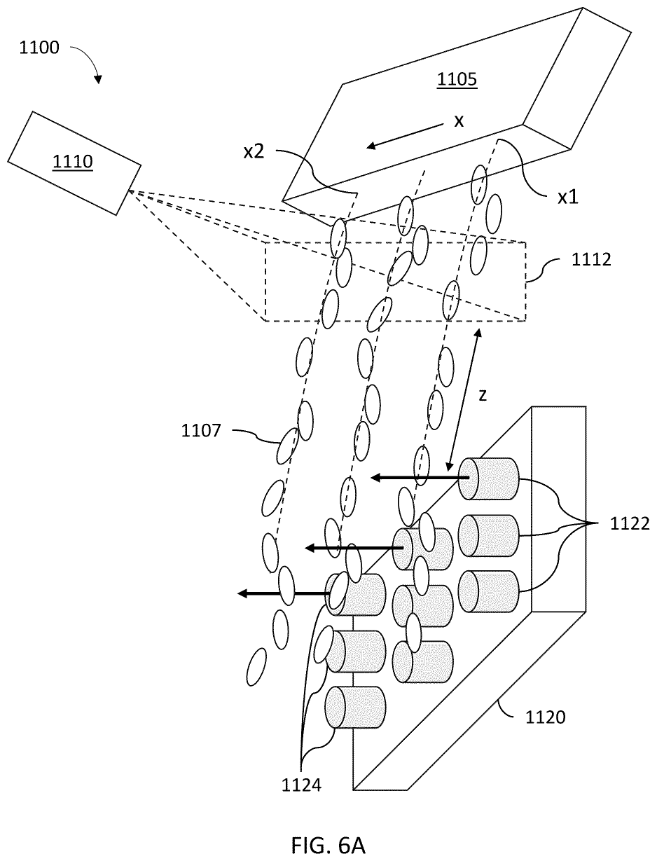

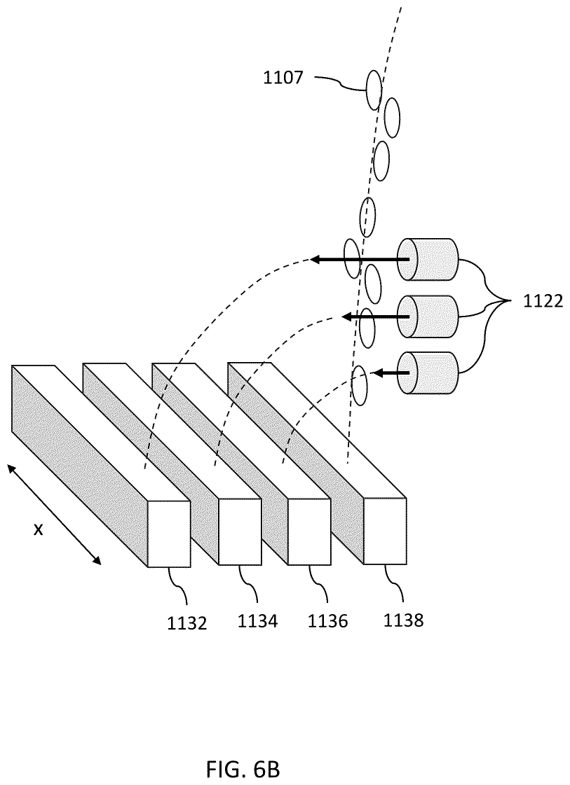

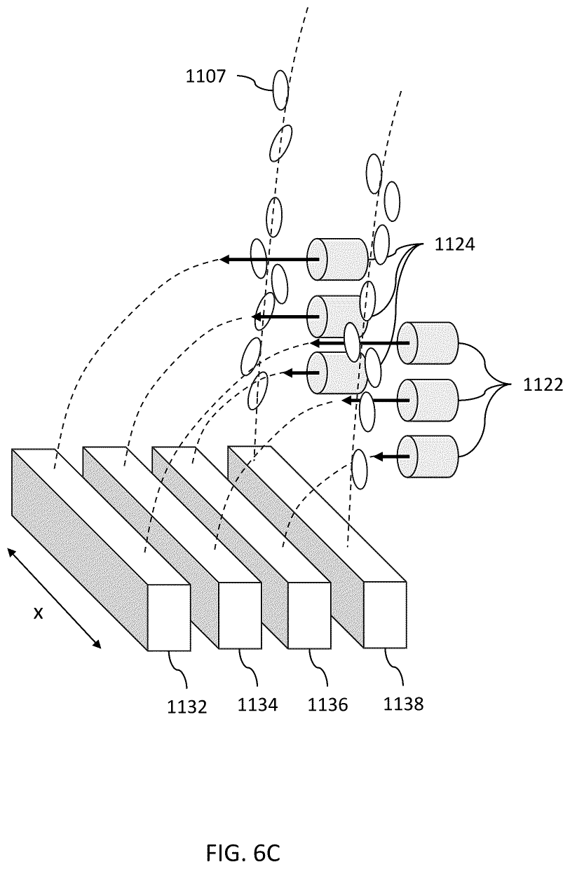

FIG. 6A shows an example optical inspection system 1100 including a chute 1105 out of which a set of objects 1107 are falling. The objects pass an image capture area 1112 of an image capturing device 1110, and pass in front of ejector 1120. The objects 1107 fall out of chute 1105 at different positions along an x-axis, as shown in a simplified way in FIG. 6A where only three x-positions are shown by the dotted lines depicting approximate paths that the objects 1107 will take as they fall out of the chute 1105. The objects falling approximately at a first x-position (“x1”) pass in front of a first set of ejectors 1122, and objects falling approximately at a second x-position (“x2”) pass in front of a second set of ejectors 1124. The objects traverse the distance (“z”) between the image capture area 1112 to the ejectors 1120, which equates to an amount of time when the objects are in free fall. For example, the distance “z” can be from about 0.1 m to about 1 m, or from about 0.1 m to about 0.5 m, and the time between the image capture area 1112 to the ejectors 1120 can be less than about 20 ms, or less than about 10 ms.

In some cases, the ejector 1120 is used to reject defects (e.g., less than 5% or less than 10% of falling objects 1107) by ejecting them (e.g., using puffs of air) into a reject container, while the remaining items (e.g., more than 95% or more than 90% of falling objects 1107) are collected in an accept container. In some cases, the ejector 1120 is used to sort objects into categories (e.g., premium/high/normal/discount grades, or small/medium/large sizes). In such cases, most or all of the falling objects 1107 can be ejected or diverted (e.g., using puffs of air) into one or more sorting containers, while the undiverted objects 1107 are collected in a container below the falling objects 1107. For example, about 10% of objects 1107 could be ejected or diverted using the ejectors 1120 into a first container (e.g., a reject bin), about 20% of objects could be ejected or diverted using the ejectors 1120 into a second container (e.g., premium grade #1), about 30% of objects 1107 could be ejected or diverted using the ejectors 1120 into a third container (e.g., premium grade #2, which is lower quality than premium grade #1), and the remaining about 40% can be undiverted by the ejectors 1120 and can be collected in a fourth container (e.g., an accepted grade, or a baseline grade).

FIG. 6B shows an example of a set of ejectors 1122, which are a subset of the ejectors 1120 in system 1100 in FIG. 6A. In this case, set of ejectors 1122 includes three ejectors, each of which can physically exert an amount of force on an object such that the path of the object is diverted into a collection bin 1132, 1134, 1136. A fourth collection bin 1138 is positioned below the stream of falling objects 1107 such that they will fall into the bin 1138 if they are not diverted using the set of ejectors 1122. For example, the set of ejectors can include air jets that shoot a jet of compressed air at the falling object 1107. In other cases, the ejectors can use mechanical actuators or robotic arms to divert the path of, or pick up, moving objects, as described further herein. In this example, objects 1107 pass a first ejector of the set of ejectors 1122, which exerts a relatively large force that diverts a falling object 1107 into a far bin 1132. The objects then pass a second ejector of the set of ejectors 1122, which exerts a relatively moderate force that diverts a falling object 1107 into a middle bin 1134. The objects then pass a third ejector of the set of ejectors 1122, which exerts a relatively small force that diverts a falling object 1107 into a close bin 1136. The set of ejectors 1122 in this example is advantageous for objects that are moving very quickly (e.g., in free-fall) since each ejector ejects an object from one position to a particular bin without needing adjustment between ejection events, which reduces latency times. For example, an ejector can have an ejector latency time (i.e., the time from when the ejector receives a signal to eject an object to when it exerts a force on the object) of less than about 10 ms, or less than about 5 ms, or less than about 3 ms, or less than about 1 ms, or less than about 0.5 ms, or less than about 0.1 ms.

FIG. 6C shows an example of two sets of ejectors 1122, 1124, from the ejectors 1120 in system 1100 in FIG. 6A, at two different x-positions. This example illustrates that a two dimensional (2D) array of ejectors with sets of ejectors at different x-positions, and at different heights or distances relative to the moving objects, can be used to divert or sort objects falling at different x-positions into different bins. This is advantageous to be able to sort any object, irrespective of x-position, into any collection bin.

Three ejectors 1122, 1124 per x-position, and four collection bins 1132, 1134, 1136, and 1138 are shown in this example. In other cases, the systems and methods described herein can include from one to 20 ejectors, or more than 20 ejectors, at each x-position, such that objects can be ejected or sorted into 20 or more collection bins across the entire x-position range of the chute. Additionally, there can be from 1 to 100 x-positions, or more than 100 x-positions. The number of x-positions can be related to the size of the objects being ejected. For example, ejectors can be spaced at x-position intervals about the size of an average length or an average width of the objects, or at about one half, at about 1.5 times, or at about twice the average length or average width of the objects. In some cases, collection bin 1138 can be omitted, and all of the falling objects 1107 can be diverted by the ejectors 1120.

Returning to FIG. 5A, in hardware timer block 576, the system can use known or calculated time delays to send signals to the ejection system 578 (e.g., ejectors 1120 in FIG. 6A) at the correct times and correct x-positions to divert the path of an object into a collection bin. Ejection system 578 can include air jets that shoot a jet of compressed air at the falling objects, mechanical actuators, or robotic arms, to divert the path of, or pick up, moving objects, as described further herein. For example, the hardware timer can send signals to the ejection system 578 at fixed intervals, for example, at intervals from about 0.01 ms to about 0.2 ms, or about 0.01 ms to about 0.1 ms, or about 0.02 ms, or about 0.05 ms, or about 0.1 ms. In some cases, the set of blocks 552 of the processor, the hardware timer block 576, and the ejection system block 578 include memory-mapped input/output (I/O) to achieve low command latency (e.g., sub-microsecond, less than 10 ms, or less than 100 ms). In some cases, the system 550, including the set of blocks 552 of the processor, the hardware timer block 576, and the ejection system block 578, can use a real-time operating system (OS) or kernel bypass to achieve accurate and deterministic timing.

The systems and methods described herein can use line-scan cameras or area scan cameras. Some differences between line-scan cameras and area scan cameras are the size of the images sent from the camera to the frame grabber and to the processor, and how the images are stitched together. Another difference is that line-scan cameras are synchronized with the motion of the objects, for example, using fixed timing or triggers from sensor inputs. For example, the image capture area 1122 in FIG. 6A can be a single line for line-scan cameras, and multiple lines (e.g., 8, 16, 32, 50, 64, 100, 128, 150 lines, or more than 150 lines) for area scan cameras.

FIG. 6D shows an example of a line-scan camera with an image capture area 1116 that is a single line of an image. The line-scan camera 1110 takes a first line of an image of an object 1107 and waits an amount of time while object 1107 moves to a new position (e.g., due to free-fall), and then the line-scan camera takes a subsequent line of the image. Only one object 1107 is shown in FIG. 6D for simplicity; however, many objects can be analyzed at once using line-scans. Even though the same area of space is being imaged, a different section of the one or more objects in the image capture area are imaged, since the one or more objects have moved (e.g., due to being in free-fall, or moving on a conveyor). The image of the object(s) is captured over time as the object moves through the image capture area. The distance “z” between the image capture area and the ejectors dictates the total time allotted for analysis of the image and sending a trigger signal to the ejectors 1120, including latency added by the ejectors 1120.

For example, a line-scan camera can capture a line every about 100 microseconds (μs), or from about 10μs to about 500 μs, or from about 50 μs to about 1 ms. For example, if 20 mm long object (e.g., an almond) is falling at a rate of 3 m/s, it will travel 20 mm in about 6.7 ms. Capturing line-scans using the line-scan camera every 667 μs will capture the object in about 10 lines, capturing line-scans using every 133 μs will capture the object in about 50 lines, and capturing line-scans using every 67 μs will capture the object in about 100 lines.

In some cases, the ejection signals or commands are also synchronized with the line-scan capture rate. For example, a signal to trigger an ejection can be sent every about 100 μs, or from about 10 μs to about 500 μs, or from about 50 μs to about 1 ms. This can be advantageous, since the line-scan capture rate is synchronized with the object motion, the ejection signals will also be synchronized with the object motion. For example, a line-scan camera can scan one line every about 100 μs and a signal can be sent to an ejection system (e.g., 1120 in FIG. 6D) every about 100 μs.

Parallel processing or pipelining can also be used to capture a line-scan, while processing previously captured line-scans. For example, referring again to FIG. 5H, a set of line scans can be stitched together to form a first stitched image 531, a second set of line scans can be stitched together to form second stitched image 532, and a third set of line scans can be stitched together to form third stitched image 534. In parallel with the analysis of the first image 531, the second image 532 can be being stitched together, and the third image 534 can be being grabbed by the frame grabber (similar to the example shown in FIG. 5C). In some cases, the frame grabber can grab individual lines from the line-scan camera, and stitch them together into stitched images 531, 532, 534 (e.g., 8, 16, 32, 50, 64, 100, 128, 150 lines tall, or more than 150 lines tall), then each of these stitched images can be sent to the processor. The processor (e.g., GPU, ASIC, or FPGA) can then stitch together the first stitched image 531 and the second stitched image 532 before analyzing the images using an AI model.

FIGS. 6A-6D show examples where objects 1107 are falling from a chute 1105. In other examples, the objects 1107 can be moving on a conveyor (as described herein), past the image capturing device 1110 and the ejectors 1120. Objects moving on a conveyor can be moving at a slower rate than objects in free-fall, which can translate into longer times between imaging and ejection. Therefore, in some cases, objects moving on a conveyor can be inspected or sorted using slower systems and methods, while inspecting or sorting objects in free-fall can be done using faster systems with lower latency.

### AI MODEL TRAINING

In some cases, the AI models used in the systems and methods described herein are trained using synthetic data. In some cases, the synthetic data can be obtained by 1) collecting representative objects, 2) taking images of the representative objects from different angles, 3) masking and/or cropping each of the images, 4) creating a 3D model of the images using photogrammetry, and 5) creating a set of training data images from the 3D model.

In some cases, from 10 to 500, from 20 to 100, or from 50 to 60 representative objects are collected, from which the synthetic data is generated. The representative objects can include multiple (e.g., about 10, or about 20, or from 10 to 30, or from 10 to 50, or from 10 to 100) objects from each of the different classifications (or classes, or categories, or grades) that the system will use. Some examples of classifications (or classes, or categories, or grades) are related to quality (e.g., defective, non-defective), category (e.g., type-A, type-B), size (e.g., small, large), shape (e.g., round, square), and color (e.g., white, black, uniform, non-uniform).

The images from different angles can be taken using a digital camera, and in some cases, using the same camera(s) that will be used on the actual optical inspection systems described herein. In some cases, the images are taken from about 20 (or about 10, or about 50,or from about 10 to about 100) different angles that encompass 360-degrees around an axis of the object. In some cases, a first set of images are taken from about 20 (or about 10, or about 50, or from about 10 to about 50) different angles that encompass 360-degrees around a first axis of the object, and a second set of images are taken from about 20 (or about 10, or about 50, or from about 10 to about 50) different angles that encompass 360-degrees around a second axis of the object. The first axis can be perpendicular to the second axis, or the first axis and the second axis can have an angle between them, such as an angle of 45 degrees or an angle between 0 degrees and 90 degrees. In some cases, a first set of images are taken from about 20 (or about 10, or about 50, or from about 10 to about 50) different angles in a first loop that surrounds the object (i.e., where the camera is approximately level with the object), and a second set of images are taken from about 20 (or about 10, or about 50, or from about 10 to about 50) different angles in a second loop that is located above the object (i.e., where the camera is above the object and oriented to capture images of the object from different angles from above).

In some cases, the same background and lighting conditions used in the actual optical inspection system are used to generate the images for the training data. For example, if the color (or wavelength) of light is cool white during the actual data collection and AI model inference by the optical inspection system, then it is desired to use the same cool white LED light during the synthetic data creation. In some cases, more than one light, or multiple lights, are used to simulate the actual lighting conditions (e.g., reflected light, multiple lights illuminating an object) used for one side or both sides of an object.

In some cases, the images are then masked and/or cropped to remove some or all of the background. For example, an image editing program (e.g., Adobe photoshop) can be used to mask and/or crop the images. In some cases, a portion (or all) of the background is removed and the object under question in the image is kept. The masking and/or cropping can improve the quality of the 3D model that will be created in the next step.

In some cases, a 3D model of each object is then created from the images of the object from different angles using photogrammetry (e.g., using Agisoft Metashape software). Photogrammetry is a tool by which one can create a virtual 3D model from a series of images taken at different angles.

Once the 3D models are created, then the synthetic images for the training data can be created from the 3D models (e.g., using 3D software, using 3D software developed for video games, and/or using Blender software). For example, a 3D model of an object can be used to create about 100, about 500, or from about 50 to about 1000, synthetic images from each of the 3D models. The synthetic images can be images of the object from many different angles, as might be seen in images taken by the actual optical inspection system during operation.

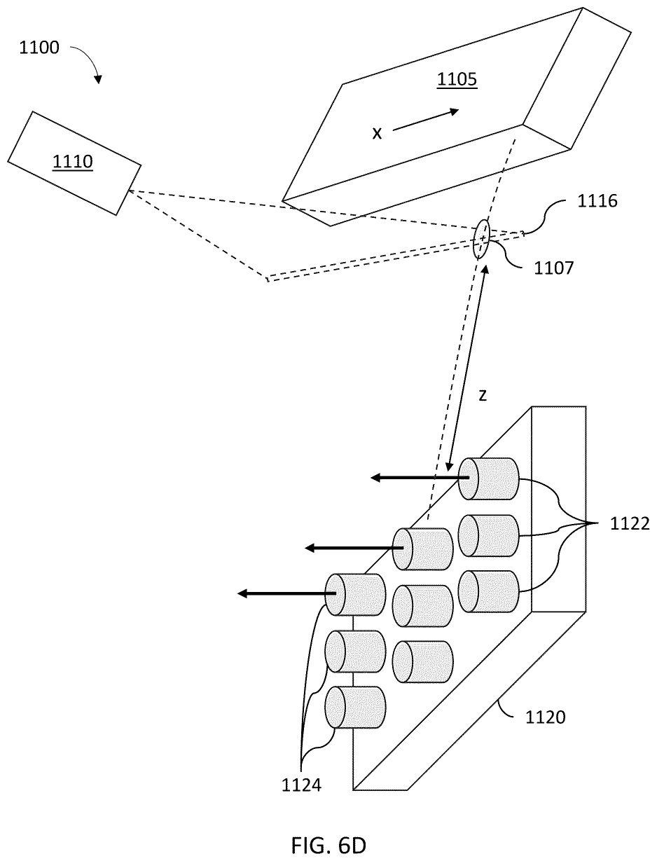

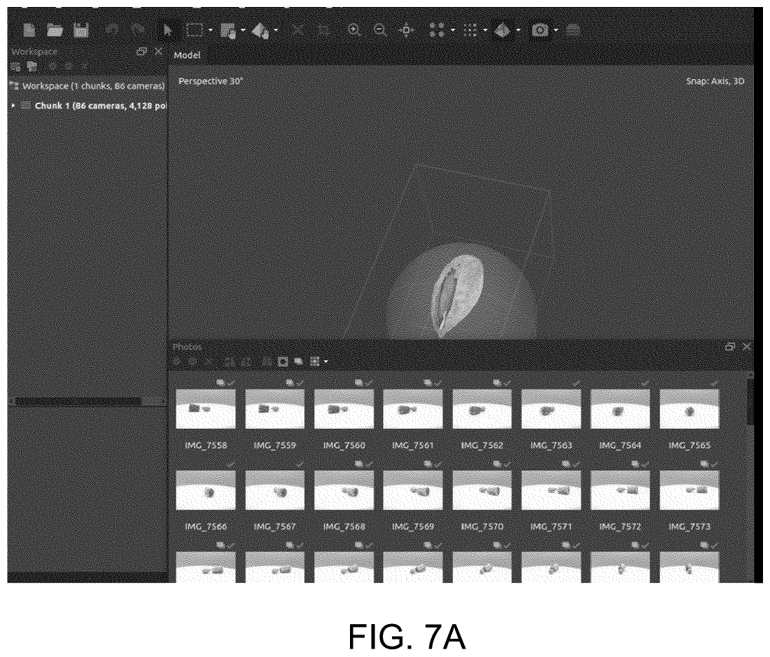

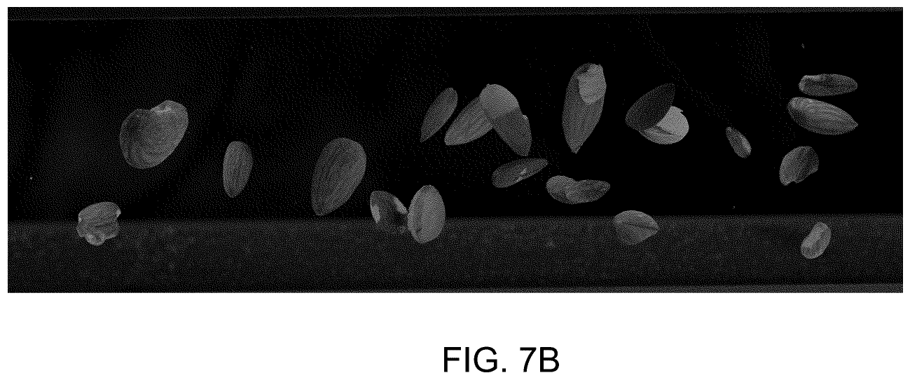

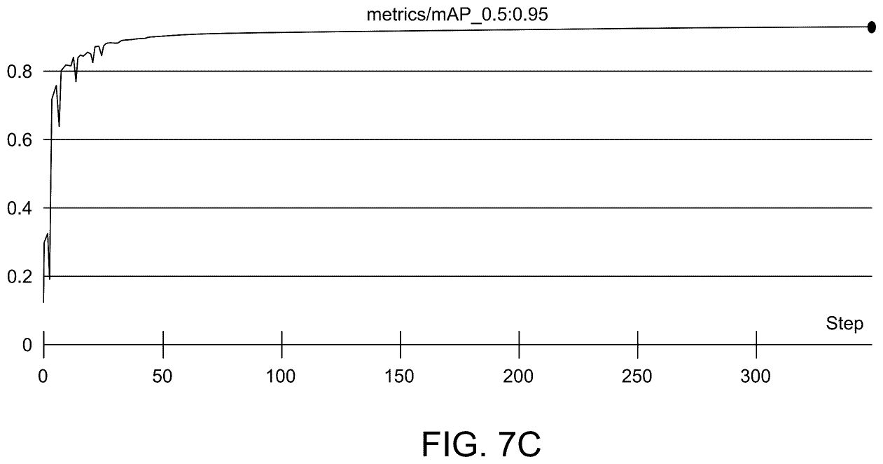

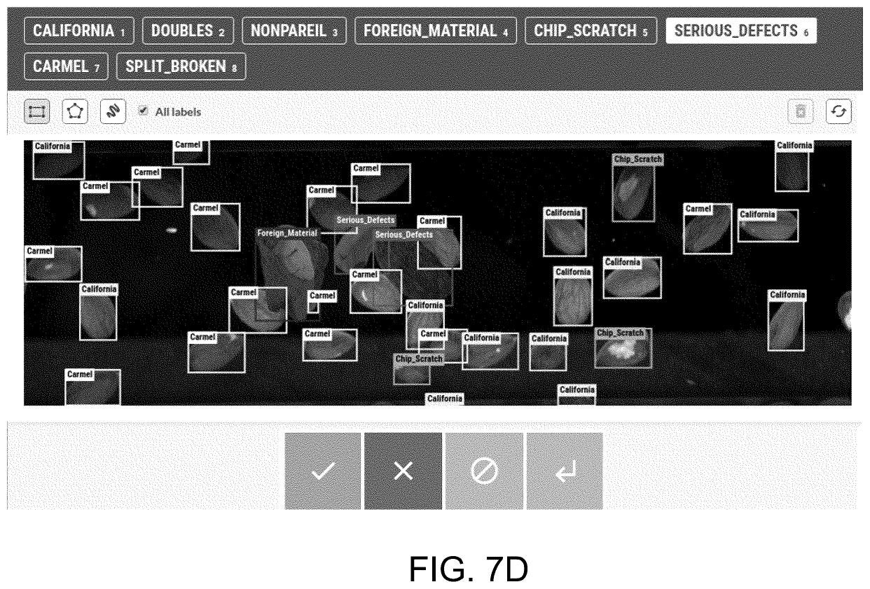

FIG. 7A shows an example of a 3D model of an object (an almond in this example) that was created using photogrammetry from images taken from many different angles. The 3D model was then used to create synthetic images of the object from different angles. FIG. 7B shows synthetic images of different objects (almonds in this example) from different angles that were generated using 3D gaming software (such as Blender or Unity from the 3D model generated using photogrammetry). Then, COCO tools can be used to create AI training data from the synthetic images (from the 3D gaming software). The created AI training data can include labels and bounding box information corresponding to the images that an AI training module can understand, which can save tens of days of person hours spent on annotation.

In some cases, the AI model used in the systems and methods described herein is trained using synthetic data (e.g., generated as described above). The AI model can be trained by 1) using synthetic data to train the AI model, 2) collecting actual data using an optical inspection system described herein (e.g., during actual operation) and manually classifying some additional output data, and 3) improving the AI model using the manually classified additional output data (i.e., using active learning).

FIG. 7C shows an example of training data from an AI model for inspecting, analyzing, and/or grading objects (almonds in this example). FIG. 7C is a chart that plots the mean average precision (mAP, on the y-axis) of the AI model over training iterations (or steps, on the x-axis). The AI model achieves a 0.928 mAP score after about 300 to 350 iterations (or steps) (as shown in FIG. 7C). A higher mAP indicates that the AI model is able to detect the objects more accurately when taking an average across a set of analyzed objects. For example, an mAP@[0.5:0.95] indicates an average score precision of a set of analyzed objects with intersection over union (IoU) scores (IoU scores are described further below) between 0.5 and 0.95.

Once the AI model is trained using the synthetic data, the actual system can be used to generate an additional set of images for re-training and/or validating the AI model using active learning. The additional collected images can be manually classified (and/or annotated), and the manually classified additional images can be used to re-train the AI model and improve the accuracy (e.g., to greater than 90%, or to about 95% accuracy). In some cases, there may be from about 10,000 to about 100,000 (or about 50,000) total training images, and about 10% (or from about 5% to about 20%) of the training images are those that have been manually annotated for use in active learning, or to validate and/or to re-train the AI model.

FIG. 7D shows an example of real images of objects (almonds in this example) taken by an actual optical inspection system, as described herein. Each of the images in FIG. 7D has been manually annotated by an operator to either validate or correct the output of the model trained using only synthetic data. An advantage of this approach is that the AI model trained using synthetic data can draw bounding boxes and labels (e.g., indicating the classification, grade, or type of an object). This eliminates the need for time-consuming manual bounding box drawing, and all that is required at this stage is to validate or correct erroneous labels (e.g., about 30% to 40% of the errors from the AI model trained using only synthetic data). This active learning process relies on some manual annotation, however, since some of the processes have already been done (e.g., bounding box drawing and initial labeling), the total person hours required to train the AI model using the present methods leveraging synthetic data is significantly reduced compared to that of an entirely manual annotation process to generate a set of training images. Using synthetic data to train the AI models described herein can save a significant amount of time compared to manually determining a classification for every training image. For example, it may take 20-30 person days of annotation work to manually classify 20,000 to 50,000 training images, while generating classified training images using synthetic data (e.g., generated using the above method) can take significantly less resources (e.g., about 3 to about 10, or about 3 to about 5, or about 5, or about 10 person days).

The optical inspection systems described herein can analyze images using an AI model and produce reports containing classifications and/or grading information for objects in the images. In some cases, active learning (or incremental learning) is used to re-train the AI model, wherein information in a report is manually modified (e.g., by an operator), and the modified data is sent to the AI model to re-train the AI model. The information in the report can be manually modified, for example, to regroup the information, and/or to change one or more labels associated with images or objects. In some cases, such active learning methods are performed on systems with storage systems and/or processors that are in the cloud. For example, the modified information can be saved to a storage system in the cloud, and a processor in the cloud can be configured to re-train the AI model, and then the re-trained AI model can be provided to one or more processors of the optical inspection system to be used to analyze images.

### PROCESSING IMAGES FROM A PAIR OF OPPOSING CAMERAS

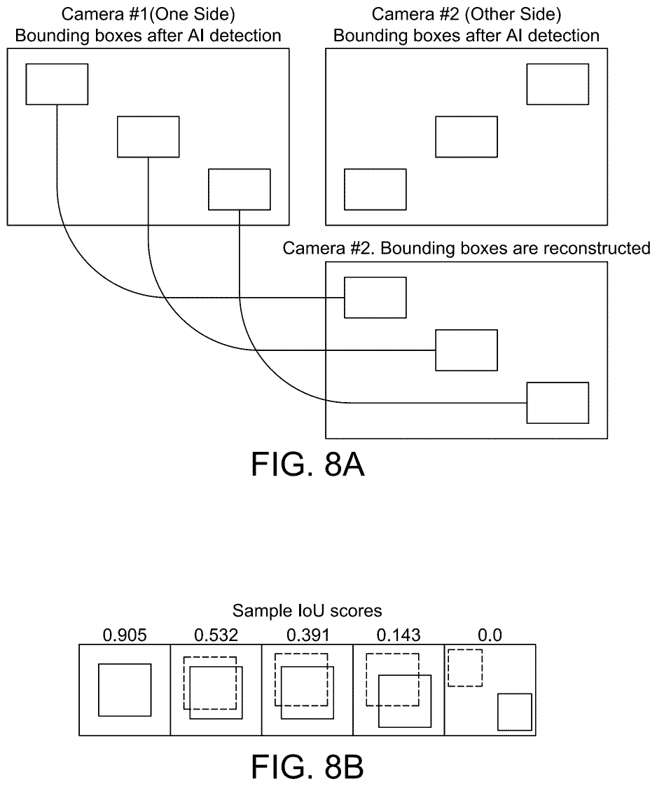

FIGS. 8A and 8B show an example of processing images from a pair of cameras, where one camera is positioned to take images of one side of an object and the other camera in the pair is positioned to take images of the other side of the object. This process can be used with the optical inspection systems and methods described herein, for example, as described with respect to the systems in FIGS. 1-5. FIG. 8A shows an image from a first camera (“Camera #1”) (oriented to capture images from a first side of an object) with three objects identified and surrounded with bounding boxes. Also shown is an image from a second camera (“Camera #2”) (oriented to capture images from a second side opposite to the first side of the object) with three objects identified and surrounded with bounding boxes. In an example, one side of a detected object has a good class or grade, but the other side is defective. Therefore, an image of the front of the object (from the first camera) and an image of the back of the object (from the second camera) can be associated together, and if either one of the sides is defective then the object can be graded as defective. To associate the detected object in two different images together, a mirror image of the bounding boxes in the image from the second side can be taken, as shown in FIG. 8A (“Camera #2: Bounding boxes are reconstructed”).

FIG. 8A shows an example where the image taken from the second camera are mirrored (i.e., reflected horizontally). After the bounding boxes in the image from the second camera are mirror reversed (as shown in FIG. 8A) then the image from the first camera and the mirror image of the image from the second camera can be superimposed, and an algorithm (e.g., a Hungarian algorithm, also known as Kuhn-Munkres algorithm) can be applied to pair (or associate) bounding boxes in both the first and the second (or the primary and the secondary) camera images. The algorithm can determine which pairs of images represent two sides of the same object. Once the images are paired (or associated), then a final grading can be assigned to each object.

FIG. 8B shows some examples of how the bounding boxes of objects may overlap once the mirror image is taken of the image from the second camera and is superimposed with the image from the first camera. The algorithm can determine an intersection over union (IoU) value. High IoU values (e.g., those greater than 0, or greater than 0.5) indicate that a bounding box has a high degree of overlap with another bounding box, which indicates a high likelihood that the bounding boxes are surrounding the same object. Low IoU values (e.g., those less than 0.5, or about 0) indicate that that a bounding box has a low degree of overlap with another bounding box, which indicates a low likelihood that the bounding boxes are surrounding the same object. Advantages of this IoU-based approach is that no image processing is required and a relatively simple algorithm for determining an IoU can yield accurate results. Similar IoU methods have been used for objects detected by autonomous vehicles, however, unlike situations encountered by a self-driving car where the bounding boxes are of the same object in different timestamps, in the case of the optical inspection systems with opposing cameras described herein, the objects in each bounding box pair can have different appearances since the images being analyzed are taken from opposite sides of the same object. Therefore, the IoU method is uniquely well-suited to the present systems and methods, since other approaches that use advanced image processing of the bounding box areas to compare the similarities may be less reliable at detecting different sides of the same object.

### CLOUD STORAGE

In some cases, previously generated reports and/or data from one or more of the systems described herein are archived automatically to a storage system in the cloud. For example, all reports and data (e.g., images, bounding box location, and/or grades) from systems of a single customer (or operator, or owner) can be centrally stored in a cloud storage (e.g., a cloud storage system from Microsoft, or Amazon Web Services). In some cases, an operator can access the reports and/or data in the cloud, and obtain relevant quality grading or inspection metrics. Using such systems and methods, an operator can be provided with information that is useful for them (e.g., for QC) without having any data science skills or other software (e.g., Jupyter) knowledge. In some cases, an operator can use their domain knowledge to review and (quickly and easily) add, remove, and/or edit the grades in reports and/or data in the cloud. In some cases, updated reports and/or data used for active learning (e.g., including revised grade and/or other label information added, removed or edited by the operator) can be automatically stored in a centralized cloud database. The new information may then trigger a new AI model training for one or more of the systems of the customer (or operator, or owner). Archived data in the cloud can also be used to show historical trends over time (e.g., hours, days, months, or years). In some cases, aggregate reports can be created from the reports and/or data in the cloud, for example, that combine data from multiple optical inspection systems (and/or lines, and/or facilities), or that contain data that has been filtered (e.g., by system, location, etc.).

### ADDITIONAL OPTICAL INSPECTION EMBODIMENTS

In some cases, the image inspection systems include one or more lighting and imaging assemblies that illuminate and capture images of moving objects. The captured images can be stored and analyzed in an image processing and storage system, which can include one or more processors and one or more storage devices, such as volatile memory systems. The image processing and storage system can be equivalent or similar to any of the systems described herein, for example those in FIGS. 1-5. In some cases, from about 1000 to about 10,000, or from about 1000 to about 100,000, or from about 1000 to about 1,000,000 objects can be imaged and analyzed per second using the systems and methods described herein.

The optical inspection systems and methods described herein can acquire images of (fast-moving) objects, and, using the image processing and storage system, optionally pre-process the images, analyze the images to determine a classification, categorize and/or grade the objects, optionally save the images and/or information generated from the analysis, and optionally generate reports based on the information generated from the analysis. Some examples of classifications (or classes, or categories, or grades) that the optical inspection systems and methods described herein can use are those related to quality (e.g., defective, non-defective), category (e.g., type-A, type-B), size (e.g., small, large), shape (e.g., round, square), color (e.g., white, black, uniform, non-uniform), or any other visual characteristic of the objects. The systems and methods described herein can utilize from about 3 to about 100, or from about 5 to about 50, or from about 5 to more than 100 predetermined classifications (e.g., classes, categories, or grades).

The lighting and imaging assemblies described herein can include one or more base structures coupling the lighting and imaging assemblies to a support structure, such as a larger frame of the optical inspection system, an external structure such as a wall, ceiling, beam, or a component or support structure of a piece of processing equipment (e.g., a conveyance system or processing equipment). The lighting and imaging assemblies can further include light support structures to couple lights to the bases, and one or more image capture device support structures to support one or more image capture devices. A benefit of the lighting and imaging assemblies described herein is that they can accommodate different length lights by moving the bases closer or farther from one another. For example, a longer light can be supported at each end by bases that are placed farther apart from one another, and a shorter light can be supported at each end by bases that are placed closer together. This can be advantageous to utilize lights that effectively illuminate an entire field of view of the one or more image capture devices of the lighting and imaging assemblies described herein. The width of the field of view of the image capture device(s) in the optical inspection systems and methods described herein can be from about 0.1 m to about 5 m, or from about 0.5 m to about 3 m, or from about 1 m to about 3 m, or greater than about 5 m, or less than about 0.1 m, or greater than about 5 m. The height of the field of view of the image capture device(s) in the optical inspection systems and methods described herein can be from about 0.1 m to about 2 m, or from about 0.5 m to about 1 m, or from about 0.1 m to about 0.5 m, or less than about 0.1 m, or greater than about 2 m.

In some cases, an ejector can be included in the system, which can eject one or more objects from the stream of moving objects in response to one or more analyzed images of the object(s). The systems and methods described herein can also be used as sorting systems and methods wherein one or more ejectors are used to divert objects from the moving stream of objects into one or more object collection bins in addition to one or more bins collecting objects that are not ejected. For example, defective objects can be detected and ejected using the systems and methods described herein. In another example, different grades (e.g., quality, weight, color) can be separated using the ejectors to direct objects into different bins in response to the analyzed images. In some cases, the image processing and storage system can analyze the captured images of the moving objects and send a signal to the ejector in a short amount of time (e.g., in less than about 100 ms, or less than about 35 ms, or less than about 10 ms). In some cases, the image processing and storage system can capture and analyze the images of the moving objects and send a signal to the ejector in a short amount of time (e.g., in less than 100 ms, or less than 35 ms, or less than 10 ms). In such cases, the image processing and storage system can be equivalent or similar to the systems in FIG. 3 or 5, which include first-stage volatile memory systems.

The optical inspection systems and methods described herein are capable of real-time sorting of large numbers of objects (e.g., from 1000 to a million objects per second, greater than a million objects per second). This presents a challenging problem since there can be a short amount of time between a first time when an object is in a field of view of an image capture device and a second time when the object is in position for an ejector to route the object to one or more different locations (i.e., an ejection position). For example, when the objects being imaged and ejected are in free-fall (e.g., after leaving a chute), then there can be less than about about 100 ms, less than about about 50 ms, less than about about 35 ms, or less than about about 20 ms between the first and second times. Objects in free-fall can move at speeds from about about 10 m/s to about about 50 m/s, or over about 50 m/s, depending on their physical properties such as mass, density, and/or shape. In cases where the image capture device field of view and the ejection position are about 1 m apart, the time allowed for capturing images, processing the images, and sending a signal to the ejector to eject an item based on the analyzed images is typically from about 100 ms to less than about 20 ms (e.g., about 35 ms). While increasing this distance would provide more time for analysis and signal transmission, it also increases the uncertainty in predicting a position of a moving object due to random drift. This presents a tradeoff between a larger distance, which reduces prediction accuracy but provides more processing time, versus a shorter distance, which decreases the available time but improves position prediction accuracy.

The optical inspection systems and methods described herein are capable of real-time inspection and sorting of moving objects. In some cases, the objects being imaged are on a moving conveyor, such as a conveyor belt, or moving set of bins. In some cases, objects can be dropped out of a chute and imaged in free-fall. The images can be analyzed using the image storage and processing system, and the analyzed images can indicate that a particular object is defective. Once an object is identified as defective, the predicted location of the object at a specific moment can be determined using the image storage and processing system based on its position during imaging. The predicted location can be in a position at which an ejector (e.g., an ejector of a set of ejectors) can eject the defective object, and the image storage and processing system can be used to send a signal to the ejector at the correct moment in time to eject the defective object. In cases where there is a large distance between the image capture device field of view and ejector positioning, such as greater than about 2 meters or greater than about 5 meters, the predicted position has a higher chance of being incorrect. This can result in signals being sent to the wrong ejector at the wrong time, potentially leading to errors.

The predicted location of the object can be determined based on a known location of the object at the time of imaging, and an estimated velocity (i.e., speed and direction) at the time of imaging. For example, the objects being imaged can be conveyed by a conveyor belt moving at a known speed, and the estimated velocity of the objects can be determined from the speed and the direction of movement of the conveyor belt. In some cases, the estimated velocity can be determined using equations of motion and the geometry of the system. For example, objects in free-fall accelerate towards the ground due to gravity, and a parabolic path of an object falling off a chute can be estimated based on a given initial velocity (e.g., a known or predetermined initial velocity) upon exiting the chute. In some cases, the position of the object at the time of imaging can be used together with equations of motion from the geometry of the system to estimate the velocity of the object. For example, if the object is imaged closer to the chute then then it can have a slower estimated speed than if the object were imaged farther from the chute, since it will have had less time to accelerate due to gravity. In other cases, the velocity can be estimated using two or more images to capture the object as it is falling. In such cases, two or more images can be captured at different times, and the differences in position and time between the images can be used to estimate the velocity of the object.

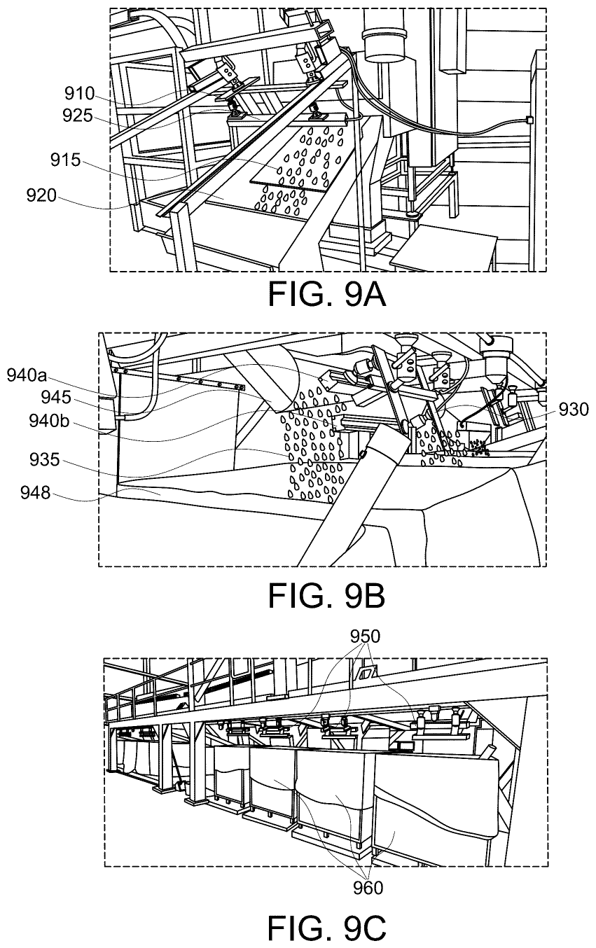

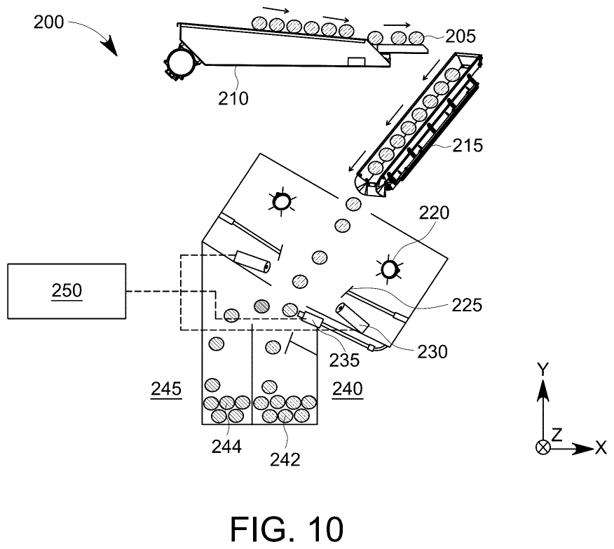

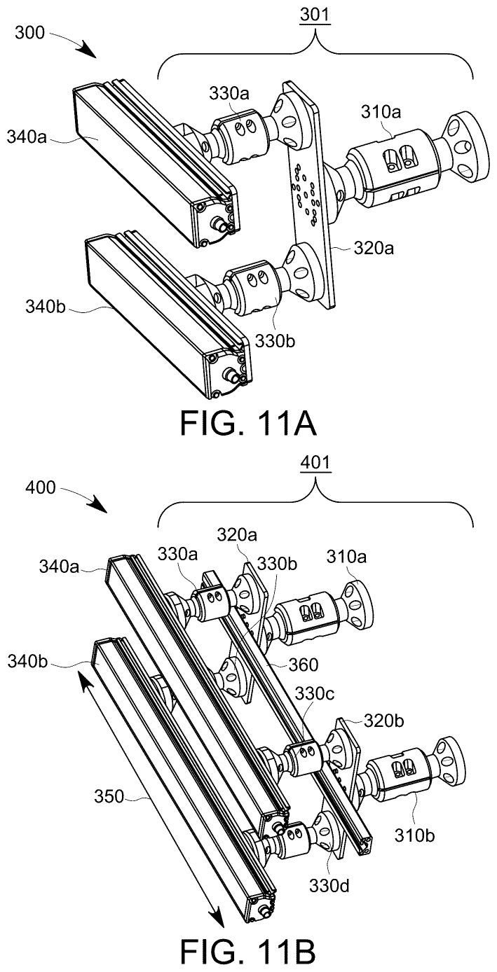

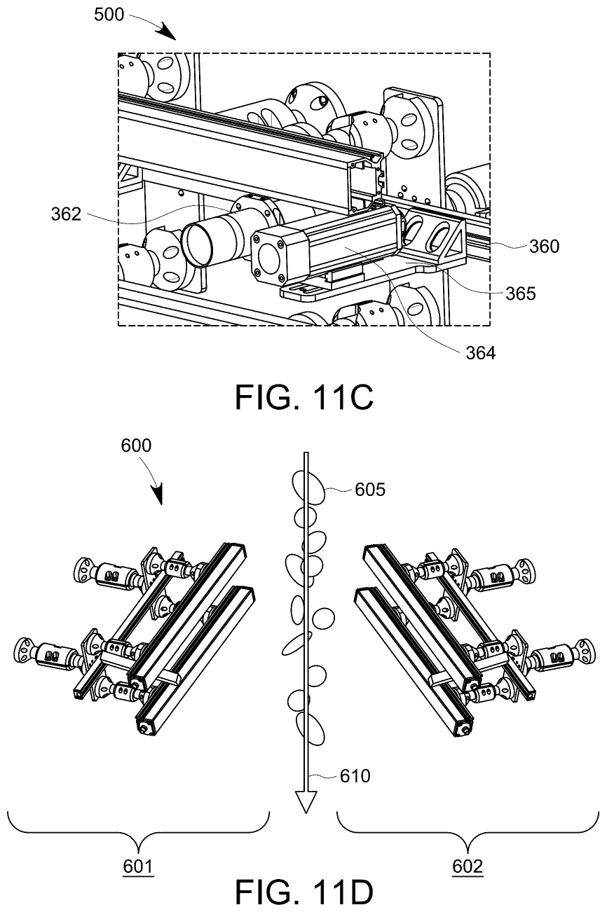

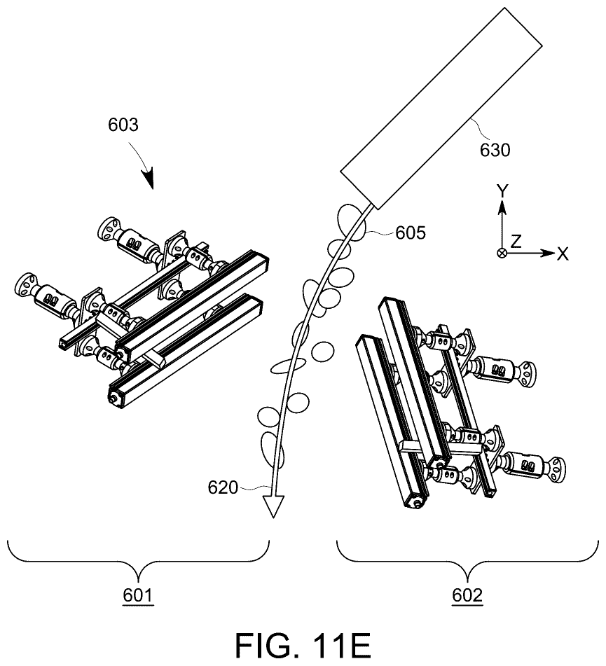

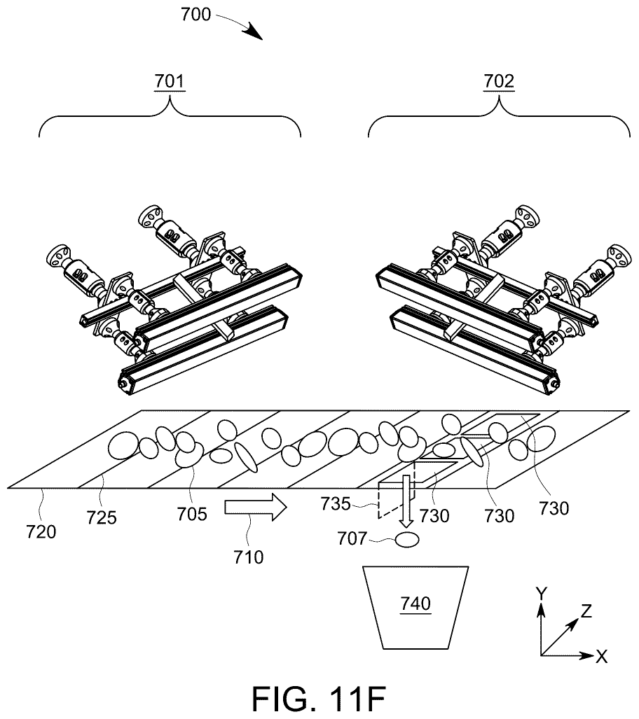

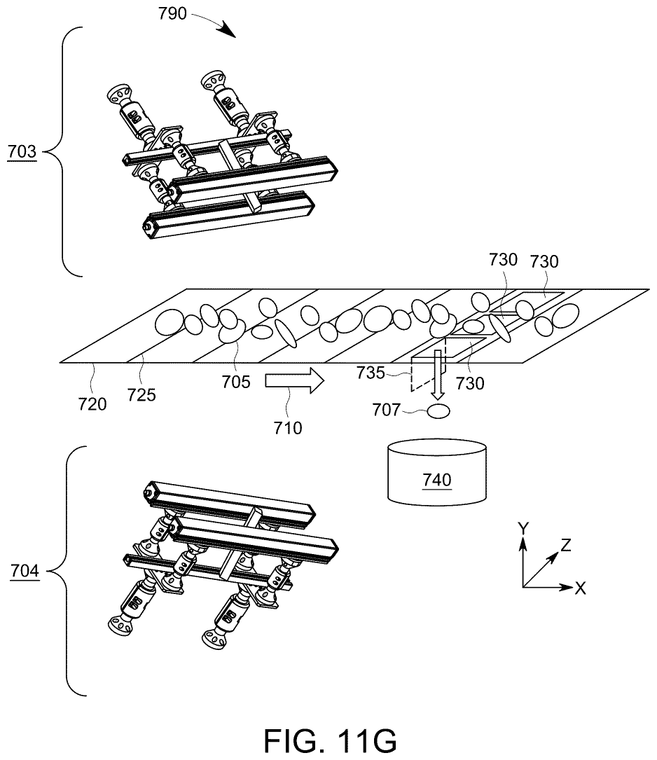

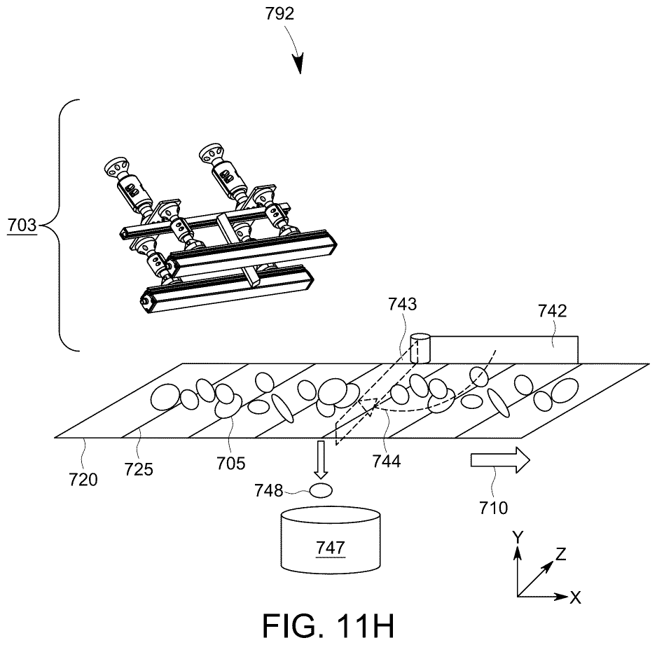

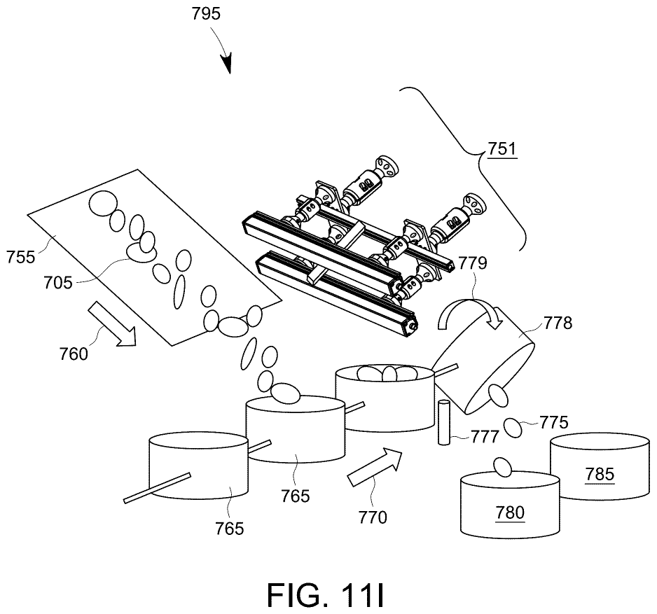

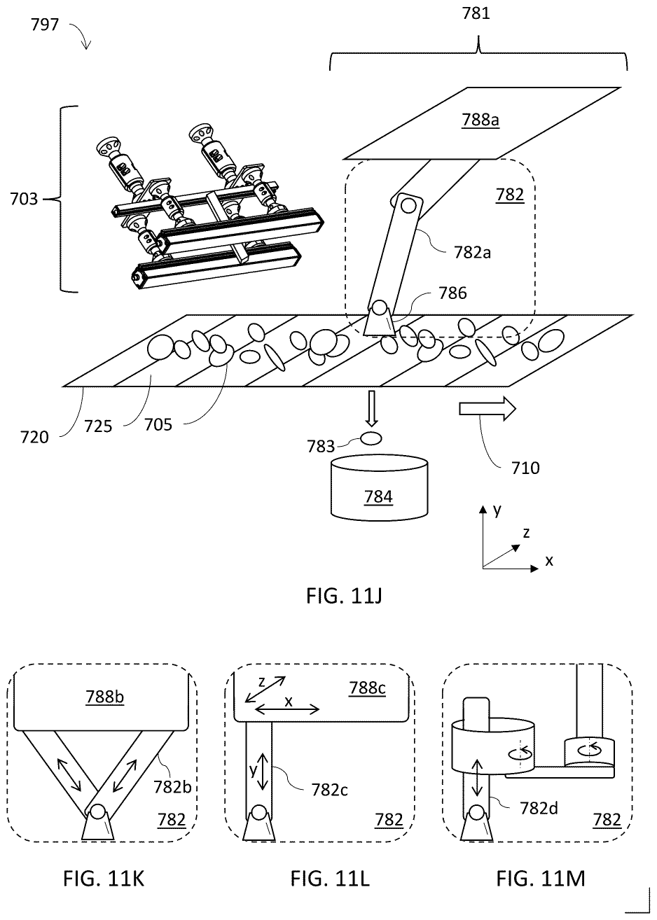

FIGS. 9A-9C show some examples of image inspection systems described herein. FIG. 9A includes a lighting and imaging assembly 910 that illuminates moving objects 915 using light 925 and captures images of moving objects 915 using an image capturing device coupled to lighting and imaging assembly 910. The lighting and imaging assembly 910 is positioned above chute 920 in this example. Chute 920 can be beneficial in some cases, since it can cause the moving objects to form a single layer such that objects are not occluding one another (or occlude one another less than they would when in free-fall without using a chute) while being imaged. Systems including lighting and imaging assemblies and chutes are described further below and in FIG. 10. Lighting and imaging assemblies similar to lighting and imaging assembly 910 are described further below and in FIGS. 11A-11C.

FIG. 9B includes a lighting and imaging assembly 930 that illuminates moving objects 935 using lights 940a, 940b and captures images of moving objects 935 using an image capturing device coupled to lighting and imaging assembly 930. The moving objects 935 are in free-fall in this example, having fallen out of chute 945. Chute 945 may also be referred to as a spout or a tray, in some cases. The moving objects 935 are collected in bin 948 after being imaged. Lighting and imaging assemblies similar to lighting and imaging assembly 930 are described further below and in FIGS. 11A-11C.

FIG. 9C shows an example of several lighting and imaging assemblies 950 (similar to lighting and imaging assemblies 910, 930 in FIGS. 9A and 9B) which are arranged in parallel. The image inspection system in this example also includes several bins 960 which are arranged in parallel. In this example, each lighting and imaging assembly 950 illuminates and captures images of moving objects that are being collected in a single bin 960. In general, one or more lighting and imaging assembly 950 can illuminate and capture images of moving objects that are then collected into one or more bins 960. For example, the image inspection system could be a sorting machine including means to direct the moving objects into different bins based on analyzed images captured using a single lighting and imaging assembly 950. In another example, multiple lighting and imaging assemblies 950 can be used to illuminate and capture images of moving objects that are being collected in a single bin 960. In some cases, a central computing system is coupled to and is used to store and process the images from multiple or all of the lighting and imaging assemblies 950. In other cases, each lighting and imaging assembly 950 is coupled to a separate computing system that is used to store and process the images from the lighting and imaging assembly 950 that it is coupled to.

FIG. 10 is a schematic of an example of an optical inspection system 200 described herein. Optical image inspection system 200 includes a chute 215, a set of lights 220, a background 225, image capture devices 230, an optional ejector 235, a first bin 240, a second bin 245, and an image processing and storage system 250.

The plurality of objects 205 is conveyed from a storage vessel 210 into the optical inspection system 200. For example, the storage vessel (e.g., a vibrating vessel) can be above the optical inspection system 200 as shown in FIG, 10, and the plurality of objects 205 can be dropped into the optical inspection system 200 using chute 215. Chute 215 can be beneficial in some cases, since it can cause the moving objects 205 to form a single layer such that objects 205 are not occluding one another (or occlude one another less than they would when in free-fall without using a chute) while being imaged. Additionally, a single object 205 can be ejected using ejector 235 more easily when there is a single layer of moving objects 205 due to the chute 215. In another example, a conveyor belt can be used to convey the plurality of objects 205 into the optical inspection system 200. Optical inspection systems using conveyor belts and optional ejectors are described further below.

The set of lights 220 are positioned to illuminate the plurality of objects 205 as they pass in between the background 225 and the image capture devices 230. The lights 220 can be any type of lights, such as LED lights, incandescent lights, or fluorescent lights. There are two image capture devices 230 in this example, one of each side of the stream of moving objects 205. In some cases, there can be one, two, four, or more than four image capture devices 230 in optical inspection system 200. The image capture devices 230 can be any devices capable of capturing a digital image, including digital cameras, charge-coupled device (CCD) cameras, and digital video recording devices (i.e., digital video cameras). In some cases, the image capture devices 230 are video recording devices that capture video, and still images are extracted from the captured video. In some cases, the image capture devices 230 can capture line scans, or area scans, and then move them through space to cover an entire field of view. For example, an image capture device 230 can capture about 35 line scans or area scans per second, or from about 10 to about 100 line scans or area scans per second, or more than 100 line scans or area scans per second. The ejector 235 is positioned to eject some of the plurality of objects 205 after they are imaged using the image capture devices 230. The ejectors 235 can include a set of air nozzles, in some cases, or can include mechanically actuated members used to divert a moving object. The objects 242 that are not ejected are collected in the first bin 240, and the objects 244 that are ejected by the ejector are collected in a second bin 245. In some cases, optical inspection system 200 further includes one or more scales (e.g., including one or more force sensors, balances, or load cells) for weighing the bins. For example, the first bin 240 and/or the second bin 245 can be positioned on top of a scale that can measure the weight of the objects in the first bin 240 and/or the second bin 245, respectively.

Image processing and storage system 250 is coupled to the image capture devices 230 and to the ejector 235. The image processing and storage system 250 can store and analyze images from the image capture devices 230, and send signals to the ejector 235 based on the analyzed images. For example, an analyzed image can indicate the presence of a defective object, and a signal can be sent to ejector 235 to eject the defective object. In another example, an analyzed image can classify an object, and a signal can be sent to ejector 235 to eject the object into the second bin 245 to sort objects into classes or categories. In some cases, the image processing and storage system 250 is any of the systems shown in FIGS. 1-5. In some cases, the image processing and storage system 250 can capture and analyze the images and send a signal to the ejector 235 in a short amount of time (e.g., in less than 100 ms, or less than 35 ms, or less than 10 ms). In such cases, the image processing and storage system 250 can be the systems in FIG. 3 or 5, which include first-stage volatile memory systems. When objects are in free-fall (e.g., having come out of a chute) then there can be a short time (e.g., less than 100 ms, or less than 50 ms) between the moments when the object is in the field of view of the image capture devices 230 and when it is aligned with the ejector 235. Therefore, optical inspection system 200 including image processing and storage system 250 that is capable of sending a signal to the ejector 235 in a short amount of time (e.g., in less than 100 ms, or less than 35 ms, or less than 10 ms) can be advantageous or required in some cases for optical inspection system 200 to operate as a real-time sorting system.

Optical inspection system 200 includes an ejector 235, however, in other cases, there can be from 1 to 10 ejectors, from 1 to 100 ejectors, or more than 100 ejectors. The ejectors can be arranged such that they eject moving objects from different regions of a moving or falling stream of objects. For example, the chute 215 can cause the objects 205 to form a single 2-dimensional layer (e.g., see FIG. 9A), and a row of ejectors 235 can be arranged in a line in the z-direction (into/out of the page) such that each ejector 235 can eject an object 205 from a different region along the z-direction.

Optical inspection system 200 includes two bins 240, 245, however, in other cases, there can be from 1 to 10 bins, from 1 to 100 bins, or more than 100 bins. For example, in cases where there is no ejector 235, then the optical inspection system 200 can inspect the moving objects 205 and collect them in a single bin 240. In other examples, several ejectors 235 can be included which are positioned to aim at the moving objects 205 from different angles, which are positioned to eject the moving objects into different bins (e.g., from 1 to 10 bins, or from 1 to 100 bins, or more than 100 bins). For example, the bins can be arranged in a line in front of the stream of objects, or in an arc where the stream of objects is approximately at the center of the arc.

FIGS. 11A-11D show examples of lighting and imaging assemblies which can be used in conjunction with any of the optical inspection systems described herein. The lighting and imaging assemblies shown in FIGS. 11A-11D can also be used in systems other than the optical inspection systems described herein.

FIG. 11A shows an example of a lighting assembly 300 of an optical inspection system including a mounting fixture 301 and lights 340a, 340b. The mounting fixture 301 includes a base structure 310a, an intermediate structure 320a, and light support structures 330a and 330b. The base structure 310a can be coupled to a rigid support such as a larger frame of the optical inspection system (not shown), or an external structure such as a wall, ceiling, beam, or a component or support structure of a piece of processing equipment (e.g., a conveyance system or processing equipment). The intermediate structure 320 is coupled to the base structure 310a and to light support structures 330a, 330b. The intermediate structure 320 can be longer or shorter than shown in FIG. 11A to support lights 340a, 340b with different spacings between them. Light support structure 330a is coupled to and supports light 340a, and light support structure 330b is coupled to and supports light 340b.

FIG. 11B shows an example of a lighting and imaging assembly 400 of an optical inspection system similar to the assembly 300 in FIG. 11A, and further including a second base structure 310b, a second intermediate structure 320b, and additional light support structures 330c and 330d. The lights 340a, 340b are longer than those shown in FIG. 11A and are supported in two locations in lighting and imaging assembly 400. The two base structures and corresponding additional light support structures are used to support the longer lights 340a, 340b. An advantage of lighting and imaging assembly 400 is that the base structures 310a, 310b can be mounted different distances apart to support lights 340a, 340b of different lengths 350. Length 350 can be from about 0.1 meters to about 5 meters, from about 0.2 meters to about 3 meters, or from about 0.5 meters to about 2 meters in different cases. For example, a field of view of an image capture device of the optical inspection system can be about 1 meter across, and the length 350 of the lights 340a, 340b can also be about 1 meter to illuminate the plurality of objects being imaged in the field of view, or in an area of space captured by the image. The base structures 310a, 310b can be mounted according to the length 350, about a meter apart in this example, in order to support the lights 340a, 340b. In another example, a field of view of an image capture device of the optical inspection system can be about 3 meters across, and the length 350 of the lights 340a, 340b can be about 3 meters to illuminate the plurality of objects being imaged in the field of view, or an area of space captured by the image. The base structures 310a, 310b can be mounted about 2.5 meters to about 3 meters apart in this example, in order to support the lights 340a, 340b. The adaptability of lighting and imaging assembly 400 allows it to support a pair of lights 340a, 340b of different lengths, which is enabled by the arrangement of the base, intermediate structures, and light support structures shown in FIG. 11B.

The lights 340a, 340b in the examples shown in FIGS. 11A-11D have high aspect ratios. In other examples, the assemblies in FIGS. 11A-11D can support lights with shapes such as round, circular, oval, ring shaped, rectangular, square, or cone shaped. The adaptability of lighting and imaging assembly 400 allows it to support lights of various sizes and shapes using the light support structures (e.g., light support structures 330a, 330b in FIG. 11A) coupled to base structures (e.g., base structures 310a, 310b in FIG. 11B) using intermediate structures (e.g., intermediate structures 320a, 320b in FIG. 11B). Intermediate structures (e.g., intermediate structures 320a, 320b in FIG. 11B) provide mechanical stability to the assemblies in FIGS. 11A-11D, for example, when coupling multiple (e.g., 2 or more) lights (e.g., of various sizes and/or shapes) to the base structures.

FIG. 11C shows an example of a lighting and imaging assembly 500 of an optical inspection system similar to the lighting and imaging assembly 400 in FIG. 11B, and further including a first image capture device 362, and an optional second image capture device 364, which are coupled to an optional secondary image capture device support structure 365, which is coupled to the image capture device support structure 360. In other cases, the first image capture device 362, and an optional second image capture device 364 can be coupled directly to the image capture device support structure 360. The first and the second image capture devices 362, 364 can be any devices capable of capturing a digital image, including digital cameras, charge-coupled device (CCD) cameras, and digital video recording devices (i.e., digital video cameras). In some cases, the first and the second image capture devices 362, 364 can be sensitive to different wavelengths of light (e.g., visible and IR), different light levels or intensities, and/or have different image capture settings (e.g., different shutter speeds). In some cases, one or both of the first and the second image capture devices 362, 364 can be event-based vision cameras (e.g., that only send data for pixels that change intensity compared to a previous frame or reference image).

FIG. 11D shows an example of a lighting and imaging assembly 600 of an optical inspection system similar to the lighting and imaging assembly 500 in FIG. 11C, and further including a first lighting and imaging assembly 601 and a second lighting and imaging assembly 602 arranged on different sides of a plurality of objects 605. In this case, the plurality of objects 605 being imaged are in free-fall and are moving in a direction 610 while being imaged by the lighting and imaging assemblies 601 and 602. FIG. 11D shows two lighting and imaging assemblies 601, 602. In some cases, there can be one or more lighting and imaging assemblies 601, 602 on the same side of the plurality of objects 605. For example, there can be just one lighting and imaging assemblies 601 on one side of the plurality of objects 605. In another example, there can be two lighting and imaging assemblies 601, 602 on the same side of the plurality of objects 605 (e.g., as shown in FIG. 9A). In another example, there can be two lighting and imaging assemblies 601, 602 on the same side of the plurality of objects 605 (e.g., as shown in FIG. 9A).

FIGS. 11E-11F show examples of portions of optical inspection systems including the lighting and imaging assemblies described herein, additionally showing a chute in FIG. 11E, and a conveyor in FIG. 11F.

FIG. 11E shows an example of a lighting and imaging assembly 603 of an optical inspection system similar to the lighting and imaging assembly 500 in FIG. 11D, and further including a chute 630. The system in this example includes a first lighting and imaging assembly 601 and a second lighting and imaging assembly 602 arranged on different sides of a plurality of objects 605 after leaving a chute 630. The plurality of objects 605 being imaged are falling in a direction 620 while being imaged by the lighting and imaging assemblies 601, 602. Direction 620 may not be vertical and may be somewhat curved due to the force of gravity acting on the objects 605 after they leave chute 630 which is at an angle with respect to the vertical y-direction. FIG. 11E shows two lighting and imaging assemblies 601, 602. In some cases, there can be one or more lighting and imaging assemblies 601, 602 on the same side of the plurality of objects 605. For example, there can be just one lighting and imaging assemblies 601 on one side of the plurality of objects 605. In another example, there can be two lighting and imaging assemblies 601, 602 on the same side of the plurality of objects 605 (e.g., as shown in FIG. 9A). In another example, there can be two lighting and imaging assemblies 601, 602 on the same side of the plurality of objects 605 (e.g., as shown in FIG. 9A).

FIG. 11F shows an example of a lighting and imaging assembly 700 of an optical inspection system similar to the lighting and imaging assembly 600 in FIG. 11D, however, in this example, the first lighting and imaging assembly 701 and second lighting and imaging assembly 702 are arranged on different sides of a plurality of objects 705 that are being conveyed in a direction 710 (the x-direction) using a conveyor 720 (e.g., a conveyor belt). FIG. 11F shows two lighting and imaging assemblies 701, 702. In some cases, there can be just one lighting and imaging assembly 701 or 702.

FIG. 11F also shows optional ejectors 730, which are trap doors in the conveyor 720 arranged over one or more bins 740. The ejectors 730 can include a trap door which can actuate to an open position 735 whereby one or more objects 707 can fall through the trap door and be collected in bin 740. For example, the conveyor 720 can include moving members 725 that move objects 705 in the direction 710 (the x-direction), and the objects 705 pass over ejectors 730 when closed and fall through ejector 730 when the trap door is in the open position 735. Three ejectors 730 are shown arranged in a line along the z-direction such that each ejector 730 can eject an object 705 from different regions along the z-direction of the conveyor 720. In some cases, bin 740 can be shaped like a trough such that the ejectors 730 cause object 705 to fall into bin 740 when opened. In some cases, ejectors can be arranged at different locations along the x-direction (not shown), and can cause an object 705 to fall into one or several different bins (not shown) using different ejectors, for example, based on one or more analyzed images of the object 705.

FIG. 11G shows an example of a lighting and imaging assembly 790 of an optical inspection system similar to the lighting and imaging assembly 700 in FIG. 11F, however, in this example, the first lighting and imaging assembly 703 and second lighting and imaging assembly 704 are arranged on different sides of a conveyor 720, which is moving a plurality of objects 705 in a direction 710 (the x-direction). For example, conveyor 720 can include moving buckets, or a conveyor belt, made from a transparent material, such as clear plastic or glass.

FIG. 11H shows an example of a lighting and imaging assembly 792 of an optical inspection system similar to the lighting and imaging assembly 790 in FIG. 11F. In this example, the lighting and imaging assembly 703 is arranged above conveyor 720, which is moving a plurality of objects 705 in a direction 710 (the x-direction). The ejector 742 in this example includes a bar or flipper which can actuate to position 743 by moving or rotating in direction 744. When the ejector 742 is actuated to position 743, one or more objects 748 can be directed to fall off conveyor 720 and be collected in bin 747, for example, based on one or more analyzed images of the object 705. In some cases, ejectors can be arranged at different locations along the x-direction (not shown), and can cause an object 705 to fall into one or several different bins (not shown) using different ejectors, for example, based on one or more analyzed images of the object 705.

FIG. 11I shows an example of a lighting and imaging assembly 795 of an optical inspection system similar to the lighting and imaging assembly 700 in FIG. 11F. In this example, lighting and imaging assembly 751 is arranged to illuminate and image a plurality of objects 705. For example, lighting and imaging assembly 751 can image objects 705 after they leave chute 755, which is moving the plurality of objects 705 in a direction 760. A set of containers 765 (e.g., trays or buckets) is arranged to receive objects 705. The set of containers can be moving (e.g., in a direction 770) such that one or more objects 705 are caught in different containers 765 as they move. An optional ejector mechanism 777 can flip a container 778 of the set of containers 765 in direction 779 in order to sort, dump, or transfer objects 775 from container 778 into sorting container 780, for example, based on one or more analyzed images of the object 705. For example, ejector mechanism 777 can be an air jet, or a linear actuator (e.g., an actuator rod) that pushes on one side of container 778 to flip it over. In some cases, there can be one or more sorting container 780, 785, and additional ejector mechanisms (not shown) can be used to flip a container 765 at the right location to sort objects into the additional sorting containers. In some cases, there can be more than two, from about two to about ten, or more than ten sorting containers. In some cases, there can be more than one lighting and imaging assembly (e.g., as shown in FIG. 11E) used in combination with the system shown in FIG. 11I.

FIGS. 11J-11M show examples of a lighting and imaging assembly 797 of an optical inspection system similar to the lighting and imaging assembly 792 in FIG. 11H. In this example, the lighting and imaging assembly 703 is arranged above conveyor 720, which is moving a plurality of objects 705 in a direction 710 (the x-direction). The ejector 781 in this example includes a pick and place sorting machine, which includes a moveable arm 782 (or robotic arm) that can grab or grip an object of the plurality of objects 705 using an end-effector 786 (e.g., a gripper, or end-of-arm tooling (EOAT)). The end-effector 786 can include vacuum cups, suction cups, mechanical claws, or other types of mechanical grippers.

Ejector 781 can contain a single moveable arm 782 or multiple moveable arms 782. FIGS. 11J-11M show some examples of robot arms 782. FIG. 11J shows robot arm 782 containing an articulated robot 782a connected to a base 788a and containing rotary joints that allow the robot arm 782 to move in the x-and z-directions (across the conveyor 720) and in the y-direction (up and down) to grip and then lift and move objects. FIG. 11K shows robot arm 782 containing a delta (i.e., parallel) robot 782b. The delta robot contains multiple arms 782b connected to a base 788b, where each arm can move such that the arm becomes longer or shorter, which allows the end-effector to move in the x-, y-and z-directions and tilt. Delta robots typically contain 3 to 5 arms, however, only two arms are shown in FIG. 11K for simplicity. FIG. 11L shows robot arm 782 containing a cartesian (i.e., gantry) robot 782c. The cartesian robot contains an arm 782c coupled to a base 788c that operates on three linear axes x-, y- and z-, which allows the end-effector to move in the x-, y- and z-directions to lift and move objects. FIG. 11J shows robot arm 782 containing a selective compliance assembly robot arms (SCARA) robot 782d. SCARA robots include two parallel rotary joints and a vertical linear motion, which allows the robot to move in the x-, y- and z-directions within a cylindrical or spherical-like working envelope (depending on the relative orientation of the rotary joints to one another).

Ejector 781 can be used with the systems and methods described herein. The ejector 781 can use the end-effector 786 to grab an object 783, then move the object 783 using the moveable arm 782 to place the object 783 into bin 784, for example, based on one or more analyzed images of the object 705. In some cases, the moveable arm 782 can move a grabbed object to different locations and can cause the object to fall into one or several different bins (not shown), for example, based on one or more analyzed images of the object 705.

### OPTICAL INSPECTION METHODS

Systems and methods for optical inspection systems for moving objects are described throughout the present disclosure. The optical inspection systems described herein (e.g., the systems shown in FIGS. 1-5) can be used to perform methods for optical inspection of moving objects.

In some embodiments, a method for optical inspection of moving objects includes the following steps. For example, the following method can be performed using the systems described in FIGS. 1, 2 and/or 4. A first image capturing device can acquire images of an object that is moving. A first first-stage storage system coupled to the first image capturing device can store images from the first image capturing device. A first second-stage processor coupled to the first first-stage storage system can analyze the images from the first image capturing device. A second image capturing device can acquire images from the object that is moving. A second first-stage storage system coupled to the second image capturing device can store images from the second image capturing device. A second second-stage processor coupled to the second first-stage storage system can analyze the images from the second image capturing device. A second-stage storage system coupled to the first and second second-stage processor can store images and/or information from the first and second second-stage processors. A third-stage processor coupled to the second-stage storage system can process information from the second-stage processor and second-stage storage system and produce a report. A third-stage storage system coupled to the third-stage processor can store images and information from the third-stage processor.

In some embodiments, a method for optical inspection of moving objects includes the following steps. For example, the following method can be performed using the systems described in FIGS. 1, 3 and/or 5. A first image capturing device can acquire images of an object that is moving. A first volatile memory system coupled to the first image capturing device can store images from the first image capturing device. A first second-stage processor coupled to the first volatile memory system can analyze the images from the first image capturing device. A second image capturing device can acquire images from the object that is moving. A second volatile memory system coupled to the second image capturing device can store images from the second image capturing device. A second second-stage processor coupled to the second volatile memory system can analyze the images from the second image capturing device. A third second-stage processor coupled to the first and second second-stage processors can process information from the first and second second-stage processors. A third-stage storage system coupled to the third second-stage processor can store images and information from the third second-stage processor. The third second-stage processor can produce a report using the images and information stored in the third-stage storage system.

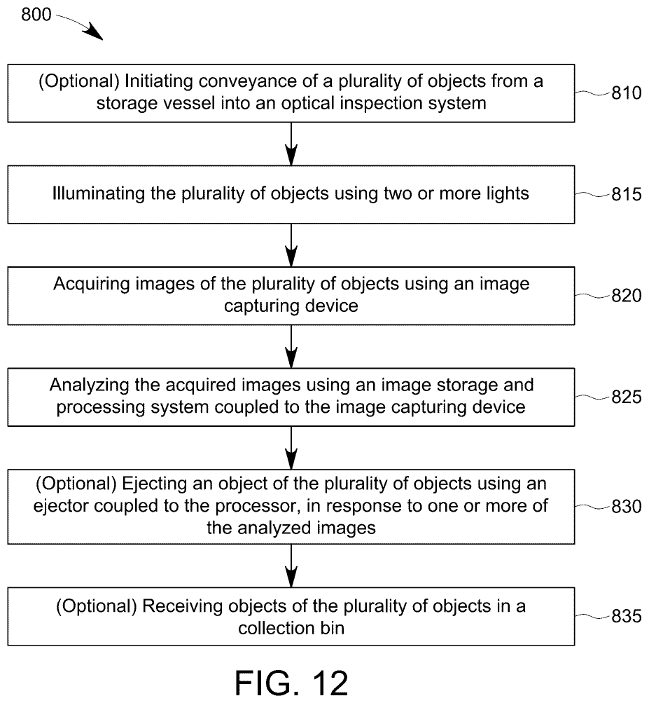

FIG. 12 shows a flowchart of an example of a method 800 for inspecting or sorting objects. For example, the following method can be performed using the systems described in FIGS. 9A-11F. In optional step 810, conveyance of a plurality of objects is initiated from a storage vessel into an optical inspection system. For example, a chute or a conveyor system coupled to a vessel containing the objects can be used to move the objects into the optical inspection system. In step 815, causing the plurality of objects to be illuminated using two or more lights. In step 820, acquiring images of the plurality of objects using an image capturing device. In step 825, analyzing the acquired images using an image storage and processing system coupled to the image capturing device. In optional step 830, causing ejection an object of the plurality of objects using an ejector coupled to the processor, in response to one or more of the analyzed images. In optional step 835, objects of the plurality of objects are received in a collection bin. In cases including optional step 830, in step 835 the objects of the plurality of objects that are not ejected by the set of ejectors are received in a first bin, and the object of the plurality of objects that is ejected by the set of ejectors is received in a second bin.

In some cases of method 800, the image capturing device captures the images of the plurality of objects in step 820 as the plurality of objects are in free fall (e.g., having exited a chute, or having been dropped from a vessel), or as the plurality of objects are moving on a conveyor.

In some cases of method 800, the image capturing device captures the images of the plurality of objects in step 820 in instances where the rate of the conveyance of the objects from the storage vessel into the optical inspection system is from about 100 to over a million objects per second. In some cases, from about 1000 to about 10,000, from about 1000 to about 100,000, from about 1000 to about a million, more than 10,000, more than 100,000, or more than a million objects, can be analyzed per second in step 825. In some cases, from about 1000 to about 10,000, from about 1000 to about 100,000, from about 1000 to about a million, more than 10,000, more than 100,000, or more than a million objects, can be imaged and analyzed per second in steps 820 and 825.

In some cases of method 800, the analyzing the acquired images in step 825 further includes: storing images from the image capturing device using a volatile memory system coupled to the image capturing device; analyzing the images using a second-stage processor coupled to the volatile memory system; and storing images and information from the second-stage processor using a third-stage storage system coupled to the second-stage processor. Additionally, the second-stage processor can generate a report using the images and information stored in the third-stage storage system.

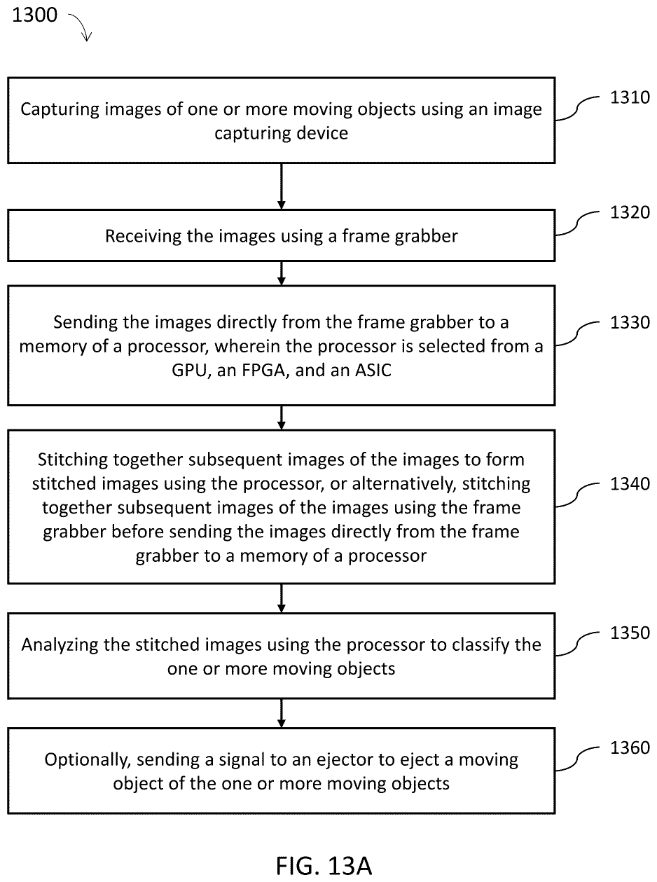

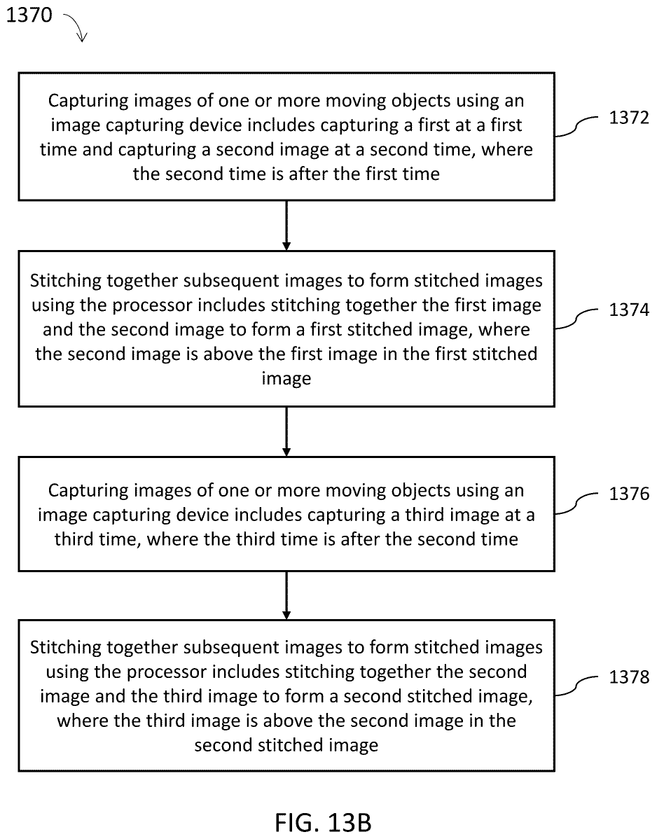

FIG. 13A is a flowchart of an example method 1300 for sorting moving objects. At block 1310, images of one or more moving objects are captured using an image capturing device. For example, block 1310 can be performed using image capture processing block 560 of system 550 in FIG. 5A. At block 1320, images are received using a frame grabber. For example, block 1320 can be performed using frame grabber processing block 562 of system 550 in FIG. 5A. At block 1330, the images are sent directly from the frame grabber to a memory of a processor (e.g., a GPU, an FPGA, and an ASIC). For example, block 1330 can be performed using processor memory processing block 564 of system 550 in FIG. 5A. At block 1340, subsequent images of the images are stitched together to form stitched images using the processor. For example, block 1340 can be performed using image stitching processing block 566 of system 550 in FIG. 5A. Alternatively, subsequent images of the images are stitched together using the frame grabber in block 1320 before sending the images directly from the frame grabber to a memory of a processor. In such cases, the stitching can be performed using frame grabber processing block 562 of system 550 in FIG. 5A. At block 1350, the stitched images are analyzed using the processor to classify the one or more moving objects. For example, block 1350 can be performed using preprocessing processing block 568 and/or model inference processing block 570 of system 550 in FIG. 5A. At optional block 1360, a signal or command or trigger is sent to an ejector to eject a moving object of the one or more moving objects. For example, optional block 1360 can be performed using hardware timer processing block 576 and/or ejection system processing block 578 of system 550 in FIG. 5A.

FIG. 13B is a flowchart of an example method 1370 for sorting moving objects, which can optionally be performed together with method 1300. The method 1370 in FIG. 13B shows a similar sequence of blocks as depicted in the example shown in FIGS. 5E-5H. At block 1372, the capturing images of one or more moving objects using an image capturing device (e.g., in block 1320 of FIG. 13A) further includes capturing a first image at a first time and capturing a second image at a second time, wherein the second time is after the first time. The first image and the second image are images that are received by the frame grabber in block 1320 of method 1300. At block 1374, the stitching together subsequent images to form stitched images using the processor (e.g., in block 1340 of FIG. 13A) further includes stitching together the first image and the second image to form a first stitched image, where the second image is above the first image in the first stitched image. Some examples of resulting stitched images, where a subsequent image is above a previous image, are shown in FIGS. 5G-5I.

At block 1376 of method 1370, the capturing images of one or more moving objects using an image capturing device (e.g., in block 1320 of FIG. 13A) further includes capturing a third image at a third time, where the third time is after the second time. The third image is an image that is received by the frame grabber in block 1320 of method 1300. At block 1378, the stitching together subsequent images to form stitched images using the processor (e.g., in block 1340 of FIG. 13A) further includes stitching together the second image and the third image to form a second stitched image, where the third image is above the second image in the second stitched image.

The systems and methods described herein that send lines or frames from the image capturing devices directly to the processor (e.g., GPU, FPGA, or ASIC) use frame grabbers. A frame grabber is a specialized piece of hardware, which can take the form of a PCIe card, embedded module, or external device, and serves as the interface between a high-speed camera and the host computer. Its primary role is to reliably capture image data streams from cameras (e.g., using interfaces such as Camera Link, CoaXPress, or high-speed GigE Vision) and transfer those pixels into system memory or directly into a GPU for processing.

In practice, the process begins with the camera producing a continuous high-bandwidth video or image stream. In some cases, the image stream can include hundreds or thousands of frames per second at multi-megapixel resolutions. The frame grabber then receives this raw data over the selected camera interface protocol (e.g., Camera Link, CoaXPress, or 10GigE). Once received, the frame grabber can handle the data by performing protocol management, for example, unpacking the transmission format, error correction, and timing. It may also provide additional functions such as buffering, triggering, or preprocessing, which can involve operations like region-of-interest extraction, image formatting, or Bayer decoding. Frame grabbers can also be equipped with DMA capability, allowing them to write image data directly into system memory without requiring the CPU to shuttle it.

In some cases, frame grabbers can take advantage of APIs (e.g., NVIDIA GPUDirect®) or equivalent APIs to extend DMA beyond system RAM and write directly into GPU memory across the PCIe bus. This bypasses the CPU and avoids unnecessary memory copies, ensuring that the captured frame arrives in GPU memory ready for immediate processing.

The functionality of frame grabbers is beneficial for high-speed machine vision applications such as inspection and sorting, where low-latency and high-bandwidth capture are essential. A frame grabber can prevent frames from being dropped and can minimize latency by preventing data from bouncing through the CPU and RAM. Frame grabbers capture the raw data stream from the camera, decode it, and then, using DMA or RDMA (Remote DMA, an extension of DMA that allows one computer to directly access the memory of another computer over a network), push the data directly into GPU memory over PCIe, enabling real-time image processing without CPU bottlenecks.

In some cases, the systems and methods described herein use line-scan image capturing devices (i.e., line-scan cameras). Line-scan cameras differ from area-scan cameras in that they only capture one line of pixels at a time, similar to a single row from an area camera. To build a complete two-dimensional image, many of these individual lines must be stacked or stitched together as the object moves, whether on a conveyor belt, rotating drum, or in free-fall. Precise synchronization with encoders or motion controllers can be used so that each captured line corresponds to the correct physical position. In other cases, such as when objects are in free-fall, the speed of the object is known, and the rate of line-scan capture can be preprogrammed. For objects in free-fall, the line-scan camera can take images at a fixed line rate (lines per second) since the physics of free-fall provides a predictable acceleration profile. In some cases, the line rate (and exposure time) can be tuned so that the vertical stretching or compression of the object in the reconstructed image is minimized.

The stitching of the lines from a line-scan camera into a full image can happen in different system components or processing blocks, depending on the system design. In some cases, the stitching can be done directly in the frame grabber. The frame grabber can include on-board logic (e.g., FPGA logic) that can be used to assemble the incoming stream of lines into a complete two-dimensional image in real time. By using encoder signals or external triggers, or programmed timing, the frame grabber can determine when to add a new line and produce a fully stitched image that it can deliver to system memory or directly to a processor (e.g., GPU, FPGA, or ASIC) using DMA. This method offers very low latency, reduces CPU and GPU workload, and ensures reliable synchronization, though it offers less flexibility if custom stitching logic is required.

Alternatively, the stitching can be performed in software on the processor (e.g., GPU, FPGA, or ASIC). In this setup, the frame grabber can transfer lines (e.g., the raw line buffers, or preprocessed line data) into system RAM or GPU memory via DMA, leaving the software to assemble the lines into an image. This approach is valuable when custom processing, for example, to stitch images together that overlap in space and time as described herein, for example in FIGS. 5G-5I. In other cases, stitching can be performed in software on the processor to account for unusual image geometries. An advantage of stitching the images in the GPU is that it provides maximum flexibility, and processor (e.g., GPU) memory transfer techniques using DMA can be used to keep the latency short.

In some cases, the systems and methods described herein can use a hybrid approach, in which the frame grabber performs a first stitching operation to partially assemble the data, and the processor (e.g., GPU, FPGA, or ASIC) performs a second stitching to further assemble the data. For example, the frame grabber can stitch line-scanned lines together into frames (e.g., frame 531, 532, and 534 in FIG. 5I) and the processor can stitch the frames together to form a double stitched image, for example, as stitched frames 531 and 532 are stitched together to form double stitched image 533 in FIG. 5I. In some cases, the frame grabber can perform a first stitching to partially assemble the data, such as, tile stitching or strip stitching, before handing off intermediate buffers to the processor (e.g., GPU, FPGA, or ASIC) for final assembly or corrections.

The embodiments and components of the optical inspection systems described herein (e.g., those related to the systems shown in FIGS. 1-5 and 9A-11F) can be used to perform one or more of the methods for optical inspection of moving objects described above.

CLAUSES

Clause 1. An optical inspection system, comprising: an image capturing device configured to acquire images of an object that is moving; a first-stage frame grabber coupled to the image capturing device and configured to receive the images from the image capturing device; a second-stage processor coupled to the first-stage frame grabber and configured to analyze the images from the first-stage frame grabber, wherein the first-stage frame grabber is configured to send the images directly to a memory of the second-stage processor; a second-stage storage system coupled to the second-stage processor and configured to store images and information from the second-stage processor; a third-stage processor coupled to the second-stage storage system and configured to process information from the second-stage processor and second-stage storage system and produce a report; and a third-stage storage system coupled to the third-stage processor and configured to store images and information from the third-stage processor.

Clause 2. The optical inspection system of clause 1, wherein the image capturing device is compatible with direct memory access (DMA), and is selected from: a digital camera, charge-coupled device (CCD) camera, or digital video camera.

Clause 3. The optical inspection system of clause 1, wherein the second-stage processor is a graphics processing unit (GPU), a field-programmable gate array (FPGA), or an application-specific integrated circuit (ASIC).

Clause 4. The optical inspection system of clause 1, wherein the second-stage processor is configured to analyze the images from the image capturing device using an artificial intelligence model.

Clause 5. The optical inspection system of clause 4, wherein the second-stage processor is further configured to analyze the images using the artificial intelligence model to add bounding boxes to the images and classify the images according to predetermined classes.

Clause 6. The optical inspection system of clause 4, wherein the artificial intelligence model is trained using synthetic data that was generated using photogrammetry.

Clause 7. The optical inspection system of clause 4, wherein information in the report is manually modified to produce a modified report, and the modified report is used to re-train the artificial intelligence model using active learning.

Clause 8. The optical inspection system of clause 1, wherein the second-stage storage system comprises a write optimized pseudo database, or an embeddable key-value store database.

Clause 9. The optical inspection system of clause 1, wherein the third-stage processor is a central processing unit (CPU) or a field-programmable gate array (FPGA).

Clause 10. The optical inspection system of clause 1, wherein the third-stage storage system comprises a DRAM system, an SSD system, or other type of persistent memory system.

Clause 11. The optical inspection system of clause 1, wherein the third-stage storage system comprises a relational database.

Clause 12. The optical inspection system of clause 1, wherein one or more of the second-stage processor, second-stage storage system, third-stage processor, and the third-stage storage system are located in the cloud.

Clause 13. An optical inspection system, comprising: an image capturing device configured to acquire images of an object that is moving; a first-stage frame grabber coupled to the image capturing device and configured to receive the images from the image capturing device, wherein the first-stage frame grabber is configured to send the images directly to a memory of the first second-stage processor; a first second-stage processor coupled to the first-stage frame grabber and configured to analyze the images from the first-stage frame grabber; a second second-stage processor coupled to the first second-stage processor and configured to process information from the first second-stage processor; and a third-stage storage system coupled to the second second-stage processor and configured to store images and information from the second second-stage processor, wherein the second second-stage processor is configured to produce a report using the images and information stored in the third-stage storage system.

Clause 14. The optical inspection system of clause 13, wherein the image capturing device is compatible with direct memory access (DMA), and is selected from: a digital camera, charge-coupled device (CCD) camera, or digital video camera.

Clause 15. The optical inspection system of clause 13, wherein the first second-stage processor is a graphics processing unit (GPU), a field-programmable gate array (FPGA), or an application-specific integrated circuit (ASIC).

Clause 16. The optical inspection system of clause 13, wherein the first second-stage processor is configured to analyze the images from the image capturing device using an artificial intelligence model.

Clause 17. The optical inspection system of clause 16, wherein the first second-stage processor analyzes the images using the artificial intelligence model to add bounding boxes to the images and classify the images according to predetermined classes.

Clause 18. The optical inspection system of clause 16, wherein the artificial intelligence model is trained using synthetic data that was generated using photogrammetry.

Clause 19. The optical inspection system of clause 16, wherein information in the report is manually modified to produce a modified report, and the modified report is used to re-train the artificial intelligence model using active learning.

Clause 20. The optical inspection system of clause 13, wherein the second second-stage processor is a central processing unit (CPU) or a field-programmable gate array (FPGA).

Clause 21. The optical inspection system of clause 13, wherein the third-stage storage system comprises a DRAM system, an SSD system, or other type of persistent memory system.

Clause 22. The optical inspection system of clause 13, further comprising an ejector or a robotic arm coupled to the second second-stage processor and configured to eject or remove the object when the second second-stage processor indicates that the object is defective.

Clause 23. The optical inspection system of clause 13, wherein one or more of the first second-stage processor, the second second-stage processor, and the third-stage storage system are located in the cloud.

Clause 24. A method of sorting moving objects, comprising: capturing images of one or more moving objects using an image capturing device; receiving the images using a frame grabber; sending the images directly from the frame grabber to a memory of a processor, wherein the processor is selected from a GPU, an FPGA, and an ASIC; stitching together subsequent images of the images to form stitched images using the processor, or alternatively, stitching together subsequent images of the images using the frame grabber before sending the images directly from the frame grabber to a memory of a processor; analyzing the stitched images using the processor to classify the one or more moving objects.

Clause 25. The method of clause 24, further comprising sending a signal to an ejector to eject a moving object of the one or more moving objects.

Clause 26. The method of clause 24, wherein the image capturing device is a PCI or PCIe device that is compatible with direct memory access (DMA).

Clause 27. The method of clause 24, wherein: capturing images of one or more moving objects using an image capturing device further comprises capturing a first image of the images at a first time and capturing a second image of the images at a second time, wherein the second time is after the first time; and stitching together subsequent images to form stitched images using the processor further comprises stitching together the first image and the second image to form a first stitched image of the stitched images, wherein the second image is above the first image in the first stitched image.

Clause 28. The method of clause 27, wherein: capturing images of one or more moving objects using an image capturing device further comprises capturing a third image of the images at a third time, wherein the third time is after the second time; and stitching together subsequent images to form stitched images using the processor further comprises stitching together the second image and the third image to form a second stitched image of the stitched images, wherein the third image is above the second image in the second stitched image.

Clause 29. The method of clause 28, wherein parallel processing is used such that stitching together the first image and the second image to form the first stitched image of the stitched images overlaps in time with the third time.

Clause 30. The method of clause 24, wherein: capturing images of one or more moving objects using an image capturing device further comprises capturing line-scan images of the one or more moving objects; receiving the images using a frame grabber further comprises receiving the line-scan images using a frame grabber one line at a time; sending the images directly from the frame grabber to the memory of the processor further comprises sending the line-scan images from the frame grabber to the memory of the processor one line at a time; stitching together subsequent images of the images to form stitched images using the processor further comprises stitching together subsequent line-scan images of the line-scan images to form stitched line-scan images using the processor.

Clause 31. The method of clause 24, wherein: capturing images of one or more moving objects using an image capturing device further comprises capturing line-scan images of the one or more moving objects; receiving the images using a frame grabber further comprises receiving the line-scan images using a frame grabber one line at a time; stitching together subsequent images of the images using the frame grabber further comprises stitching together subsequent line-scan images of the line-scan images to form stitched line-scan images using the frame grabber; sending the images directly from the frame grabber to the memory of the processor further comprises sending the stitched line-scan images from the frame grabber to the memory of the processor.

Clause 32. The method of clause 31, further comprising stitching together two or more of the stitched line-scan images using the processor to form double-stitched line-scan images.

Embodiments of the disclosed invention have been referenced in detail, and one or more examples of the disclosed invention have also been illustrated in the accompanying figures. Each of the embodiments and examples herein have been provided to explain the present technology, not as limitations of the present technology. Furthermore, while particular embodiments of the invention have been described in detail, it will be appreciated that alterations to, variations of, and equivalents to these embodiments may be readily conceived of by those skilled in the art, upon attaining an understanding of the foregoing. For instance, features illustrated or described with respect to one embodiment may be used with another embodiment to yield an additional embodiment. It is intended that the present subject matter covers all such modifications and variations within the scope of the appended claims and their equivalents. Those of ordinary skill in the art may practice these and other modifications and variations to the present invention without departing from the scope of the present invention, which is more particularly set forth in the appended claims. Furthermore, the foregoing description is by way of example only, and is not intended to limit the invention, as will be appreciated by those of ordinary skill in the art.

What is claimed is:

1. An optical inspection system, comprising:
an image capturing device configured to acquire images of an object that is moving;
a first-stage frame grabber coupled to the image capturing device and configured to receive the images from the image capturing device;
a second-stage processor coupled to the first-stage frame grabber and configured to analyze the images from the first-stage frame grabber, wherein the first-stage frame grabber is configured to send the images directly to a memory of the second-stage processor;
a second-stage storage system coupled to the second-stage processor and configured to store images and information from the second-stage processor;
a third-stage processor coupled to the second-stage storage system and configured to process information from the second-stage processor and second-stage storage system and produce a report; and
a third-stage storage system coupled to the third-stage processor and configured to store images and information from the third-stage processor.

2. The optical inspection system of claim 1, wherein the image capturing device is compatible with direct memory access (DMA), and is selected from: a digital camera, charge-coupled device (CCD) camera, or digital video camera.

3. The optical inspection system of claim 1, wherein the second-stage processor is a graphics processing unit (GPU), a field-programmable gate array (FPGA), or an application-specific integrated circuit (ASIC).

4. The optical inspection system of claim 1, wherein the second-stage processor is configured to analyze the images from the image capturing device using an artificial intelligence model.

5. The optical inspection system of claim 4, wherein the second-stage processor is further configured to analyze the images using the artificial intelligence model to add bounding boxes to the images and classify the images according to predetermined classes.

6. The optical inspection system of claim 4, wherein the artificial intelligence model is trained using synthetic data that was generated using photogrammetry.

7. The optical inspection system of claim 4, wherein information in the report is manually modified to produce a modified report, and the modified report is used to re-train the artificial intelligence model using active learning.

8. The optical inspection system of claim 1, wherein the second-stage storage system comprises a write optimized pseudo database, or an embeddable key-value store database.

9. The optical inspection system of claim 1, wherein the third-stage processor is a central processing unit (CPU) or a field-programmable gate array (FPGA).

10. The optical inspection system of claim 1, wherein the third-stage storage system comprises a DRAM system, an SSD system, or other type of persistent memory system.

11. The optical inspection system of claim 1, wherein the third-stage storage system comprises a relational database.

12. The optical inspection system of claim 1, wherein one or more of the second-stage processor, second-stage storage system, third-stage processor, and the third-stage storage system are located in the cloud.

13. An optical inspection system, comprising:
an image capturing device configured to acquire images of an object that is moving;
a first-stage frame grabber coupled to the image capturing device and configured to receive the images from the image capturing device, wherein the first-stage frame grabber is configured to send the images directly to a memory of the first second-stage processor;
a first second-stage processor coupled to the first-stage frame grabber and configured to analyze the images from the first-stage frame grabber;
a second second-stage processor coupled to the first second-stage processor and configured to process information from the first second-stage processor; and
a third-stage storage system coupled to the second second-stage processor and configured to store images and information from the second second-stage processor,
wherein the second second-stage processor is configured to produce a report using the images and information stored in the third-stage storage system.

14. The optical inspection system of claim 13, wherein the image capturing device is compatible with direct memory access (DMA), and is selected from: a digital camera, charge-coupled device (CCD) camera, or digital video camera.

15. The optical inspection system of claim 13, wherein the first second-stage processor is a graphics processing unit (GPU), a field-programmable gate array (FPGA), or an application-specific integrated circuit (ASIC).

16. The optical inspection system of claim 13, wherein the first second-stage processor is configured to analyze the images from the image capturing device using an artificial intelligence model.

17. The optical inspection system of claim 16, wherein the first second-stage processor analyzes the images using the artificial intelligence model to add bounding boxes to the images and classify the images according to predetermined classes.

18. The optical inspection system of claim 16, wherein the artificial intelligence model is trained using synthetic data that was generated using photogrammetry.

19. The optical inspection system of claim 16, wherein information in the report is manually modified to produce a modified report, and the modified report is used to re-train the artificial intelligence model using active learning.

20. The optical inspection system of claim 13, wherein the second second-stage processor is a central processing unit (CPU) or a field-programmable gate array (FPGA).

21. The optical inspection system of claim 13, wherein the third-stage storage system comprises a DRAM system, an SSD system, or other type of persistent memory system.

22. The optical inspection system of claim 13, further comprising an ejector or a robotic arm coupled to the second second-stage processor and configured to eject or remove the object when the second second-stage processor indicates that the object is defective.

23. The optical inspection system of claim 13, wherein one or more of the first second-stage processor, the second second-stage processor, and the third-stage storage system are located in the cloud.

24. A method of sorting moving objects, comprising:
capturing images of one or more moving objects using an image capturing device;
receiving the images using a frame grabber;
sending the images directly from the frame grabber to a memory of a processor, wherein the processor is selected from a GPU, an FPGA, and an ASIC;
stitching together subsequent images of the images to form stitched images using the processor, or alternatively, stitching together subsequent images of the images using the frame grabber before sending the images directly from the frame grabber to a memory of a processor;
analyzing the stitched images using the processor to classify the one or more moving objects.

25. The method of claim 24, further comprising sending a signal to an ejector to eject a moving object of the one or more moving objects.

26. The method of claim 24, wherein the image capturing device is a PCI or PCIe device that is compatible with direct memory access (DMA).

27. The method of claim 24, wherein:
capturing images of one or more moving objects using an image capturing device further comprises capturing a first image of the images at a first time and capturing a second image of the images at a second time, wherein the second time is after the first time; and
stitching together subsequent images to form stitched images using the processor further comprises stitching together the first image and the second image to form a first stitched image of the stitched images, wherein the second image is above the first image in the first stitched image.

28. The method of claim 27, wherein:
capturing images of one or more moving objects using an image capturing device further comprises capturing a third image of the images at a third time, wherein the third time is after the second time; and
stitching together subsequent images to form stitched images using the processor further comprises stitching together the second image and the third image to form a second stitched image of the stitched images, wherein the third image is above the second image in the second stitched image.

29. The method of claim 28, wherein parallel processing is used such that stitching together the first image and the second image to form the first stitched image of the stitched images overlaps in time with the third time.

30. The method of claim 24, wherein:
capturing images of one or more moving objects using an image capturing device further comprises capturing line-scan images of the one or more moving objects;
receiving the images using a frame grabber further comprises receiving the line-scan images using a frame grabber one line at a time;
sending the images directly from the frame grabber to the memory of the processor further comprises sending the line-scan images from the frame grabber to the memory of the processor one line at a time;
stitching together subsequent images of the images to form stitched images using the processor further comprises stitching together subsequent line-scan images of the line-scan images to form stitched line-scan images using the processor.

31. The method of claim 24, wherein:
capturing images of one or more moving objects using an image capturing device further comprises capturing line-scan images of the one or more moving objects;
receiving the images using a frame grabber further comprises receiving the line-scan images using a frame grabber one line at a time;
stitching together subsequent images of the images using the frame grabber further comprises stitching together subsequent line-scan images of the line-scan images to form stitched line-scan images using the frame grabber;
sending the images directly from the frame grabber to the memory of the processor further comprises sending the stitched line-scan images from the frame grabber to the memory of the processor.

32. The method of claim 31, further comprising stitching together two or more of the stitched line-scan images using the processor to form double-stitched line-scan images.
